(19) United States
(12) Patent Application Publication
(10) Pub. No.: US 2005/0097179 A1
(43) Pub. Date: May 5, 2005

(54) Spam prevention

(76) Inventor: Gregory Michael Orme, La Vergne, TN (US)

Correspondence Address: GREGORY MICHAEL ORME, 310 OAKWOOD COVE, LAVERGNE, TN, 37086-4130, US

(21) Appl. No.: 10/941,564

(22) Filed: Sep. 16, 2004

(30) Foreign Application Priority Data
Sep. 16, 2003 (AU) 2003905029
Feb. 3, 2004 (AU) 2004900472

(51) Int. Cl. G06F 15/16; G06F 12/14; G06F 11/30; H04L 9/32

(52) U.S. Cl. 709/207; 713/200

(57) ABSTRACT

Multiple inventions are included. Also users of an email system are limited in ways including to be able to send only a certain number of emails per day. This can ensure for example that if they spam the system they can be suspended before they can send an economically worthwhile amount of spam.

### BACKGROUND OF THE INVENTION

The present invention relates to the field of email.

### SUMMARY OF THE INVENTION

Spam in email is a major problem with according to some estimates over fifty percent of all email being spam. The more sophisticate filters get the more difficult it becomes for legitimate users to talk about many subjects. It would be desirable to have an email system that did not have these limitations.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a system to avoid spam. In a preferred embodiment at least one mail server allows only a certain amount of email, including for example a predetermined number of emails, to a user of the system in a predetermined time period, for example per hour, per day, per week, etc. The amount of email depends on actions the user must do. The aspects of the invention can be referred to as the email system. “Email” can also refer to other messaging and communications systems between computers.

In a preferred embodiment the user can pay a deposit for example $10 and can then send so many emails per day, say 20 as an example. So the user would for example pay a deposit of $X to send Y emails per day. The system can also define what kinds of attachments can be sent, whether HTML can be used, etc. A newer user would optionally be not allowed to send with HTML and/or attachments but as they developed a track record this could be allowed.

In a preferred embodiment each user has preferably an easy way to complain of spam. They can for example reroute a spam email they receive to the administrators, who then can suspend or complain to the user who sent the offending email. For example there can be an email address for spam offender details to be sent to, and the user forwards the offending email to that address. There could also be a controller including for example special buttons, menus, etc that the user can open, click on, etc after receiving spam. This could send the offending email to the administrators.

In a preferred embodiment since a user could send a limited amount of email per day they will get quickly caught if they spam or otherwise abuse the system and their account would be suspended or terminated. Since this is likely to occur before they can send many emails then they in this example would have paid $10 to send probably 20 emails which is not worth it for them. So the invention includes the aim of making sending spam in the system unprofitable.

Preferably a user who wanted to send more email could send a higher number of emails with a higher deposit, for example $20 would allow them to send 40 emails per day.

In a preferred embodiment users can preferably also have their privileges extended if their track record is good. For example if they are a member for a given period in good standing they might be allowed to send more per day on a predetermined deposit, or even have the deposit refunded.

In a preferred embodiment other users may be allowed to use the system if they qualify as being unlikely to be spammers. For example the system may allow anyone to use the email service if they use a means including for example filling out a form with multiple choice questions so urgent messages can be sent to members, perhaps including a phone number. In this way a spam message could not be included.

In a preferred embodiment people who could show they had valid email accounts at ISP's that charged for their account could get permission to send a predetermined number of emails in a predetermined time period e.g. per day to the system. Preferably the ISP would enter into an arrangement to deduct a fine from the user's account if they spammed the system, preferably equivalent to the bond other users might pay though this amount may vary according to the situation.

In a preferred embodiment there can be entities including for example businesses, people, companies, associations, etc that can act as guarantor for user including a person, company, etc to use this and similar systems for other messaging, web surfing, file transfers, management, etc. They can agree to pay a fine or other items of value if the user spams, does a denial of service attack, tries to hack into something, etc.

In a preferred embodiment there could be groups of users and/or computers who have a way of communicating with each other including for example forums, chat rooms, email lists, messaging, cabling, wireless, SMS, phone calls, etc and who are able to talk to people who want to access the system for reasons including an emergency, to test the system, make a one time message, an emergency, etc or who don't want to use one of the other methods of the system. After communicating sufficiently and passing predetermined tests with at least one person, computer, etc on the forum for example and perhaps responding to an email they could be allowed to send a given number of emails per day or to send a given number of emergency emails to the system.

For example they could answer an email, answer some question, undergo sight and sound tests, etc to prove they aren't computers or software, etc. If they pass the predetermined test then it might be assumed that it wouldn't be worth while for a spammer, hacker, etc to go to all this trouble to send only a few spams and get banned.

In a preferred embodiment users who had credit cards could fill out an authorization payment which is preferably not used unless they have to pay a fine, for example for spamming the system, like for example deposits are held when hiring a car.

In a preferred embodiment there could be forums attached to the email system which could allow people to post messages a user could see, and a notification of a message could be sent to the user to look at the forum. This could preferably only be a message posted with limited information to prevent spam. The messages in the forum would be preferably be highly restricted in the words they could use to make it harder for spam to be posted there. For example they could include multiple choice questions, the answers of which are displayed at the forum.

In a preferred embodiment when a user joins he gets an account with the system. Preferably he should sign in with a username and password and protect these from theft and misuse. Preferably he should also be able to sign in securely including for example HTTPS. Outlook Express and Outlook for example can be used to log on securely to a mail server.

In a preferred embodiment the user can receive at least one private email address which he can share with people but not use in any way that can attract spammers. He might have another public address which he can give out, but people are limited in the ways described here as to how they can write to it. Preferably people wanting to contact the user would be limited to sending basic information including for example their email address, phone number, clicking on multiple choice options in forms such as used in Outlook, etc.

Preferably the public email address can route to the private email address according to the terms and conditions of the system, for example a limited number of emails per day. Additionally the sender may be required to periodically read some text that is designed to be hard to read for computers.

In a preferred embodiment users may have their private email address set up so that it only receives mail from the system's email server so no other email can get to them. The invention also contemplates email can be redirected to another email account of theirs, preferably one in which the address is not widely known. This might for example be with their ISP, Hotmail, GMail, etc.

In a preferred embodiment the user is given a special password, identifier, etc that is included in email and other messaging means sent to him through the system. The identifiers can include an email address the email is coming from, the server ID, password written into the email, a digital certificate, a hash of predetermined data, and any other suitable identifier.

Preferably the user sets rules on his email client so the email that contains these identifiers is routed to his inbox or a preferred folder and other email is either discarded or placed elsewhere for viewing if he chooses. Since only the mail system should know this identifier spam would be deleted or saved for checking separate from the system's email.

In a preferred embodiment the email can be entered through a HTML page such as used by Hotmail. This is also preferably metered to a predetermined number of emails per day.

In a preferred embodiment the system can also be used to protect against advertising from other messaging means including for example instant messaging, Microsoft messenger, SMS, etc.

In a preferred embodiment the system can also be used to transfer data from web users, web sites, mail servers, file servers, FTP sites, etc to protect them from hacking attacks. The system server (which includes all aspects of the invention) can be set up as for example a proxy server and for example has a DNS server in it with a list of preferred sites it works for, which may include for example sites known to be free from porn, educational sites, sites to be protected from hacking, etc.

Preferably the server is designed to not be capable of understanding computer commands other than those needed to do its proxy job and to be managed by the administrators. This makes it more difficult for it to be hacked.

Preferably it intercepts the DNS request from the user's computer. This can be done in many ways including for example the system server's IP address being included in the root hints section of a Microsoft DNS server, or client. Normally when a computer is connected to the internet it must query a DNS server to obtain an IP address and this query goes to DNS servers that run the internet. Instead of or in addition to this a user that desires to access this system can have his DNS queries go to the system server.

This can be done in many ways. For example Microsoft software for servers can forward DNS queries to the system server. Specialized software can be written to direct these queries. The system server's IP address can be substituted in the user's computer so there is only the system server to make DNS queries outside of its local network to.

Preferably this could be designed so the user could activate a first controller on his computer to redirect the DNS queries to the system server, and then a second controller to revert back to the internet DNS servers. This makes it more convenient to use the system.

Say for example the user wishes to visit a site www.exampleonly.com and its real IP address is 210.210.132.9. The server looks in its DNS records and preferably tells the enquirer that the DNS address of the site is the system server's own IP address and/or the IP address or a member server, perhaps in round robin sharing of the load or load balancing of queries. It might also add a particular port number to the IP address so when the user tries to access that address the system server knows who it is from.

In a preferred embodiment the enquirer then has an IP address associated with the name but not the real IP address. Also the names can be sub domains so many web sites can be operated in this way by the server. For example the server name as exampleonly.com might have thousands of subdomain names that each signify a particular web site it acts as a proxy for.

So the enquirer makes a request for that web page and the server looks up the real IP address for that site and passes on the request. When it receives the request back from that site it preferably strips the page of all identifiers that give its real site name, location, IP address, and email addresses, and if it links to any other site protected by the server those links are also preferably changed.

In a preferred embodiment the page is then sent back to the enquirer with no information that shows where the web site really is. Because of this it is very difficult to hack. The proxy server is hardened and set up to only do its job and has no other files to be accessed. The only requests it will route are preferably to route files, web pages, etc to the enquirer.

In a preferred embodiment the user can set his computer to use the system server as a proxy for all traffic for a predetermined time. The DNS enquiries go through the proxy server and are intercepted. The DNS enquiries normally return the IP address of the site the user wants to visit.

Instead the IP address can be changed preferably to another IP address, which can be for example randomly or according to an algorithm generated. The IP addresses could also be private addresses because when the request gets to the proxy server the addresses are changed anyway. For example when the system server gets a DNS enquiry it might give an IP address of between 10.0.0.0 and 11.0.0.0 which are not internet routable. Then it records which DNS names are associated with which of these non routable IP addresses. When an enquiry comes through with a dummy IP address the system server recalls what site this is really for and routes that request to the site. After a predetermined time the system server might drop that DNS dummy information so it can recycle the IP addresses given out, though this should not need to be done for a long time.

When it receives replies from the web site, FTP site, file server, etc it strips them of identifiers including for example email addresses, ways to determine the site's real locations, etc. The user then gets the information from the site but has no way of knowing where it is, and so it cannot be easily hacked. Since it can only be contacted through the system server with a restricted set of code including HTML, FTP, Telnet, etc commands there preferably are not enough command and information for a hacker to find the real server or hack through the system server.

Preferably the system server has a basic operating system only able to do these tasks, to minimize the chance of vulnerabilities allowing a hacker to crack it.

If the proxy server gets a denial of service attack then it can have many other servers doing the same job which can spread the load. Since the hacker does not know where the real server is they cannot attack it directly. If the attacks persist the proxy server may go into a mode where a secured connection is made with the enquirer, or the enquirer must respond to an email to have their request processed.

In a preferred embodiment a plurality of other servers might be directed to do some of the tasks for the system server, to spread some of the load in for example a Denial of Service attack.

Preferably the users of the service might have to be vetted in ways similar to for email, to reduce denial of service attacks.

In a preferred embodiment if a secured connection is used then this might only be available to registered users like in the email examples and all other requests would be ignored or redirected. Preferably users might only be allowed to access a predetermined number of data objects including for example files, web pages, etc per day. They may have to for example demonstrate a valid email account such as with an ISP to make requests and so on. Much of this would only be in the case of a Denial of Service attack though. When there was no attack the user's access could be increased.

In a preferred embodiment the user may join an email system according to the invention where emails he wants to send stay in his computer and a notification is sent to the person he wants to contact. A reply comes back with perhaps a one time email address and the user replies to it and attaches his message. In this way if the message is spam the system knows the IP address of the user and can block it.

In a preferred embodiment the mail server can selectively pick which emails it uploads from the user's computer. It waits for the response from the receiver to say it's ok and then uploads the email.

In a preferred embodiment the server may also upload the email, send a notification to the addressee saying it has an email for them and asking them to authorize it, and/or to send an authorization to the sender who replies to the authorization, and this authorizes the server to send the email.

This would preferably be for users who are relatively unknown to the system.

In a preferred embodiment the system also partially censors data objects including for example web pages, emails, newsgroup comments etc unless the user allows them or turns the filter off. Keywords and other filtering means that define spam can be blacked out in the email, web page, etc so the user can tell if he wants to read it or not.

Preferably his has the advantage of allowing him to look at the messages but cannot actually read the spam and so gets much less annoyance from it. He also is less likely to miss a legitimate email.

Preferably the programs can alter the fonts and colors, toning down the email so it is less offensive looking, removing HTML, and other programming languages attached to the email, removing images, etc. So if the spam alert triggers then the email has much of the offensive nature blocked so it is not as bad an experience to receive it.

In a preferred embodiment the user may send his secret identifier, password, etc to trusted people. They can then include this identifier in the email to send to the user.

In a preferred embodiment the server may also send an email to a person wanting to temporarily access the email system, or direct them to places including for example forums, chat rooms, a web page, to receive an email, etc. At one of this places or attached in an email may be a file like an image file with something written on it that a computer could not read easily. They may receive a temporary identifier that is good perhaps for one email to the user. A spammer likely would not bother having someone read this to send one piece of spam.

In a preferred embodiment the invention encompasses the concept of internet speed bumps to slow down users so that spammers and hackers who need to do things more quickly before detection are effectively excluded.

In a preferred embodiment the user might receive or be directed to a web page which has an audio or movie file in which the identifier is found, also difficult for a computer to read. Identifying this correctly might allow him for example to send an emergency message.

In a preferred embodiment users may also have the ability to send identifiers in this manner to other people and companies. Companies for example might be allowed to send email to users in the email system if they include predetermined identifiers so the users can know to accept them or opt out. To do this they preferably must agree to pay a fine if it is misused. Preferably these are also metered in the numbers sent per day in case the identifier is used by a spammer.

For example to do this the company might send a version of the email they want to send to the administrators. The administrators in turn can distribute the email from within the system so spammers cannot mimic the company to gain access.

In a preferred embodiment email addresses may constructed that encompass long email names perhaps including long subdomain names. There would be so many possible email names that the spammer would be unlikely to guess a valid private email address.

In a preferred embodiment BCC and CC may be disabled, perhaps by blocking emails when the To: Address is not the same as the addressee's. Users may be allowed to send a limited number according to their account conditions.

Preferably the email and web page server system becomes in effect like a gated community where one cannot enter without doing things inconvenient to hackers and spammers. Also speed bumps prevent then doing much damage if they do get in.

In a preferred embodiment this system can also include reducing the spreading of worms and viruses. The system can preferably have rules that do not permit certain kinds of attachments, or perhaps have an area to send them first so they can be checked as not dangerous. For example they could be placed in simulated Windows or whatever operating system and see what the attachment does, perhaps accelerating the dates so if it is set to do something at a given time it can't wait out the system. Also the system and/or users can have a virtual operating system installed to run attachments first in and to monitor the results.

Preferably also the system would ensure that users could not store their usernames and passwords in their computers, they would have to be reentered each time. The system would also preferably require a password of sufficient complexity to not be easily hacked. Users might write these down but this would not be accessible to worms and viruses. Worms would find it difficult to propagate as they would be throttled in how many they could send through the system. With worm and virus alerts certain kinds of emails could be throttled in number until safeguards are in place.

In a preferred embodiment for example the system could be set up to send and receive through different ports than 110 and 25, and have a firewall which users can provide and/or the email system can include. These would block ports 25 and 110, and open different ports to the mail server. In this way worms could not use their own SMTP engine to propagate. If someone got a worm through the system they could quickly alert the system so the sender could be temporarily blocked to slow down the spreading. Because there are so many ports the email system could pick one hard for worms, etc to find. The email system might also include a firewall, or instructions for users to set up a third party firewall. Preferably substantial numbers of users would have different port numbers for email so preconfigured ports in a worm could not always work.

In a preferred embodiment the system may additionally encrypt emails or keep confidential records of emails for a period, preferably only for a few days, so that if a user complained they received a spam email it could be sent to the administrators to make sure the sender can be found and suspended. It should be more difficult to spoof a sender's address since a user preferably needs an authorized username and password to access the server. No other emails would be accepted, except according to the rules of the email system.

A preferred embodiment would be to encrypt the sender's details and place them in the email, message etc. If there is a complaint by a user the administrators can look at this encrypted information which preferably would contain the sender's name, address, time of sending, email account so he could be suspended if desired. Additionally in all these embodiments packet information including where the data came from, what routers, computers, etc could also be encrypted and placed in the email so the administrators can decrypt this later to help trace the senders.

In a preferred embodiment the email system may also be used in messaging services including for example Microsoft Messenger, instant messaging, SMS, etc. The user would have to log in and preferably have his numbers of messages throttled. Also this could be used to limit the number of SMS and other messages sent to mobile phones. Faxes and personal phones could also be protected by these principles though the problem is not serious enough there for this kind of system so far.

In a preferred embodiment this system need not be run by one company, other people and companies may join the system with their email servers by agreeing to abide by the conditions explained here, preferably paying a fine if they don't. ISP's for example could set their email and other servers up in the same way and these could communicate with each other. The email system could be a standard adhered to. Email and other message servers could send data including emails to each other, preferably encrypted so no hackers could insert information. This could be done with IPSec and Kerberos for example. Mail server according to the disclosures herein can refer to any kind of message or file server.

For example if a first user has an account with a first server and he wants to send a message including for example an email to a second user at a second server then the two servers can set up a secured or other connection between them to transfer email.

In a preferred embodiment the mail servers would authenticate with each other by having usernames and passwords and in addition encryption including for example Ipsec, Kerberos, etc could be used to transfer email and other data between them.

In a preferred embodiment identifiers for a user including for example an email address, instant messaging names, web pages, addresses, phone numbers can be encrypted preferably with a hash function such as MD5 and advertised.

In a preferred embodiment these hashes can be placed in a repository, preferably in a database means. Preferably these would include detail of a user's credentials and what he was trusted or permitted to do including whether their email address was safe to receive email from.

Preferably these email addresses and other identifiers can also include passwords, strings of data, etc that can be included in a communication such as email, instant messaging, messaging with mobile phones, and all other communication means.

In a preferred embodiment the user has a special signature including a hash of predetermined numbers of their identifiers. This need not be a hash or use encryption, for example this can be a made up email address falsely saying who the email is from, or any identifier.

In a preferred embodiment the receiver takes the sender's email address or whatever identifier is being used and applies a hash function to it, for example MD5, SHA1. Then there is a preferably online or otherwise available repository of hashes of users that are trusted to various degrees. The receiver makes a hash with the user's identifiers and checks it with the repository of hashes and if it is there then it allows the message to be delivered, otherwise it may be placed in another place including folders, spam repositories, deleted, etc.

A false email address is a useful identifier since then spammers cannot try that email address and get a response form a mail server to indicate it is valid, whereupon they spam that address. It is just as easy though to simply have a string of data corresponding to that user inserted in the message or in an attachment, etc. Then the receiver can make a hash of that identifier and compare it to the hashes in the repository.

In a preferred embodiment the levels of trust accorded to these identifiers can be arrived at from many factors. Preferably a predetermined number of emails are allowed from that user in the mail system. Another is that someone or a system vouches for that user to be allowed to make predetermined communications.

For example a user may correspond with a system that tests their ability to read and understand messages. They might log onto a site and have to read things difficult for computers to read and listen to sounds and answer questions, and perhaps reply to at least one email. If they succeed their email address or an identifier is hashed and placed in the database.

In another example they may have to go to a forum and correspond with trusted people. Their email addresses might be masked to other users and they need to respond to an email sent to them with the identifier, or reply to it to get the identifier. The trusted users converse with the candidate sufficiently to ensure this is a legitimate request and the candidate is not a computing means, spammer, or hacker. Of course this can involve a kind of Turing Test but also include the aforementioned reading of images and listening to sounds, and interpreting them correctly.

In a preferred embodiment certain email addresses with an ISP or other messaging or email service might be believed to be legitimate because the user pays a fee for them. In this example the service may assign them an identifier, create a hash or recommend them for one.

In a preferred embodiment companies and other associations might give their email lists to the system to have them made into hashes, and into a repository. This may be quicker to validate as for example they may have their hashes on their web sites or other online or network data sources. When the users from that location send emails the addresses are checked against the hashes at the data source to confirm them.

In a preferred embodiment a user's identifiers may be confirmed as ok by the various receiving means and a kind of credit or performance history can be updated at the various repositories.

For example if users have a record of legitimate emails then this can be an updated number or identifier based on an algorithm at a repository. The user can display their hash and their record to show they are reputable. If they have a poorer score this is also displayed and some of their messages and email may be rejected. The receiving means may elect to cache some of the hashes and identifiers and hashes for preferred intervals to reduce times for checking them. Preferably the user could apply to have this score of their messaging reliability changed if they believe it is unfair or inaccurate.

Preferably the repositories of the hashes could be replicated to other locations so they were less vulnerable to hacking, slow internet connections, and denial of service attacks, etc. Hashes could be made of predetermined numbers of the hashes to make sure none were changed by hackers.

In a preferred embodiment, hashes of other data including files can be placed in repositories. For example programs may have many files and these could be checked against these hashes before installation to ensure they are not tampered with.

Preferably downloadable programs and other files may need to register their files with the repository as hashes before users will download or use them. They first check the repository to show they are safe, or for any other purpose. This can also include hashes of web site addresses which are desirable in some context. Users may go to certain sites and check links out on these repositories as ok before exploring them. Additionally some computing means may restrict browsing and other file access on networks as well as the internet if they do not match hashes and other identifiers in the repositories as ok for any reason. This can include an equivalent of Microsoft's Discretionary Access Control Lists on files where instead of or in addition to the file being guarded in this way it is guarded by details on it at a repository.

In a preferred embodiment emails may also be examined for attachments compared to hashes at a repository. For example only certain kinds of code including for example executable files, vbs other scripts, etc may be allowed to execute if they are recorded at the repository.

In a preferred embodiment companies and other users may restrict attachments to preferred types and content by registering what they will accept in a repository as preferably hashes, advertised in locations including at their web site, a notice section at a repository, other places, etc. When a user wishes to send them something he checks the repository to see what they will not accept. Images for example might be likely to be allowed. In this example users can define rules of what they will accept, and other users can check these rules first before wasting their time trying to send outside the policy rules.

In a preferred embodiment users would post hash and other profiles of what programs, code, scripts, etc are acceptable, and other users could in turn have hash and other policies of what they can send. For example there can be preconfigured hash and other profiles that a user can decide on, of what they will send and/or receive. They download or otherwise interact with the repository the hashes and other identifiers to create and/or manage their profiles and policies. If they comply with the repository guidelines they know their attachments and other communications will be accepted.

In a preferred embodiment users may specify versions of certain programs and not change them often, as doing so would require updating their own hash databases and caches of hashes, which can use up bandwidth. In all these examples MD5 is an example only and there are other hash producing functions that may be more suitable, since MD5 has recently been found to have some security issues. SHA1 is a good alternative.

In a preferred embodiment to avoid spammers making up email addresses and occasionally guessing correct ones an identifier would preferably also be included in the email. Also email address could include a large subdomain name. In DNS names these can be much larger than the typical, like microsoft.com. It might for example be user@sales.microsoft.com, user@marketing.microsoft.com, etc. The email addresses to make them less vulnerable could be more complex with the subdomain name, here sales or marketing could be a much longer and more complex string of characters. This could include so many possible combinations that spammers would find it difficult to guess this. In addition there could be another part to the name like user@ffdsaafds.iouiou.microsoft.com.

Preferably this is in addition to making the usernames long and hard to guess. Preferably this is in the example of associations that have their own DNS server or can request changes to other ones, for example at an ISP or hosting company. For example a DNS server only looks at two parts of the domain name such as microsoft.com, nytimes.com, and the sub domains and other parts of the fully qualified domain name are managed by the name server. This name server or one delegated to this task can manage the subdomain names to keep them hard to guess.

Preferably these additional parts of the namespace can be changed at preferred intervals, so what worked before no longer does. Updated hashes can then be displayed by the users.

In a preferred embodiment the viewing means of users can selectively block potentially undesirable material. One of the worst aspects of spam and undesirable websites is having to view material including for example web pages, email, attachments, etc to determine its suitability. The system can evaluate email according to various filtering systems including Bayesian Filtering and other system known in the relevant arts. One advantage of this system is the filter can be set in a higher state as falsely identifying an email as spam is not as big a problem here.

In a preferred embodiment if the email, attachment, web site, etc is suspected to be undesirable according to the rules of the system parts of it are blocked out so it becomes preferably unreadable in total. Looking at the parts which are visible one can work out if the rest is worth seeing. For example if it is an email one can work out from the parts seen if it is likely to be a legitimate email or not and if so then the block can be lifted and the rest of the email seen.

Preferably because the suspicious email is partially blocked it makes the spam less upsetting because one doesn't have to read a substantial part of it, even inadvertently. For example many spam emails use words like Viagra. If an email contained this word it would be highly blocked so the user could determine if it was legitimate without having to read enough of the email to get a potentially undesirable message.

In a preferred embodiment web sites can be filtered in a similar way to reduce the chances of seeing or reading material undesirable to the user. If the web site is acceptable and the filter was wrong then the block can be removed. In this way children for example could surf the internet and receive email with much less likelihood of being exposed to unsuitable material.

For example if the web page had certain keywords involving sex the images, movies and links could be automatically blocked. Emails with phone numbers, prices, and ways to order things could be heavily censored for reading. None of the embodiments explained here are intended to limit in any way. While the system lends itself to email and messaging use the principles explained here can be used in any data transfer between any kinds of entities. The scope of these disclosures is best left to the claims. In addition each part in the U.S. and other patent applications can be considered to be a separate invention in its own right, and its scope should not be limited by the context in which it is explained. Also any part that can be considered to be a separate invention can be used in conjunction with any other part in this application or with any other invention, in any setting, context, application, process for any use known in the relevant art.

### THREE DIMENSIONAL BROWSING

### ABSTRACT

A hardware and software based system including for creating a three dimensional space for computer use is disclosed. The system includes creating a three dimensional frame of shapes navigable with a computing means, and video and audio effects are added by the host computer. The system includes ways to quickly move around the three dimensional space, and to convert two dimensional graphics and programs to synchronize with the three dimensional system.

### BACKGROUND OF THE INVENTION

The invention relates to the field of data on networks.

### SUMMARY OF THE INVENTION

The use of computers has largely been confined to a two dimensional interface. This includes word processors, internet browsers, spreadsheets, and operating systems. Three dimensional programs and movies have been used but they are usually slow and with poor resolution.

They are popular in games but using three dimensions has not penetrated significantly into general use by computer users. The present invention is directed to many aspects including providing a system in which people can use a three dimensional software and hardware system more efficiently.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The internet and various operating systems are mainly in 2D while 3D applications and hardware are improving technologically. It is desirable then to improve devices that are graphical interfaces in ways including for example computers in networks, the internet, and stand alone computers.

One of the main problems is the amount of bandwidth that can be consumed with 3D. The best mode of the invention involves reducing this problem by caching, storing, running, rendering, downloading, etc a 3D framework and the various effects including for example textures, images, avatars, animations, skins, sounds, flash animation, shockwave, Direct Draw, 3D FX, Open GL, video acceleration, etc, all graphical parts associated with the relevant arts.

A good analogy is games like Quake where a frame like means is set up, like a bare bones 3D shape and this is added to with textures, images, etc to flash out the 3D environment. In a similar way a 3D operating system would preferably create the basic shapes and additional images, textures, animations, skins, etc would be added to them.

The frame can include for example walls, doors, all architectural shapes, windows, shapes of animals people and/or avatars, nature, trees, landscapes, etc. The frame though is preferably of reduced detail so that it can be downloaded more easily. In a preferred embodiment the frame can be regarded as those parts of the overall presentation that cannot be cached separately. For example the floor plan could not preferably be cached because it is likely to be different in different situations. The wall textures such as bricks, wood, etc could be cached if it is used on a plurality of different frames.

An avatar shape might be a frame if it is different in different situations. The colors and textures on the avatar might be cached if they are used on a plurality of frames.

The basic framework can then be used in the computing means, and this framework can be shared amongst the computing means on networks and/or the internet. The add in visual and sound effects as described earlier can be transferred between the computing means, from at least one central repository, or different computing means can use their own versions of any of these effects.

They can additionally download these from various repositories, which can be updated according to preferences including for example fashions, new effects available, add on programs, new computer code, new frame and floor plans, new color schemes, new sound effects, improved coding such as OpenGL Direct Draw and Direct Sound, etc.

The inventive concept includes extending this into operating systems, business software, spreadsheets, word processors, file managers, databases, anti virus programs, firewalls, calculators, browsers, etc.

In a preferred embodiment a browser can include a 3D frame as described in which different pages can be many shapes including for example different rooms, walls, windows, doors, paintings, tables, appearing like a television, book cases, mountains, pools of water, facets, etc. The effects can be added to these as described, and similar to ways they are now used in 2D in the relevant arts.

Instead of or in addition to a mouse clicking on various icons the mouse can direct the cursor or whatever directs the viewpoint to positions in 3D by apparatus. These include controllers on the mouse, and instead of or in addition to this there can be other controllers including a second mouse, keyboard, controllers such as those used in virtual reality, gloves with controllers, devices tracking eye movements, devices monitoring brain waves for controllers, changing data and images shown according to biological signals from the user, joysticks, touch pads, etc.

For example a first controller including for example a mouse can include controls to make the cursor and/or viewpoint move around this frame, scenery, images displayed, etc. On a normal web page there are icons including for example arrows and buttons to click on to move the user forward and backward in their selections, to their home page, etc. In the 3D and other frames these icons might do different things including for example arrows to retrace a 3D path of selections as well as 2D, icons to click on different rooms via a 3D journey, buttons to move the user's viewpoint up and down and in any direction, buttons to move the user directly to a particular destination, zoom in or out on particular objects and/or environment, change colors, change textures, etc.

Also there can be effects which represent a kind of moving means, including for example a transporter, elevator, going on stairs, escalators, vehicles, bicycles, springboards, animals to ride, etc. These can include moving the user from one data point to another. For example these can be employed in moving from a first set of data to a second including for example web pages, spread sheets, documents, file managers, directories, flash and other movies and all other displayed material known in the relevant arts.

Instead of or in addition to a file manager and/or index the frame means can include icons as 2D and 3D placed in areas including for example walls, on facets of objects, in galleries, in decks like decks of cards, in boxes, on shelves, etc. The icons can activate changes including for example doors opening or closing, walls moving, stairs moving or stopping, files changing position, objects opening and closing, data being displayed or hidden, etc.

Preferably moving after selecting icons including for example controls, maps, destinations, files, objects, etc is relatively automated so the user need not direct his controllers in every small movement including for example using one or two mice, keyboards, joysticks, game pads, any controller of computer data known in the relevant arts. It can also be fully under control of the user where he can make all movements manually

Preferably these examples of the invention would include a means to translate from 2D programs including for example browsers, email clients, server software, operating systems, word processors, spreadsheets, business software, etc.

The invention preferably would take the 2D programs and convert the graphical controllers, command lines like DOS, Linux, UNIX, File menus, icons to click on, hyperlinks, etc and/or all other aspects of a program into the 3D environment. The user would then if desired run the 3D converter on his 2D programs.

Preferably 3D programs would be used as well, the conversion and emulation with 2D programs would be a useful addition to give more variety in their uses. Frames could additionally have many options and be downloaded like the effects, preferably in ways similar to skins, avatars, textures in games, etc are made by people and downloaded today.

Preferably then the system would include a frame that could accommodate created effects as described by companies for sale, but also so communities could create free and shareware add ons to work in the 3D means.

In a preferred embodiment forums for example could be converted into 3D environments, even with Usenet. The framing means would convert this to 3D by running programs, accessories, code, images, etc on the user's computing means. The administrators of the forums might have preferred effects to use, and preferred frames to impose on the users, or they could select their own. Default frames for these and other web environments could be used as well.

In terms of computing power this need not be difficult for computers and networks including the internet to handle. The effects are preferably cached in the computing means as are preferred frames. Additional ones can be downloaded as desired but these are typically not large.

The system could be run by different kinds of 3D engines including like those used in Quake, Doom 3, Unreal Tournament, Sim City, Red Alert, etc. Users could preferably choose the frames and levels of details so it was not too slow on their computing means. For example the user might select variables including for example the resolution, optional detail, optional animation of some objects, different colors, different themes, etc.

Hyperlinks could be represented by icons including for example 2D and/or 3D shapes, avatars, text, symbols, and interacting with them including for example clicking on them can take you to somewhere else including for example another 3D environment area, or 2D as preferred.

The scroll wheels and other examples of controllers could be used to move in a 3D direction. For example the normal mouse movements could move in a 2D pattern like on a floor plan. The scroll wheel or another device including for example additional buttons, wheels, touch pads, trackballs, joysticks, game pad buttons, etc might move the viewpoint, cursor etc up and down so the viewpoint moves in ways including running, flying, walking, teleporting, driving, etc.

In a preferred embodiment there could be large rooms with icons including for example thumbnails, small animations, movies playing, file names, folders, boxes, etc on and in the walls with passageways in any way known in the relevant arts including architecture, game environments, etc. Moving then to the destination would be easy, not unlike a normal file manager or index.

In a preferred embodiment like in games, the controllers could be set in any form. In an example not intended to limit these possibilities the right hand mouse button could move forward, the left clicks on icons, a scroll wheel could move up and down, a middle button might rock side to side to turn around and/or to move to the side, and so on with all possible variations in controls. A joystick could also be placed on the mouse to be moved by a finger.

Time could also be accelerated or slowed. In a preferred embodiment clicking on icons or activating another controller such as on a mouse, keyboard, joystick, etc could result in a slower journey to that link, file, etc and it could also be speeded up if the user was in a hurry.

In a further preferred embodiment other users could appear in the 3D environment. For example in forums the other users could appear with 2D or 3D avatars, static or animated. They could be animated by means including for example artificial intelligence, by user controls, by predetermined programmed responses, etc.

The user could optionally move invisibly, be seen by selected other users, in any combination.

Although some preferred embodiments are shown to include certain features, the applicant(s) specifically contemplate that any feature disclosed herein may be used together or in combination with any other feature on any preferred embodiment of the invention. It is also contemplated that any feature may be specifically excluded from any preferred embodiment of an invention. Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### THREE DIMENSIONAL DISPLAY PIXELS

### ABSTRACT

An element directs a light beam in a predetermined pattern, to create a three dimensional image. By changes including making each pixel look different from different directions a three dimensional display can have a higher resolution.

### BACKGROUND OF THE INVENTION

The present invention relates to the field of optics, including stereoscopy.

### SUMMARY OF THE INVENTION

Three dimensional displays suffer from the problem of poor resolution. Typically this is because a separate pixel is needed for each viewpoint. For example a display might need to have ten different viewpoints of a particular pixel to correspond to different viewpoints.

To do this currently a first pixel needs to be represented by the exampled ten different pixels that show a different signal from each direction. With current technology this leads to the display either looking very grainy, or the number of viewpoints reduced.

To be able to do the same with one pixel the display could in this example have ten times the resolution. It is desirable then to make one pixel able to show different signals in different directions.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

FIG. 1 shows a liquid crystal in a first position and/or shape.

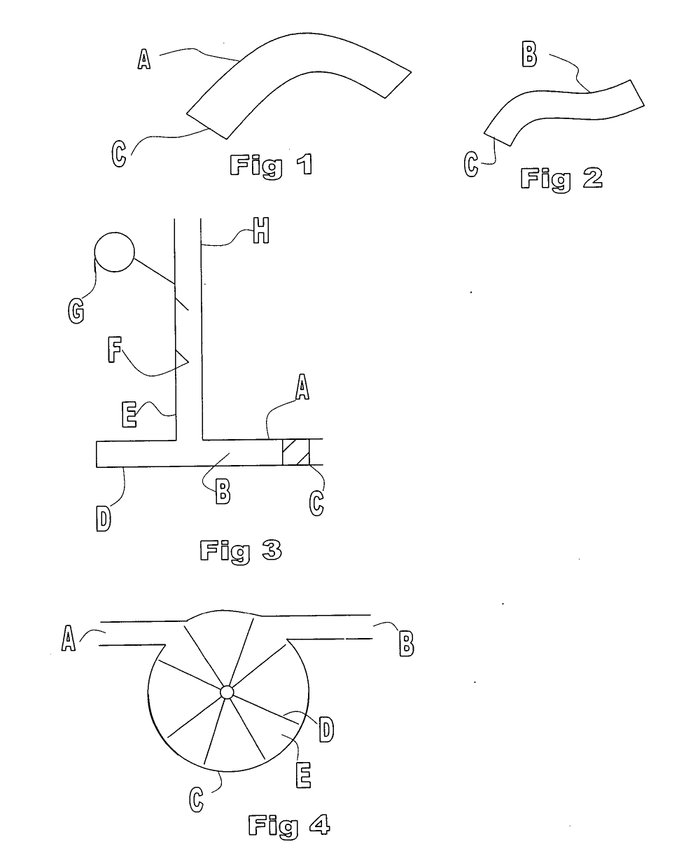

FIG. 2 shows a liquid crystal in a second position and/or shape after a stimulus.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a section of an emitting and/or receiving device including for example display screens. It includes at least one moving icon to direct at least one emitter and/or receptor in preferred directions in a predetermined pattern. The icons can include for example pixels, apertures, tubes, CCD's, liquid crystal elements, OLED's, lenses, mirrors, etc.

Preferably this motion will include a predetermined pattern to cover substantially an area. In the example of an emitter this motion may include covering part or all of at least one display screen. This pattern of motion may include for example side to side, reminiscent of the motion of an electron beam in a cathode ray tube, with vertical motion in substantially the same pattern, and/or oblique motion, etc. The motion may also be irregular and/or periodic in time and distance travelled in any pattern known. The motion of the exampled icon may also include moving in and out of the surface, migrating to other parts of the surface, being encapsulated in other shapes, changing in size and/or shape, changing in transparency and/or albedo, and all other variations of possible motion.

In a preferred embodiment at least one receptor may include substantially the same motions as the aforementioned emitter. Of course the icons moving may include in a predetermined combination all emitters, all receptors, or any ratio of emitters, receptors and other objects that either emit or receive include circuit components, lights, optic circuitry, transistors, resistors, integrated circuits, computer parts, etc as desired. A first component may also change into a second component described here as desired.

Included in the invention is to make the icons move so as to receive and/or display an image in 2D and/or 3D. Also included is the ability to make a display point in preferred directions, to be seen more clearly in some directions than others. Preferably the invention may include receivers for example CCD's etc which receive data more in a predetermined direction preferably because of the orientation of the icons.

For example a kind of liquid crystal like compound can be used to direct the emitter and/or receptor. As is known in the art, liquid crystals deform in shape under a stimulus. Preferably devices including liquid crystals can twist under a stimulus to change their orientation. This can preferably change the direction of beams exiting and/or entering them.

In a preferred embodiment a liquid crystal twists on application of an electric current. The crystal can be designed instead to be in a different shape. For example in FIG. 1A represents a shape formed substantially from liquid crystal without a stimulus. Light coming either in or out of one end is turned inside the crystal. C can for example be mounted to receive light from a source, and/or it could direct light to a receiving means for example a CCD. It can also direct light from an emitter including for example LCD's, OLED's, Cathode Ray Tubes, etc.

In a preferred embodiment C could connect to another liquid crystal or any means to modulate the light so it can be brightened or darkened. For example then one liquid crystal could modulate the brightness of the beam and another liquid crystal modulate the direction of the beam.

In FIG. 2 an electric current changes the shape of the liquid crystal which directs the beam in a different direction and/or receives light from a different direction. If the crystal is stimulated according to a predetermined pattern the device can direct a beam in different direction, and/or receive light from different directions.

A plurality of these devices could act as an emitter for example directing light to users at different viewpoints. If the beam in each device changed then different users could see the device as looking different from different viewpoints. With enough of these a three dimensional screen could be constructed. In a similar way receptors could receive light from different directions in an array.

This change in direction can cause a sweeping of the direction of a beam coming out of the device, or it can receive a beam from the surroundings going into the device. In this way icons such as this can be arranged including put closely together so as to make a display and/or emitter that can send and/or receive in 3D.

The changing in shape of the exampled liquid crystal need not be the same as the desired change in direction of the beam. A reflecting and/or refracting means can be used to direct the beam to the preferred destination. For example if the change in beam direction from the deformation of the exampled liquid crystal is too small an angle this can go through at least one lens to increase this angle. If the deformation of the crystal directs the beam in the wrong direction then it might be reflected off a mirror to direct it correctly.

Liquid crystals of course are an example of the inventive concept and are not intended to limit. Another preferred embodiment would include for example tubes, nanotubes, etc that are directed in a predetermined manner to preferred directions as herein described. Such a change in motion can be done by many inputs including for example electrostatically, magnetically, electrically, by levers, cogs, chemical changes, and so on. The tubes could also be made larger and be moved as described. Building such a device is relatively easy because the movements of the icons can be done in an example of the principle by mechanisms well known in the relevant arts. For example the tubes could be 1 centimetre in diameter and moved in a predetermined pattern by motors and cogs.

In a preferred embodiment the invention can be used for altering the light coming through a display screen and/or onto a focal plane. The exampled liquid crystal changes shape and so the beam coming out of it is directed substantially less out of an aperture and so less light comes out of the device. In this example the system can modulate the brightness in a pixel. The beam can be directed onto a dark surface, recess, cavity, a mirror directing the beam away from the aperture, etc and the more this is done the less light escapes the aperture. Conversely the more the beam is directed toward an aperture the brighter the beam is. The beam can be modulated in ways including these examples.

In a preferred embodiment lenses and other light refracting means can be made to sweep in a predetermined pattern to act as an emitter and/or receptor.

In a preferred embodiment mirrors may also be used. For example a mirror is placed on a device that enables its orientation to be changed in a predetermined pattern. This can enable a projector to shine onto the device and by modulating the signal users from different viewpoints can see a different signal. A plurality of these can create a three dimensional image. The mirrors can be moved by means including for example cogs, switches, electromagnets, electrostatic forces, electrical attraction and repulsions, etc. Light and other radiation can additionally be directed to receivers to collect data, images, etc.

In a preferred embodiment pixels can also change the direction of a beam using sound waves. A transparent medium is vibrated with sound waves which alter the direction of a beam of light going through it, and/or reflecting from it. By doing this in a pixel the beam can sweep in a predetermined pattern to assist in means including to create a three dimensional image.

Although some preferred embodiments are shown to include certain features, the applicant(s) specifically contemplate that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### THREE DIMENSIONAL SCANNER

### ABSTRACT

A scanner has a surface including three dimensional receptors to take images of objects. It also has several parts which can be placed around the objects to be scanned. A three dimensional image of the objects scanned is created in a computer.

### BACKGROUND OF THE INVENTION

The present invention relates to the field of optics

### SUMMARY OF THE INVENTION

Scanners are often used in the home and businesses. These are however only capable of taking two dimensional images clearly. It would be desirable then to be able to take three dimensional images of various objects and manipulate the images in a computer.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a scanner capable of taking 3D images of objects and creating 3D shapes. Preferably it includes a plurality of sections which can be arranged around the object to a predetermined amount. These sections can include for example CCD's, lenses, mirrors, parts found in conventional scanners, cameras, and other receptors. The object can be imaged by a means including for example by using visible light, ultra violet radiation, infra red, X Rays, all frequencies of electromagnetic radiation, low frequency sound waves. Ultrasound, any frequency of sound waves, etc.

Preferably the positions of the image receptors can be sensed by the invention so the overall configuration is known. For example the device may calculate the angles and distances between the parts by sound waves bounced between them. They may also use other means to calculate the angles and distances between the image receptors by monitoring for example hinges, sides, bending parts, tying parts down, bolting parts together, having the structure held together by pieces with rulers on them which can be monitored and the results added into the software, etc. The positions of the various parts need to be precisely known to create the three dimensional image accurately.

The image receptors preferably have a 3D surface including for example those found in 3D cameras and imaging devices. These can be configured in ways including for example lenticular lenses, fly eye lenses and lens sheets, arrays of tubes as disclosed in my PCT WO9910766, etc. The parts can preferably also take a two dimensional image from predetermined viewpoints and create a three dimensional image from them in a computing means.

Preferably also the scanner includes a lighting means including at least one lamp, fluorescent light, incandescent light, halogen lamp, arc light, lights used in scanners and photocopiers, etc which can illuminate the object to be scanned so it can be seen clearly from preferred angles. Preferably the scanner can illuminate the object to be scanned with a grid like pattern of light so this can be used to determine the correct focus.

For example part of the device might emit a pattern of light in a grid including for example shapes like squares, triangles, pentagons, etc. The pattern need not be important as long as the changes in this pattern can be interpreted correctly. The grid patterns could include for example a mesh, a net, squares, rectangles, triangles, pentagons, etc.

Preferably as the light falls on the object the predetermined shape of the grid pattern is deformed according to the object's features. Analyzing this shape change can determine the exact shape of the object. Preferably this can be done on a frequency which can be filtered out so the grid is not seen. Preferably it can also be done at a higher frequency not visible or even before the image is taken.

In broad terms as a preferred embodiment a method is used in that scanner parts take images of the object from selected angles and a 3D image is synthesized from these. Sensors may additionally be used to calculate if the object is correctly placed so the imaging can be done accurately or if the image receptors and/or object should be repositioned. For example if parts of the object have a recess this might be difficult to image if it not pointing towards a receptor.

Still images, time lapse images and movies can be imaged. Image receptors are preferably connectable together and onto at least one surface in ways including for example brackets, mounts, screws, nails, rivets, bolts, welding, gluing, etc.

In a preferred embodiment a plurality of the image receptors can be placed on tracks and adjusted in position. They can also have adjustable heights, and the orientation of the image receptors can be adjusted in ways including for example on swivels, bolts, gimbals, tripods, etc. One advantage of this example is the track positions can be relatively easily added to the image data to calculate the three dimensional images.

Preferably the image receptors can adjust their own positions for improving the image, and/or the positions can be determined by a computing means. For example a user might look into what an image receptor is viewing and adjust their position. This could be done in ways including for example a viewer with a lens, LCD display, etc on, near or connected to at least one image receptor.

Preferably the user might access the image receptors with at least one computing means to monitor how they are positioned, and how the three dimensional image would look. Scanners have a preview option, and so the user could preferably preview the image in a lower resolution to see if there are any problems.

Preferably the invention can be stored in at least one container for storage and/or portability. Preferably a plurality of receptors can be conveniently placed in an array so objects can be easily imaged. For example there might be a space on a surface including for example a table, desk, shelf, etc where the invention can be set up.

Preferably the computing means can include for example at least one laptop, Personal Digital Assistant, mobile phone, desktop computer, a specialized computer for processing the imagery, etc. For example a plurality of the image receptors can be used in conjunction with at least one mobile phone, computer, Personal Digital Assistant, etc to take three dimensional images of objects and transmit these to another user.

Preferably at least one user could look at the 2D and/or 3D images for example with a 2D and/or 3D viewer and/or display. Preferably a first user could send and/or receive a 2D and/or 3D file of the object to a second user who could look at the image on a 2D and/or 3D screen.

Preferably the user could change their viewpoint of the objects scanned with the computing means including for example zooming in and out, turning the object over, stretching it, flipping it, changing colors, changing resolution, resampling, adding textures and special effects, etc.

Preferably the data from the scanner can be sent to at least one software means. This preferably can perform tasks including for example recreate an image of the objects, save it to a file, send it by email, file transfer, print it, convert it to film, display it, alter with techniques known in the art, etc.

Although some preferred embodiments are shown to include certain features, the applicant(s) specifically contemplate that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### MULTIPLE DISPLAYS

### ABSTRACT

Additional displays can be used for example on mobiles, Personal Digital Assistants and laptops.

### BACKGROUND OF THE INVENTION

The present invention relates to the field of computing.

### SUMMARY OF THE INVENTION

Multiple displays are often used in desktop computing but portable computers have only a single display. It would be desirable to have a system to use multiple displays.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

The best mode of the invention involves a means to have multiple displays on a computing means including for example laptops, notebooks, Personal Digital Assistants, mobile phones, devices by Palm like Palm Pilots, etc.

Preferably the additional displays can be connected by various means including for example wires, cables, wireless, Bluetooth, infra red, ultrasound, other electromagnetic radiation, etc.

Preferably the additional displays can be attached to the aforementioned computing means by an affixing means including for example at least one hinge, bracket, bolt, screw, clip, flap, line, rivet, etc.

In a preferred embodiment at least one additional display can be used with the computing means. This might include for example the additional display being placed in a preferred location including for example folding onto the computing means, swiveling into position, moving along at least one track into a storage position, being bolted down, being rolled up, being placed nearby separately, being folded, being held together by clasps, clips, screws, magnets, locks, etc.

In a preferred embodiment at least one other screen can be placed alongside, above or below the main screen on the computing means. This can include multiple desktop arrangements for example those supported by Microsoft, etc so that the cursor can move from one display to the next. Video cards that support multiple displays are known in the art, as are techniques to install multiple video cards.

Preferably at least one additional display is supported securely including for example by attachment to the computing means, to be on a separate frame, stand, base, tripod, etc.

In a preferred embodiment at least one display can be stored, including by being folded along hinge lines, disassembled into pieces, rolled up, etc.

### COMPUTER IDENTIFIERS

### ABSTRACT

Differing ways can be used to notify a user of a communication. Sounds including for example ring tones and parts of songs can be played at different times according to artificial intelligent programs, and special occasions.

### BACKGROUND OF THE INVENTION

The present invention relates to the field of identifiers including sounds played to notify a user of a message.

### SUMMARY OF THE INVENTION

Different sounds are commonly played on a communication means such as mobile phone and Personal Digital Assistants. It would desirable to have a way to vary these sounds and other means to alert a user according to a special occasion.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

According to an invention there is a means to vary the contacting method for users with for example mobile phones, notebooks, Personal Digital Assistants, laptops, Blackberries, other computing means,etc. These contacting methods can include for example sounds, vibrations, light beams, parts of movies, heat, signals directed at implants, etc.

In a preferred embodiment, the best mode of the invention involves a contacting means including for example a computer program and/or device. This can determine when an identifier including for example at least one ring tone, part of a song, movie, vibration, signal to an implant or other device, etc is activated when the user needs to be notified.

Preferably the invention may determine through at least one means including for example Global Positioning Systems, location through mobile phone networks, IP address and similar numbering systems, contact details, the user nominating his position, etc, where the user is and emit different predetermined identifiers to notify him. This may alert him of his location or for any other reason.

In a preferred embodiment different identifiers may preferably be activated for reasons including for example at different times of the day, different appointment times, the identifiers may be randomized, a pattern of identifiers according to an algorithm, etc. This may be done in ways including for example by algorithms, predetermined patterns, popularity charts, artificial intelligence programs, according to weather information, fashion, warnings, reminders, appointments, special occasions, etc.

In a preferred embodiment there may at times be criteria including for example identifiers which are popular with the public, some ring tones may be preferred, some parts of songs might be preferred, etc and this can change for many reasons including for example fashion, new identifiers being available, etc. These can be acquired in ways including for example downloaded into the device, purchased, rented, sampled, recorded, shared, swapped, etc and used.

Preferably the user could connect to repositories where different identifiers are used according to aspects including for example genres, fashions, popularity, etc and these can be activated in his device. The connection means can include for example cables, wireless, Bluetooth and equivalents, infra red, laser, internet, etc.

For example a downloading means including for example structures and programs like iTunes, Gnutella, Kazaa, email notifications, SMS notifications, web sites like shareware.com, etc might be used where users can preview new identifiers, see which are new or more popular, etc.

Preferably to ensure the user does not mistake an identifier being played for someone else's identifier he might use parts of an identifier he regards as familiar. This can include for example identifiers he has purchased, rented, etc so he knows he has a unique or privileged use of it in an area, location, time, etc. Such identifiers might be acquired in ways including for example auctioned, rented, purchased, etc from a repository.

In a preferred embodiment an identifier including for example his name, phone number, friendly name, username, etc might be emitted in a predetermined pattern. This can include for example ring tones associated with segments of the identifier.

In a preferred embodiment the invention could use a contacting means including for example music scale notes associated with preferred groupings of letters of the alphabet, etc. Preferably the contacting means might be able to interpret data including for example say the user's identifier, say his name, say other words, etc when activated.

In a preferred embodiment devices can be used that connect to a primary communication means including for example laptops, mobile phones, Personal Digital Assistants, Blackberries, Palm Pilots, etc.

A secondary communication means can be additionally employed, including notifying the user that the primary communication device is trying to contact them. The secondary communication means can preferably include for example a device connecting onto eyeglasses, etc. It can include for example a piercing in the ear, jaw, eyebrow, hair, any part of the body, etc and any way of connecting and/or being near the user so the user can notice the messages.

In a preferred embodiment the user may have at least one of the primary communication means mentioned herein and these can transmit and/or receive a signal to at least one the secondary communication means. For example the user might have a primary communication means including for example at least one mobile phone, Personal Digital Assistant, laptop, computer, etc and a secondary communication means including for example circuitry inside a piercing, chain, comb, hairpin, watch, ring, fingernail, contact lens, tattoo, material stuck on or in the skin, implant, etc that can notify including by for example ringing, playing something, activating an implant, vibrating, etc so the user knows the primary communication means has a message.

One advantage of this system involving a primary and secondary communication means is the secondary means need not be as large, and so can be used more easily. It might include shapes like for example brooches, earrings, pendants, jewelry, watches, cuff links, rings, attachments to or replacing fingernails, toenails, tooth replacements or implants, nose rings, contact lenses with circuitry for a display in them, material painted on the skin with circuitry in it to receive a signal, material on the skin which can heat vibrate or emit sounds with a beam from the primary communication device, tongue rings, etc.

In a preferred embodiment the secondary communication device can include for example functions of actually emitting and receiving signals directly, and in other ways act as the primary communication device. Preferably a primary and/or secondary communication means can include for example speakers, microphones, cameras, displays, monitoring the pulse, monitoring vital signs of the user, monitoring the user's temperature, monitoring of stress levels, etc. They can be activated and controlled in ways including a tactile manner for example touching, rubbing, vibrating, squeezing, gripping, hitting, biting, scratching, etc.

Although some preferred embodiments are shown to include certain features, the applicant(s) specifically contemplate that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### POWER GENERATION FROM HEATING

### ABSTRACT

A method is disclosed for creating power from the sun. Sunlight penetrates a transparent material container which heats the air inside. This causes air to rise through a funnel which is made out of light materials. This enables it to point upwards using balloons and the motion of the hot air rising. Turbines can be used at entry points on the ground to generate power from the air current.

### BACKGROUND OF THE INVENTION

The present invention relates to the production of power from renewable resources.

### SUMMARY OF THE INVENTION

The world is running out of energy from oil. It would be desirable to have cheap sources of renewable energy.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

FIG. 3 shows a device to create power from heating air.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to create power from heating air. The system includes heating air from the sun. The sun shines on a preferably transparent material which heats the air inside making it rise. This in turn can be used to move a turbine and create power.

In a preferred embodiment a large enclosure is made. For example a kind of plastic is used but any materials known in the relevant arts will work including for example canvas, Perspex, glass, etc. Preferably the material is substantially transparent so the light will shine through and heat the air and other surfaces inside.

In FIG. 3A is a transparent material which lets the sunlight in to heat inside. The material can partially be heated itself by the sun. B represents inside where the air heats up. C represents a turbine or other power generation means that creates power from the colder air rushing into the device. D represents an insulated surface so the heat doesn't leak to under the device. E represents at least one funnel which is made of very light materials. F represents optional baffles. The air rushing past the baffles can help to keep the funnel up. G represents balloons which can optionally be used to keep the funnel high enough. H represents at least one exit point for the heated air.

Preferably the air inside can be insulated underneath so heat is not substantially wasted by going under the array. Also the covering above can be darker if it gets hot and sufficiently transfer heat to the air below. In addition materials can be used which let the light in but restrict the emission of heat back outwards. One example of this is a related product to Perfect Mirror material.

There is a variation of this mechanism currently being used but this makes a solid construction with a turbine at the top of it. This is quite expensive to make, the disclosures here disclose a cheaper way.

The shape can have any cross section desired. In a preferred embodiment the shape is simpler to be cheaper to make and is substantially flat on top though it may bulge in preferred ways towards the centre to aid the air movement.

There will be at least one funnel which goes upwards and lets the hot air escape. Preferably this is made of thin and light material, and can be supported optionally by balloons. These balloons could for example also be filled by some hot air to make the array cheaper to maintain, alternatively they could use hydrogen, a partial vacuum, or helium. Preferably the shape of the funnel is aerodynamic to reduce the pressure of the wind pushing it down and at an angle. For example if the prevailing wind is typically from a direction the funnel may present a narrower width in that direction.

The outside boundaries of the array near or on the ground are sealed except for preferred points where turbines are placed. These use the air being sucked into the array to generate electricity.

One advantage of this system is it is much cheaper to build. The materials are closer to the ground and so can be braced upwards by for example poles, struts, etc. The funnel can be self supporting since its preferred purpose is to let the hot air escape upwards and create an air current. Additionally inside the funnel there can be flaps which can be moved as required. These can retard the air current going upwards which aids in supporting the funnel.

Preferably the funnel shape can be designed to not kink too much when the wind is blowing as this could disturb the smooth flowing of the hot air inside.

In a preferred embodiment the shape can be directed to catch the sun at certain times of the day. For example it may be better to design it to catch the morning sun, or afternoon sun.

In a preferred embodiment there can be a plurality of these shapes substantially near each other and preferably connected so air flows through some or all of them. For example they could be in line with at least one turbine letting air inside. The air can exit through any of the funnels, and the funnels not need to be as high or large.

In a preferred embodiment the invention is positioned on a hill, mountain, or other geographical feature. For example the material can be placed around all or part of a hill, so the shape of the hill supports the correct movement of the air, and the funnel is more supported on top.

Although some preferred embodiments are shown to include certain features, the applicant(s) specifically contemplate that any feature disclosed herein may be used together or in combination with any other feature on any preferred embodiment of the invention. It is also contemplated that any feature may be specifically excluded from any preferred embodiment of an invention. Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### USES FOR PUMPS

### ABSTRACT

Pumps with a variable capacity are connected together to achieve objectives including muffling sound and a gearing change.

### BACKGROUND OF THE INVENTION

The present invention relates to the field of hydraulics and gearing.

### SUMMARY OF THE INVENTION

Gearing is often a complicated and expensive process. The mechanisms are difficult to make and often can become worn. It would be desirable to have a gearing means that was simple and cheap to make.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

FIG. 4 shows a rotary pump.

FIG. 5 shows 2 rotary pumps connected to each other.

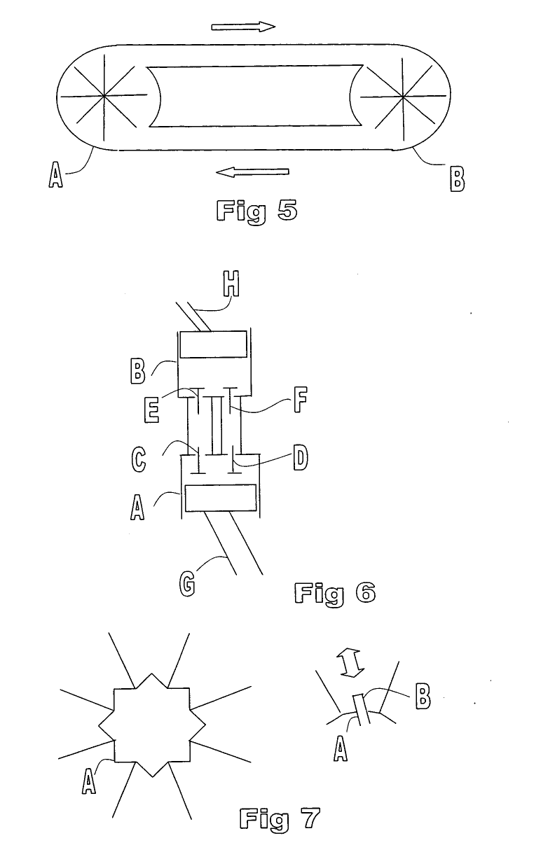

FIG. 6 shows 2 piston pumps connected to each other.

FIG. 7 shows a central area of a rotary pump with a means to restrict the volume between the vanes.

FIG. 8 shows a reservoir for burning fuel driving a pump.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to change gearing ratios in devices including using a liquid or gas instead of or in addition to cogs, levers, belts, etc.

Preferably this gas is air though all other gases including nitrogen, oxygen, Carbon dioxide, etc can be used. Liquids used can include water, oily liquids, hydraulic fluids and all other fluids known in the art.

In a preferred embodiment a rotary pump includes one that has vanes moving. These movements include for example rotating, turning, vibrating, going backwards and forwards in it, etc. Gases or liquids come in a first aperture and the moving pump parts cause the gas or liquid to exit out a second aperture. Typically a pump like this can pump faster in many ways. One way for example is by rotating it faster and causing the parts to move faster. In an example of the invention I will illustrate with rotating pumps but this is not intended to limit the principle or any aspect, which applies to all pumping means.

Preferably a rotating pump can pump faster, but also the shape of the vanes and chambers inside the pump can change shape and also alter the speed of the gas or fluid being pumped. For example the chambers inside are a certain volume, and a given RPM speed will pump a given amount. If the room in the chambers for example between the vanes is restricted or increased this would in turn cause the pump to pump less or more gas or liquid.

In FIG. 4 a pump is shown as an example. The gas or liquid comes into A and exits at B. C represent the casing of the pump. D represents the vanes of the pump. E represents the space between each vane.

If the pump spins at a constant rate the amount of liquid or gas can be increased by increasing the volume that can be held between the vanes, shown as E.

A second pump preferably of a similar mechanism can be connected so the exit from one pump goes into the entry of the other. So now as one pump turns the other pump should turn as well because the gas or liquid circulates between the two.

This is illustrated in FIG. 5.

This is then a transfer of power from the exampled mechanism of Pump A to Pump B. For example one could have pump A connected to a motor and pump B connected to a mechanism including for example wheels, pulleys, belts, cogs, etc. Pump B would turn because of the motor turning Pump A.

If the chambers and other parts in pump A and/or Pump B were restricted or enlarged this would effect a gearing change. In the case of the size between the vanes being restricted in Pump A this would cause less gas or fluid to be pumped and consequently Pump B would turn more slowly. Conversely if the chambers and parts of Pump A were enlarged, then Pump B would turn faster. So by changing the sizes of parts of Pump A and/or B, a gearing mechanism can be formed that uses a fluid or gas as a power transferring means.

In a preferred embodiment this could be set up on a vehicle including for example a car, bus, truck, bike, boat, plane, etc. For example on a bike the power production, by a motor, pedaling, etc causes pump A to turn and pump B to drive the wheels and altering the dimensions of either or both pumps would effect the required gearing change.

As can be appreciated the principle is the same for all other kinds of pumps. For example Pumps A and B could be pistons in cylinders going back and forth pumping air or fluid between each other, shown in FIG. 6.

In Pump A the piston moves up and down from a stimulus, for example here a conrod like device shown as G. The valves C and D open and close as is typical for a pump of this nature, and similar in principle to in a combustion engine such as a diesel. Pump A is connected by the pipes as shown to Pump B.

G in this example would be moved by a motor and the motion of the piston in A moves the air or liquid so as to move pump B and create motion, for example through a conrod like device at H. If the capacity of the chamber in A was larger then for the same motions of the piston in A more gas or liquid would be pumped and pump B would turn faster. So this also shows that the system represents a gearing device. The same principle works with any pair or greater number of pumps hooked together like this.

If the chamber of pump A was decreased in size then Pump B would slow down because Pump A would pump less each stroke. As before if more than two pumps, for example pumps A, B, C, D, how ever many pumps are connected to each other are adjusted then each can alter its gearing and can speed up or slow down as desired. Of course as many pumps can be on these conduits as desired.

In a preferred embodiment to illustrate this there might be a 4 wheel drive car with 4 Pumps, A, B, C, and D, one at or substantially near each wheel. There might be another E to run power steering, another F to run air conditioning, and another G could turn a generator or energy storing means to create electricity, store power from braking, and any other purpose known in the art.

Pump H would be connected to at least one motor, say a fuel including for example gas, petrol, biomass, etc. Another pump I could be connected to an electric motor and provide power from solar panels, batteries, capacitors, any power storage. As can be seen, as many pumps as required for any purpose involving delivering or receiving energy in the relevant arts can be used.

The designations of these pumps are not intended to limit the possible uses of the invention but to illustrate gearing changes in a plurality of locations from the power sources. There are many of these examples known in the art, and vehicles typically have some combination of devices substantially similar to these. Clearly gearing is used on many different kinds of machinery and these disclosures can be applied to any of them that use gearing.

As Pump H runs, the various other pumps would move and run the other devices. Sometimes in this example Pump I may run providing additional power. The idea of using a combustion engine and at least one electric motor would be an example of a hybrid vehicle.

Preferably adjusting the dimensions of the pumps would provide gearing changes to any of these as desired. For example the wheel pumps could be adjusted in real time to provide traction, the air conditioning could be changed in speed, the braking pump G would perhaps act as a brake. When the vehicle was braked G could convert this into power to be stored, as battery power, compressing air to be released for power later, etc. For example it is useful to change the gearing ration quickly to store the braking energy as this will be equivalent to stronger braking.

Preferably mechanisms in the pumps will be described, but the principle of restricting space in the pumps to make them move at a different rate is considered to be included in all variations.

Preferably in rotating pumps there is a central shaft the vanes attach to. If this central shaft is set to grow, and pieces from it were introduced into the chambers then the overall volume that can be held between the vanes is reduced. Conversely shrinking them increases the volume.

For example in FIG. 7 there is a mechanism around the central axle marked as A. As this mechanism expands it can reduce the amount of gas or liquid that could fit in between the vanes in the rotary pump. A could utilize many kinds of mechanisms known in the relevant arts to achieve this. For example it could be hydraulically designed with a gas or liquid, so that the parts of A that extended into between the vanes were inflated or pushed into expanding into this area.

Preferably these parts could be connected to pistons and a spring like means in A. As the pressure in A increased the outer part B would be pushed out reducing the volume in between the vanes. As the pressure was decreased the spring like means would withdraw it.

The mechanism is very simple to build in this preferred embodiment. All that is required is a means to make parts of A protrude more in between the vanes. To give an illustration one might imagine a shape like a glove with the fingers protruding into the area between the vanes. Inflating the glove like shape would make the fingers protrude more and reduce the volume between the vanes.

Instead of the example of the glove fingers small pistons are easily constructed and are well known in the art. These can also be pushed outwards by a means including for example levers, cogs, gas, liquid pressure, etc.

In a preferred embodiment a mechanism including for example cogs, levers, etc could push the pistons, protuberances, or other predetermined shapes into the areas between the vanes. There are enormous numbers of these mechanisms known in the art, to take motion in the central axle and convert it to a motion in between each of the vanes.

In a piston pump as another example, the chamber above the piston can be altered in shape, to increase or restrict the pumping volume the pump can make, creating a gearing change. These changes in the pump volumes can also be used when the pump is a combustion engine.

Other variations on the theme are disclosed in my third PCT WO0131384 in the section on gearing changes.

In a preferred embodiment a pump in this array can also be used as a motor or power producing means. If Pump A in FIG. 6 for example is a piston pump then that can also be run as at least one piston producing power with fuel, and the changes can still be made by varying the volume in the chamber, for example by increasing or decreasing the volume in the chamber, the top of the piston being deformed, other parts increasing or decreasing in volume as known in the art. For example the top of the piston could be directed to increase or decrease in volume from a mechanism under its surface. Devices including for example the analogy of the glove fingers or the small pistons could be introduced into the chamber to reduce the volume.

Preferably the spark if it can get more fuel in the chamber by enlarging it will create a larger explosion and more power. Restricting the chamber size has the opposite effect. More fuel by be allowed into the chamber of the volume is increased.

For example the piston pump shape is equivalent to a combustion engine. Using diesel fuel the principle is similar, and inserting a spark plug is for using gasoline.

Preferably changing the volume of the combustion area can affect this design in engine performance. For example the combustion volume might be set to change as the revolutions per minute of the engine increased, so that more fuel could be used in the chamber. Preferably there could be a way to make the chamber expand as the explosion of the fuel occurred. This could for example act to spread the explosive impact of the fuel over a longer time in the cycle. For example there could be part of the chamber that expanded against a resilient means, spring, etc. Each explosion in the chamber could cause this to expand as the fuel exploded. Changing the volume of parts of the pumps and engines can also be used without other pumps for a gearing change. For example a motor could be designed with a plurality of cylinders like these that could have their volume changed to alter the performance of the engine. These could include for example 4 cylinders, 6 cylinders, V8's, rotary engines, etc. The principle can be applied to any engine that burns fuel.

Preferably changing the volume in the chamber could also be desirable when the engine was running at lower revolutions or idling. The chamber might for example be more restricted when a diesel engine was warming up so the fuel exploded more easily. Of course these and many other aspects disclosed in this document go far beyond the field of gearing. None of these examples are intended to limit, but each part should be considered a separate invention with its scope best defined by the claims.

In a preferred embodiment the vaned rotary pump can also be used as an engine with fuel can be ignited in it, preferably from a sparking or fuel igniting means as fuel goes in between the vanes. This could be for example from the central shaft which could contain a sparking means including for example a spark plug or glow plug, or from the top of the pump. The expanding fuel turns the pump, which can be additionally adjusted by changing the volumes as described. The pump acting as an engine can be used with the other pumps to effect a gearing change, by itself, or with other pumps to act as a multi chambered engine.

In a preferred embodiment fuel including for example methane, natural gas, fuel vapor, etc can be circulated in the system and ignited in the pumps as required. Valves at preferred points may restrict the expansion of the exploding fuel to provide thrust in the desired direction.

Preferably pumps may be connected by pipes, preferably made of metal though pipes like those used in vehicles for water, oil, power steering, etc may be used. The pumps may be made in ways including for example by converting standard pumps available commercially and adding a means to varying their dimensions as described.

In a preferred embodiment reverse gears can be made by reversing the gas or liquid flow at the pumps and/or at a predetermined location. For example in the 4 wheel drive disclosed earlier the pumps could have a means to exchange the intake and outtake ports so where the gas or fluid flows into a first port of a pump it flows instead into the second port. This can also be done further from the individual pumps for example nearer the main motive source like the engine where the two pipes containing the circulating fluid or gas for gearing are swapped over so the gas or fluid flows in reverse in at least one pump.

Preferably pumps similar to those described can also be used to muffle sound. In a preferred embodiment a plurality of pumps are placed with a conduit between them, and exhaust or whatever is desired to be muffled runs into the entry port of the first pump. The noisy fluid or gas (for example exhaust from an engine) goes into the first pump where the vanes serve to reduce the noise. The pump can also be designed so the air, gas, fluids, etc go around in a larger arc so the materials being muffled stay in the pump longer. This is made by making the entry and exit ports of the pump further around the circle from each other. In a preferred embodiment this may be sufficient and another pump not needed. At least one other pump can preferably be used to reduce sound in the gases or liquids which are then expelled.

Preferably to reduce back pressure the pumps may be driven by a mechanism to ensure they are not pushed alone by the exhaust. This back pressure can affect engine performance.

Preferably all kinds of pumps can be used in this way. For example a pump with a piston, entry and exit valves can also be used, preferably so the insides assist in muffling sound including for example with baffles, cavities, rubber, etc. Since the pumps preferably have no open line of sight through them when they are operating, sounds coming in one side must hit some materials before exiting, probably many times and this tends to attenuate the sounds.

In a preferred embodiment the pumps can create a lower pressure area so the sound frequency changes, making it easier to muffle. For example this can be done by restricting or widening areas of conduits and inside the pumps, by arranging them so parts of the conduit have a lower or higher air pressure, etc.

In a preferred embodiment the pumps can also function as motors. For example in FIG. 8 there is a reservoir C where fuel is burned, and the fuel comes in by entry point A. B can be a means to combust the fuel including for example a spark plug, glow plug, etc. D represents an exit conduit. Hot gases would come out here at high pressure because of the burning fuel. At E there is a pump which spins faster because the fuel burned expands and so there are more gases to expel through F, and this can be connected to a means including for example to create power, to wheels, to a generator, etc. Of course E can be any kind of pump including a piston pump.

In a preferred embodiment these concepts can be included together. A pump can be included in a means to burn fuel as shown by example. The exhaust from this can spin other pumps and all these pumps can alter their speed by altering their interior volume and other characteristics. This can give a gearing change on any pump. Pumps can also muffle the sound of exhaust from the burning fuel as disclosed. In this example the exhaust gases would be preferably expelled rather than recycled in the examples of pumps in gearing.

Although some preferred embodiments are shown to include certain features, the applicant(s) specifically contemplate that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### DATA CLUSTERS

### ABSTRACT

A system is disclosed for interpreting data hard to understand for computers. This includes speech recognition, face recognition, handwriting, and moving on irregular terrain.

### BACKGROUND OF THE INVENTION

The present invention relates to the field of computer recognition of data including speech, handwriting, faces, and terrain.

### SUMMARY OF THE INVENTION

Computers find it difficult to interpret many things humans can do easily. These include speech recognition, faces, etc. It would be desirable to have a way to improve this ability.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

FIG. 9 shows a flow chart for speech recognition.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means of compiling data to use in recognizing data computers have difficulty with. This can include for example speech recognition, facial expressions, gestures, recognition of objects, moving in environments hard to calculate, etc.

In a preferred embodiment this includes disclosures made in my PCT WO02054378 where a dictionary of algorithms is employed, and differences of various kinds between the data collected are classified and catalogued. Often the system evaluates each piece of data and finds points of similarity between some of them, and thus creates clusters of data that are similar to each other, and the system catalogues differences between the members of this cluster.

One advantage of the system is it is not always to useful to define what these differences are, the preferable course is for the recognition means to find whatever similarities in data it can detect. This is important because this system is not just based on recognizing patterns, but on recognizing patterns the recognition means can detect. Many other systems in the art try to impose on the recognition means the way they believe we recognize data. This can be included in the process but the preferred embodiment here is to let the recognition means find similarities itself.

Preferably once the clusters of similar data start to form there will be differences between them including random variations, formulae to account for the differences, algorithms, chaotic changes, logarithmic growth and decline, etc.

In a preferred embodiment for example a speech recognition means is enabled. The system has a means to record voices of users and a means to link those sounds to what they are saying to use as a reference. This includes users reading and saying things and the words, phrases, expressions, etc they say are also inputted into the recognition means. This can also include the emotional tones employed, grammar, inflection, emphasis, pitch, speed of talking, etc. This is shown in FIG. 9.

Reasons for linking the data to the interpretation include so it can be seen how accurate the recognition means is, and if it might have made some mistakes in processing the data.

This data is placed into a database where sounds that are similar to each other are clustered together, and the differences between the members of that cluster are also defined in the database means. At this point with sufficient data the recognition means should be sorting out clusters of sounds that are similar to each other along with the differences.

It should be stressed that these similarities and differences need not necessarily be those we would choose, but those that the recognition means found itself are preferable. As long as the recognition means finds similarities and differences it should be able to use them to differentiate data, which is a preferred objective.

If the recognition means find ways to differentiate data, even if they are not what we would choose, if they work they can be useful.

Preferably to assist this process it may be useful to pre classify some clusters and to alter some clusters that are accumulating in an inaccurate way. The recognition means then accumulates parts of the language with difference data that accurately defines the different ways people talk, such as including the speed of their speech, their accents, their pitch, the way some sounds run into others, etc. In this process clusters may form that have little relationship to actual rules of the language. For example people when they talk typically run words together, and the clusters of words may include words run together like this rather than breaking these words said together into clusters the recognition means might find harder to understand.

Preferably in this process then the recognition means listens to voices and tries to work out what sounds belong in what clusters. Also it looks at those clusters to determine what differences there are to other sounds in that cluster. As the database means increases in size this should become more accurate. The actual text of what the people are saying can be used to compare how the clusters are building to see if some inaccuracies are creeping in and changes can be made.

In a preferred embodiment in a cluster the recognition means has for example added a number of sounds it finds similar in some way. It should then be possible to define a reference sound that approximates an average of all these sounds.

Once this is done the other sounds in the cluster can be referred to in terms of their differences between them and the reference sound. Ideally the reference sound should approximate a sound the recognition means notes comes up frequently and the other sounds in the cluster are similar enough to it to possibly be variations of it. The reference sound may be periodically updated by these and other methods if desired.

In a preferred embodiment the recognition means may compare a new sound that it decides to place in this cluster with the reference sound. It may assess a probability the new sound belongs in the cluster according to how similar the new sound is to the reference sound.

Preferably the administrators may decide a different sound pattern may be a preferred reference point in that cluster and can optionally give an added weighting to some sounds as they might consider those more important or more useful to the recognition means.

For example the administrators may note a cluster is forming well and the average sound in the cluster is a good representation of a word, phrase, etc. They might elect to pick a clearer version of the word as a reference sound so the other sounds are more desirably defined according to their differences with the reference sound.

Preferably as the process continues the recognition means should become more successful in recognizing the voices but also in developing an understanding in its clusters of what differences are allowable in speech and still understand what is being said. The actual sounds themselves need not be stored in the database, clusters, etc. The recognition means may store data about the sounds to save space, and for other reasons. For example the recognition means may find that using Fourier analysis can represent the sounds in a more compact form that also gives sufficient data about similarities in the sounds

In a preferred embodiment sounds can themselves be stored in the cluster, in addition to other data. When the recognition means then wants to create speech it can use these sounds in ways including for example altering their pitch and speed if desired, morphing some sounds to connect to others, etc.

In a preferred embodiment the sounds can be stored as waveforms and compressed, whatever techniques known in the relevant arts to save space and speed up computer processing. For example sounds might be stored in a compression format including for example Ogg Vorbis, MP3, etc.

In a preferred embodiment the process can include modeling the physical features of the people speaking. This may include by X Ray, ultrasound and other means making a three dimensional analysis of their abilities to make sounds, and extrapolating how they might sound with different parts including for example their larynx, tongue, lips, etc being positioned in different ways. This can additionally be stored, even the shapes as they speak monitored and sorted into clusters as before.

One advantage of this is that the voice producing means of people can be modeled and the various dimensions of their body parts recorded. The different sounds then could additionally be recorded as positions of these body parts and their dimensions in that person. To replay the sounds this model is activated. To recognize sounds and words this can be made to fit into a sequence of body part positions, and their dimensions.

In a preferred embodiment people could read from a prompter and follow indicators of what to read. Other ways would include natural speech which is recorded and the people write down what they said so the recognition means has everyday speech to analyze along with the text.

In a preferred embodiment errors may be corrected in the clusters, additionally they could be corrected by people saying more of those kinds of sounds.

Preferably the same systems for speech recognition can be employed for any recognition required. In a preferred embodiment this includes recognizing objects. The recognition means is trained as before by seeing different objects and creating clusters of image parts that are similar and creating difference data on them. This clustering can be aided by the administrators if desired. As the process continues the recognition means becomes more accurate in defining clusters. These clusters can have associated with them names of the objects and so when sufficient data has been accumulated the recognition means can with sufficient confidence place the image data into the right cluster and have the correct name for it.

Preferably the recognition means can accumulate data on the movement and changes in objects to do required tasks. The concept of the invention includes accumulating data, dividing it into clusters with difference data, until it matches up with the correct answers.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### DISPOSABLE CAPPUCCINO IMPLEMENT

### ABSTRACT

Part of a cappuccino maker is designed to be disposable.

This makes it much easier to clean.

### BACKGROUND OF THE INVENTION

The present invention relates to the field of cappuccino machines.

### SUMMARY OF THE INVENTION

Cappuccino machines are usually difficult to clean on the steam spraying end. This is inserted in milk and heat it up, and in the process usually gets cooked onto the sprayer. It would be desirable to reduce this cleaning problem.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a disposable or separately cleanable insert to replace the usual steam directing member on a cappuccino machine. Usually in the art this is a long thin tube made of materials including for example stainless steel that is placed into milk, and then hot air and steam travel through the implement to make the milk frothy.

In a preferred embodiment of the invention this is replaced with a device including for example a disposable or separately removable implement. By way of example a disposable implement can be used including for example a plastic or other material straw like device.

Preferably a straw like device can be used to connect in place of the normal implement, and hot air and steam blow down it to froth the milk. After this the straw can be disposed of rather than needing to clean it. Preferably a device can be attached to the bottom of the straw to restrict the steam and water coming out. This can serve to make the spray more accurate for frothing the milk.

Making such a device is very simple. In a preferred embodiment it just needs to restrict the flow enough to make the steam spray out more. An equivalent would be devices placed on the end of garden hoses to make them spray more. Variations on how to make the shape spray are well known in the art.

This device can also be disposable. In an example the users froth the milk and then dispose of the tube and the flow restrictor on its end instead of having to clean them.

In a preferred embodiment a variation of the normal implement is thin enough to have a straw go over it, so as to be able to dispose of the straw later and make the implement easier to clean. Preferably a stopper is placed on the bottom so milk doesn't get in between the implement and the straw.

In a preferred embodiment a special gel is used to coat the implement, so that it doesn't contaminate the milk. It can be a compound for example that is either insoluble or slowly dissolves in the milk but doesn't affect the taste. Since the milk doesn't stick to the implement it is easier to clean.

In a preferred embodiment a disposable implement is made to insert into the cappuccino machine, specially designed for the job to maximize the efficiency of the process.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### DATA STORAGE IN OPTICAL DISKS

### ABSTRACT

An optical disk is designed to contain more data.

### BACKGROUND OF THE INVENTION

The present invention relates to the field of optics.

### SUMMARY OF THE INVENTION

Optical disks such as Compact Disks and Digital Versatile Disks work by making small pits in their surface, and then reflecting a laser beam off them. It would be desirable to be able to increase the amount of data that could be stored on optical disks.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves creating pits in the surface of an optical disk including DVD's and CD's so that the holes are not precisely in a line. Because they can be to one side they reflect less light which can be interpreted as a darker return. DVD refers to a Digital Versatile Disk and CD refers to a Compact Disk.

In a preferred embodiment the laser instead of or in addition to moving over one complete track may move over for example ¼ of a track at a time when burning the disk. Because of this it can offset the holes, marks, optical magnetic imprints, etc that it burns into the optical disk a predetermined amount out of line so the reading laser does not hit them directly. This causes the signal to be weaker on the return.

For example there might be a signal return (reflection) or not as 1 and 0 as with standard optical disks, and say two grades of darker returns of light because of the offset holes, pits, magnetic imprints, etc which would give a base 4 on disk information.

Preferably the disk can also be read by a beam of a predetermined cross section including wider for example which could detect more exactly how offset the hole is and derives more data from this. Base 4 is just an example there could be even 16 different amounts of offset pits resulting in Base 16 of information.

Preferably offsetting the pits may require there to be less tracks on the optical disks as each track might be wider. This is offset however by the increase in data. For example if the pits were offset by ⅛ the normal width of a track and this allowed two other levels of brightness of the beam as it reflected back then this would make 4 levels of brightness, 0,1,2,3. If this can be done in less room than doubling the width of a standard data track then this represents a net gain of the amount of data on a disk.

For example if the track needed to be ⅛ wider each side this would amount to the whole track being ¼ wider and thus there would be ¼ less tracks on the disk. This would translate into approximately ¼ less data on the disk.

If this allowed however two extra shades of albedo the laser detects other than bright or dark, pit or land, then the data is doubled for a total in this example of 1 ½ times as much as a standard disk.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### OPTICAL DEVICES

### ABSTRACT

Optical devices including switches are disclosed which include the use of circularly polarized radiation.

### BACKGROUND OF THE INVENTION

The present invention relates to the field of optics.

### SUMMARY OF THE INVENTION

There are many kinds of optic switches available. They can for example be used in displays, in optical circuits, routers, etc. it would be desirable to add to the techniques for making optic switches.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a switching means including using circular polarization. A device, preferably including a first and a second polarized substantially transparent medium (hereafter referred to as a plate) sets a beam circularly polarized at a predetermined distance per revolution of the polarized beam. A third polarized plate can be placed at a predetermined position so the beam hits it. A beam here includes all electromagnetic radiation, but visible light is often used in optical circuitry. Preferably the beam is a laser beam but incoherent radiation is also contemplated.

In a preferred embodiment when a beam is circularly polarized it alternates from vertical to horizontal polarization. This change occurs over a certain distance. Therefore if the beam arrived at the third polarized plate which in this example is vertically polarized at a first location when the beam was still horizontally polarized then the beam would be blocked. If the beam arrived at the third polarized plate which in this example is vertically polarized at a second location when the beam was still vertically polarized then the beam would go through it.

By changing the location of the third plate then the beam can either be blocked or allowed through. In between these two alternatives the beam can be attenuated in strength by placing the third plate at a third location. This third location is preferably in between the first and second locations. The third plate can be moved by many means including for example sound waves, ultrasound, electromagnets, electrophoresis, piezoelectric devices, electrostatic forces, springs, resilient materials, electrical attraction and/or repulsion, levers, cogs, other mechanical devices, etc.

In a preferred embodiment the beam passing through the exampled three plates can be modulated by changing the positions and/or orientations of the three plates. Of course additional plates can be used as well. Additionally the first two plates are used here to create a circularly polarized beam. Any other technique to create a circularly polarized beam and/or modulate it in the relevant arts is also included.

The data to be modulated can be of many kinds including for example sound waves, digital or analog data, video imagery, etc.

In a preferred embodiment the beam can be modulated to make the beam turn on and off like a binary signal by changing at least one of the polarized plates in its position and/or orientation.

In a preferred embodiment at least one plate is changed in position and/or orientation by at least one magnetic means. For example the position of at least one plate can be changed by having a material it in that is attracted to or repelled by a magnet. Preferably an electromagnet turns substantially on and off to change the position and/or orientation of at least one plate to modulate the beam.

In a preferred embodiment at least one plate can be changed in its position and/or orientation by sound waves including for example from at least one piezoelectric means.

In a preferred embodiment the direction in the polarization of at least one plate can be changed in a predetermined way to modulate the beam. For example a Faraday rotator or an equivalent can be used.

In a preferred embodiment the devices disclosed herein can be used to modulate at least one pixel in a display. For example if each pixel in a display used the means to modulate a circularly polarized beam it could display different shades of brightness and darkness.

In a preferred embodiment the devices disclosed herein and their equivalents can be used to create a switch and/or optical transistor in optical circuitry.

In a preferred embodiment the device need not be restricted to the use of polarized plates. In the broadest terms the switch consists of two parts of which there are many mechanisms available in the art to use. The first part is a means to create a circularly polarized beam and to vary its rotation of polarization over a distance. The second part is a means to block or allow the polarized beam to pass through according to the second part's position.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### MULTI LAYERED CONTAINERS

### ABSTRACT

A system of increasing the strength of containers and walls is disclosed, including by using a series of other containers and walls.

### BACKGROUND OF THE INVENTION

The present invention relates to the field of strength of materials.

### SUMMARY OF THE INVENTION

One major problem in construction is the ability to hold in strong pressures. Submarines, dams, bottles of gas, and capacitors all have a limit on how much they can hold. It would be desirable to increase this holding capacity.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

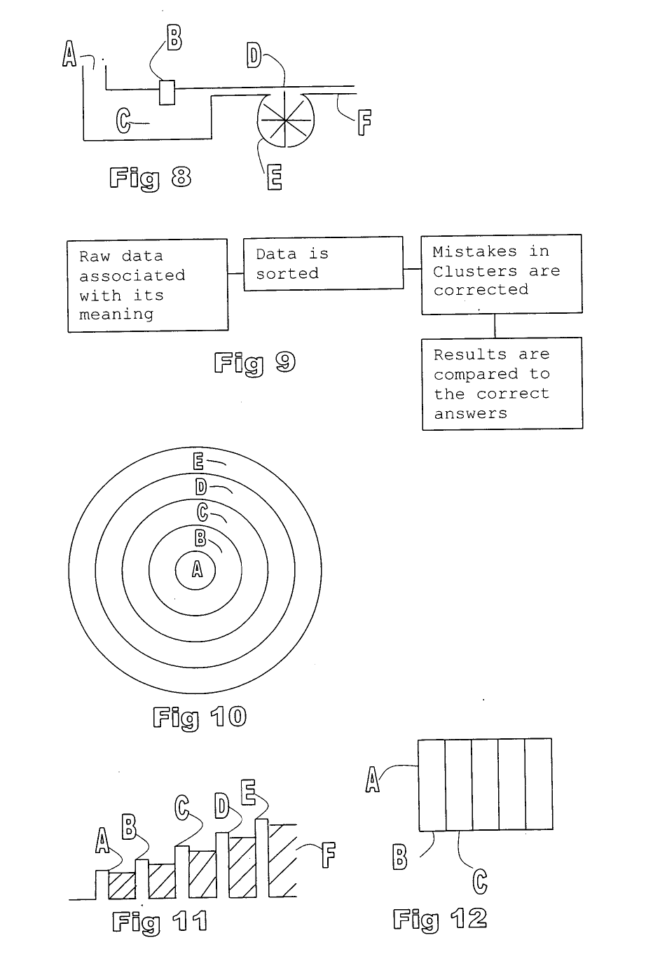

FIG. 10 shows 5 containers inside each other.

FIG. 11 shows 5 walls of a dam.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a system of increasing the strength of an enclosure and/or wall in steps.

In a preferred embodiment a first container is designed to hold gases at high pressure. This first container is put inside a second container which is put inside a third container, and so on. In this example there are five containers inside each other. Preferably the first container hold more pressure than the second container, the second holds more pressure than the third, the third holds more pressure than the fourth, the fourth hold more pressure than the fifth. Each container in this example holds more pressure than the container surrounding it.

In broad terms, a preferred embodiment of the method is comprised of the following steps. One of the major problems in holding gas pressures for example is the container exploding. In FIG. 10 the central container A contains “a” atmospheres of pressure, This is inside another container B which also contains “b” atmospheres, which is inside another container C with “c” atmospheres or bars of pressure, inside D with “d” bars of pressure and inside another container E with “e” bars of pressure.

Consider as an example the maximum strength of each container is 300 bar. In this case then E would have a capacity of “e” of 300 bar since in this example outside it is sea level air pressure of 1 bar. Now then D can have a value of “d” of 600 bar since the pressure inside D is 300 bar more than the pressure outside it. Then C would have a pressure of 900 bar, B of 1200 bar, and A of 1500 bar. One result is the overall system of containers can hold more gas pressure than if there were just one container.

Preferably there is a mechanism to transfer gas pressure from one container to another to equalize pressure as the containers are depleted and refilled with gas. For example valves to regulate pressure and to pump more pressure into a container are well known in the relevant arts. Because the containers are inside each other it is not possible to directly access valves between container for example between the first container A and the second container B.

The valves between containers can be regulated by many means including for example by remote control using radio communication, by a mechanism that goes through the outer containers through seals to reach the preferred container, etc.

In broad terms, a preferred embodiment of the apparatus involves using these containers with air cars as it allows a higher air pressure to be contained in them. Air cars use compressed air to run but the strength of the containers severely limits their range between refilling the pressurized containers.

In a preferred embodiment a dam can be constructed using these principles. In broad terms, a preferred embodiment of the method is comprised of the following steps. In FIG. 11 a first dam wall A is constructed, and then a higher and thicker second wall B is constructed behind it, and the gap between them is filled with water.

This water exerts pressure in all directions so the water acts as a partial buttress for B since the water in the dam is on both sides of it. Preferably the gap between A and B is narrow, though any width can be contemplated. Then a third, higher and thicker dam wall C is built behind B, then a fourth wall D is built behind C, then a fifth wall E is built behind D, each preferably higher and thicker than the last. F represents the shaded areas which in this example would be water from the dam. Five is used as an example in this application to explain the principle though any number that is suitable for the application can be used. For example two walls could be used if desired. Since each wall has water between it and the next then this acts to buttress the next wall. This then can be an easier way to build a dam.

In broad terms, a preferred embodiment of the method is comprised of the following steps. Submarines could also be built according to these principles.

There could be multiple containers as described earlier but in this example the pressure would decrease in each additional layer. For example in FIG. 10, A contained more pressure than B, which contained more pressure than C and so on. Here A would contain less pressure than B, which would contain less pressure than C, and so on with however many layers is required. This is because the people who might be inside container A for example would prefer a lower air pressure. Multiple layers such as these examples could also protect submersibles going to great depths as the overall pressure can be distributed amongst the containers.

In broad terms, a preferred embodiment of the method is comprised of the following steps: A capacitor has multiple layers each with increasing charge so the overall can hold a stronger current. For example with capacitors there is typically a positively charged area and a negatively charged area. The ability of the capacitor to hold energy involves how much charge these areas can hold.

If for example the negatively charged area was multi layered with each layer holding a greater charge than the layer before then this would assist in preventing arcing among other advantages. In the same way positively charged layers with each layer holding a stronger positive charge would also increase efficiency. In FIG. 10 for example A might contain a first level of negative electrical charge, B a stronger level of negative electrical charge, C a stronger level of electrical charge than B, and so on. The layers with a stronger charge are encapsulated in other layers with a weaker charge, which assists in preventing a leakage of electric current.

In broad terms, a preferred embodiment of the method is comprised of the following steps: A purpose of the invention is to provide magnetic shielding. In FIG. 10 for example A would contain devices with a strong magnetic field which needs to be shielded. B can then contain other devices with a substantially weaker magnetic field, and these tend to shield the stronger magnetic field of A. As many layers as required, each preferably with a progressively weaker magnetic field can improve the shielding, and for any other purpose.

The outer layers as disclosed in these examples have a progressively decreasing strength which tends to interact with the stronger magnetic fields inside. This can allow stronger magnets to be closer to sensitive equipment.

This system of shielding magnetic fields can in addition be used as disclosed in my PCT WO02054378, where magnets can be used to store and deliver energy. In broad terms, a preferred embodiment of the method is comprised of the following steps. A first magnet is separated from a second magnet. They are additionally connected to mechanisms that would create energy and/or motion as the magnets move toward each other. Shielding the array with weaker magnets can allow strong magnets to be used more safely.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### DATA MANAGER

### ABSTRACT

A system to manage data including between a shop and a customer. This includes managing cookies in a computer.

### BACKGROUND OF THE INVENTION

The present invention relates to commerce and computing.

### SUMMARY OF THE INVENTION

Cookies are commonly used in computers, but are a frequent source of abuse with spy ware. It would be desirable to manage these more closely with specialized programs.

Further aspects of the invention will become apparent from consideration of the drawings and the ensuing description of preferred embodiments of the invention. A person skilled in the art will realize that other preferred embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific preferred embodiments by which the invention may be practiced. It is to be understood that other preferred embodiments may be utilized and structural changes may be made without departing from the scope of the invention.

The best mode of the invention involves a device to record transactions and activities of a user. Preferably these activities include shopping, ecommerce, loans, renting, work related activities, bank transactions, computer browsing, etc.

In broad terms, a preferred embodiment of the method is comprised of the following steps. In computers cookies are a well known way to record a browser's details. Often they are used to store passwords and preferences of the user, and also to try to guess their shopping habits to place advertising more effectively.

A means can be employed to act in ways including like the function cookies have in computers, in other transactions. In broad terms, a preferred embodiment of the apparatus includes a communication means, for example at least one of a smart card, a credit card like sized cards that can be placed in a reader, preferably some kind of device that can record information from the enquiring means and have it updated, a mobile phone to transmit and/or receive data, a Personal Digital Assistant to transmit and/or receive data, jewelry and other devices worn which can transmit and/or receive data, laptops, wearable computers, coupons, any kind of card which can contain data, books, magazines, foodstuffs, any mechanical and/or electronic device, etc. Herein it is referred to as a cookie means.

Anywhere in this total U.S. application the following terms are used: “including for example”. This means that the items that follow after this term could each be included as an example. It does not mean that they all have to be included together with each other in the invention, though this could also be possible.

In broad terms, a preferred embodiment of the method is comprised of the following steps. A user goes to shops, for example a supermarket. Often they give out special coupons, and have a good idea on what the average shopper buys because they can check their inventories and how they change over time. In a preferred embodiment the user has a special device, the exampled cookie means.

Preferably as he makes transactions including for example by cash, credit card, debit card, etc he can use the cookie means in ways including for example to record information the shop can use to assist them in their statistical analysis. In addition this information can be disclosed to other shops and entities according to the desires of the user.

Preferably the cookie means can additionally be an extra feature on another card including for example at least one of a Fly Buys Card, a credit card, a debit card, any kind of issued device, etc.

For example the exampled cookie means may contain preferably approximate information about the user including for example age, size, sex, marital status, details of family, etc. The cookie means might also accumulate data about what the user buys. When the exampled cookie means (or any other computing means) is used the shop can read the information stored in it. Preferably it can read an identifier and look up its database to compare what the user has bought before, and update those details with the new purchases.

In broad terms, a preferred embodiment of the apparatus would include a smart card. The user would use this card when he makes a transaction. In a shop for example the card may be able to be swiped or scanned such as is done with debit cards and credit cards. The shop would read information on the card, and preferably some history of the user's shopping habits.

In broad terms, a preferred embodiment of the apparatus includes using a computing means including for example a mobile phone, Personal Digital Assistant, laptop, etc. The computing means can establish a connection with devices for the shop or whoever is being interacted with. Preferably this is a secured connection using encryption including for example IPSec, Kerberos, etc. The connection with the exampled shop can be made in ways including for example a cable, plus, wireless, Bluetooth, infra red, reading a bar code or other identifiers displayed on the screen on the computing means, ultrasound, etc. The connection then exchanges data as preferred, including to the example of a repository.

In broad terms, a preferred embodiment of the apparatus includes using devices worn on or in the user. For example these can be worn and include for example piercings, devices painted or tattooed on the skin, devices on or replacing fingernails and/or thumbnails, brooches, watches, rings, tongue piercings, nose rings, earrings, combs, eyeglasses, contact lenses, garments, wearable computers, etc. Inside these there can be a computing means to communicate with the shop or other entities as disclosed. Implants with a computing means can also be used.

These details may in a preferred embodiment be stored in a repository available for preferred entities. For example Shops that participate in the system may examine the card which preferably contains an identifier. The card may additional contain useful information for the shop but preferably retaining some privacy for the user. The repository may be accessed as a means including for example a web site, a file server, any kind of network, the internet, etc. Preferably a secure connection is made to the repository including using for example Kerberos, HTTPS, Extensible Authentication Protocol, IPSec, and other encryption known in the relevant arts.

Preferably the shop might then examine the accumulated history and information about the user, and update this data with information about the current activities of the user including purchases. Of course this information can partially or wholly also be contained in the cookie means, preferably in a secure encrypted form.

Preferably in return the shop or other entity may opt to give the user discounts, coupons, etc which can be programmed into the cookie means and database. Preferably the user can request a print out of available discounts and coupons so he can remember them, additionally they can be on the receipt. The coupons and similar means preferably have bar codes and identifiers that refer only to the user or others known by him so if they are used the database can be updated that they were tendered by the user.

Preferably in return for users giving relatively anonymous information about them they might receive a benefit including for example discounts and the shops can better work out what demographic groups are buying what.

In broad terms, a preferred embodiment of the method is comprised of the following steps. A computing means might communicate with the entity by a certain identifier including for example a phone number, fax number, email address, instant messaging address, SMS number, IP address, etc. On connection the entity, here a shop as an example might then receive the identifier of the user in a way including for example an email address, phone number, instant message address, any equivalent means, etc. The preferred transactions including the cookie means are also arranged.

Preferably the cookie means, here a card as an example, might be scanned with the same machine used for credit cards and debit cards, or it could have its own scanning device.

In a preferred embodiment similar transactions can be done with Personal Digital Assistants, laptops, and any other computing means. Communication can include infra red, ultra sound, radio, wireless, Bluetooth and all other protocols and communication means known to the art. Custom devices can also be employed including flash memory USB connectors, devices on a key ring, devices that can be scanned by a bar code reader to get the identifiers, devices using radio identifiers, like RFID's to identify the cookie means, and the user. The user may additionally if desired use a password or PIN to input into a means including for example a keyboard, any other device with buttons to insert numbers and letters, etc at the shop, like people do when they use a debit card.

In a preferred embodiment the user may have other semi anonymous concepts that he shares, in exchange for receiving benefits. For example he might have such a cookie means on a computer, where including for example when he logs onto sites this cookie means is allowed to be read and certain information updated on it. The cookie means could then have programs that run it, and they can check to make sure that no one is tracking information they shouldn't.

Preferably the programs may interface with the cookie folder on a computer in a mode of operation. On Windows computers for example cookies are kept in a special folder.

Preferably as the user goes to web sites cookies are in a preferred embodiment placed in his computer and these can be managed by the cookie programs to determine if the information is accurate, if it stays within the defined security and privacy boundaries, etc. If not then they can be changed including for example deleted, altered, disabled, etc.

In a preferred embodiment the user has an agreement with various companies according to the cookie means, in this example including with programs managing cookies on a computing means. The programs preferably are to interpret their cookies and to manage them including for example to rewrite them, delete them, etc according to the policies and profile of the user. With companies that do not cooperate the cookie program might preferably have a second security policy including further altering and managing the cookies, or deleting them.

In broad terms, a preferred embodiment of the method is comprised of the following steps. The cookie folder then might preferably exist in a virtual sense, cookies would be received and instead of or in addition to being stored in a cookie folder the cookie program stores them elsewhere including in memory, perhaps in a secure and/or encrypted area. Because cookies have no way of running as a program this would be difficult for companies to subvert.

Preferably spyware would also be intercepted in the same way. In one preferred embodiment companies might agree to certain access to the cookie programs in return for not trying to use spyware. Also companies would preferably agree not to share the profile information to spammers and spyware users, to give them an incentive to use the cookie program fairly. If the cookie program information was encrypted spyware could steal some information but likely not information as useful.

In a preferred embodiment the cookie means may have default security settings, custom settings for the user, etc. It may include questions periodically received from marketers, and other people to improve the profile, and various questionnaires. Included would probably be what benefits are associated with this information. It may include storing preferred information about what web sites are visited, according to certain constraints. For example there could be a list of major sites that participate in using the cookie program and it may record when it went to these sites, what the user looked at and when the user left. This list could be updated as more companies used the cookie means and kinds of sites that would be embarrassing to the user and ones he would prefer to keep confidential would not be included.

Preferably as the user visited the preferred sites the cookie program would make a list of them as described, and according to the controls in place disclose some of this to participating companies and people.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative preferred embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### A VARIABLE TRANSPARENT MEANS

### ABSTRACT

A transparent means can be adjusted in the amount of radiation it lets through.

### BACKGROUND OF THE INVENTION

The present invention relates to optics.

### SUMMARY OF THE INVENTION

Windows typically need blinds or curtains to block the light through them. It would be desirable to be able to block this in other ways.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 12 shows a transparent medium with alternating stripes of vertical and horizontal polarization.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a plurality of transparent objects each of which is polarized in a preferred direction. These can move in relation to each other, preferably by a means including for example moving from side to side, being flipped over, moving up and down, rotating, etc. Preferably as they move in relation to each other the light passing through at least two of them is reduced in ways including for example intensity, color, contrast, brightness, etc.

In a preferred embodiment there are two substantially circular polarized windows arranged in a frame. Preferably they are in a track so at least one can be easily rotated compared to the other, by hand, by a mechanism, by electric motor, etc. preferably the track includes a means for the exampled windows to rotate more easily, including for example on rollers, ball bearings, a lubricant, a low friction material such as for example certain plastics, etc. In addition the frame can be made of suitable materials including for example aluminum, wood, steel, plastic, etc. The sections can be mounted by parts including for example nails, screws, bolts, rivets, welds, solder, glue, fiberglass, etc.

Preferably this array can be set in places including for example a wall, door, ceiling, etc so the shape seen is like a normal window shape. For example the circular shapes are mounted inside a frame with an inner and outer wall on the sides of the frame. Preferably there is an opening in the frame which is similar to apertures used in buildings, including for example square, triangular, rectangular, pentagonal, etc. Through the aperture only part of the exampled round window is seen so it appears to be the same shape as the aperture.

In use, a preferred embodiment of the invention is operated by adjusting a first substantially transparent medium to change its orientation in relation to a second substantially transparent polarized medium. Preferably then as one window turns the brightness coming through the aperture, in this example the window, can be adjusted. Additionally optional layers can be placed on the inside and/or outside of the enclosure to remove the direction of polarization to a more diffused direction all over. For example the light coming into the enclosure, including for example a room, boat, shed, etc. would be polarized in a first direction. An additional layer on the inside could diffuse this polarization. An additional layer on the outside could preferably diffuse the polarization on light exiting the enclosure.

Preferably the array can be designed to reduce noise like double glazed windows. Preferably the circular array can be mounted on a frame and a hinging means so the array can be opened like a window. The many ways a hinged window opens are well known in the art.

In a preferred embodiment stripes in a first window are arranged. Preferably the stripes alternate between a first direction of polarization and a second direction ubstantially 90 degrees from the first direction. This is shown in FIG. 12. A shows a first transparent medium. B and C would be alternating polarized materials.

A second window is arranged with substantially similar striping, each stripe alternating between a first direction of polarization and a second direction substantially 90 degrees from the first direction. Preferably one stripe is a vertical polarization and the alternating stripe is a horizontal polarization.

Preferably the actual orientation of the polarization can be important in some situations including for example where a particular angle of polarized light often enters into the window so the angle of polarization might filter it. This can happen for example when light reflects off water, and the filtering can be observed through some polarizing filters on cameras.

Preferably oblique polarization is suitable in preferred situations as long as the strips alternate with a polarization pattern that is substantially at 90 degrees to each other.

In broad terms, a preferred embodiment of the method is comprised of the following steps. Preferably a first transparent medium including for example a window, pane, aperture, glass door, louver, etc is placed so that the polarized strips in a first direction line up with the stripes in a first direction in the second transparent medium, so the user can see through both panes.

Then with a mechanism including for example sliding the window to the side, up, down (as appropriate), using a motor, lever, cog, switch, pulley, etc one pane is moved so now the strips are aligned so the strips polarized in a first direction are over the strips polarized in the second substantially perpendicular second direction. Now it is difficult to see out the exampled window, except there may be some small strips on the edges of the polarized areas where one can see out. This effect if undesirable can be minimized by having the polarized panes closer together.

For example if a first strip is polarized vertically, and the second strip in the second window is polarized horizontally then one could not see through it but there may be a strip on the edges between the first and second strips where light can leak through from the neighboring strips on the second window which are of course vertically polarized.

In broad terms, a preferred embodiment of the apparatus is comprised of the light being attenuated by having to go through two transparent media, the first of which has a polarization in a first direction and the second media has a polarization in a second direction.

Of course the strips of polarized material is an example of how the polarized material might be arranged, there can be as many possible variations of patterns as can substantially work to block the light when required.

For example a checkerboard pattern of polarized squares can be used, as long as a first set of squares are substantially polarized at right angles to a second set of squares. If the areas polarized in a first direction are not completely perpendicular to the areas polarized in a second direction then the light may not be fully blocked or let through but this may desirable for some effects. For example it may be desirable for the transparent media to not fully block all the light, but to partially block it. A good analogy is sunglasses, and tinting in cars is used to partially block light.

In a preferred embodiment the first and second transparent media might be set to block the light coming through them from a relatively high amount of light blocked to a relatively low amount of light blocked. This might be useful for example to block more light at noon and less in the morning or afternoon.

In a preferred embodiment other patterns are also desirable. They can be shapes including for example triangles, squares, rectangles, pentagons, circles, ellipses, any tiling pattern, etc.

For example there could be circles arranged in rows and columns which line up to let light in and when moved cross they extinguish the light. Clearly because circles don't tile perfectly together there is a space between the circles which can be made opaque, transparent, translucent, have patterns, colors, etc according to the preferences of the user. So while the principle can be readily extended to any shapes known in the art the most efficient shape is not always preferred and thus artistic and other functional patterns have their uses too.

Any part of this total US application can be presumed to be preferably connected with, embodied, and used with any other part.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus,.variations that do not depart from the gist of the invention are intended to be within the scope of the invention. Such variations are not to be regarded as a departure from the spirit and scope of the invention.

### VARIATIONS IN LIGHT BULBS

### ABSTRACT

Light bulbs can contain variations including an extra filament which gives off light until the bulb is replaced. They can also include a sound device to alert the user to replace the bulb.

### BACKGROUND OF THE INVENTION

The present invention relates to the field of light bulbs.

### SUMMARY OF THE INVENTION

A lighting means can always be dangerous if it stops working. For example if there are lights in an important position including for example control panel, brake lights in a car, lights in a stairwell, etc broken then people can be injured. It would be desirable to have a backup means to tell this so the lighting means can be replaced.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to signal a user when an important piece of equipment including for example circuitry, rivets, light bulbs, transistors, controllers, levers, cogs, computers, etc is malfunctioning.

In a preferred embodiment a user can be notified if a light bulb is broken. In or near the base of the bulb there is a signaling device, preferably sound making, including for example a piezoelectric device.

When the exampled bulb filament breaks this would lead to a reduction in the current the bulb is using, and hence other devices could be activated by this. For example the extra current could cross a threshold and cause a sound emitting device to make sounds including beeping, a constant sound, playing a kind of tune, a siren sound, etc.

In a preferred embodiment the device might measure the filament as a circuit and be able to detect it is working when the filament is unbroken. This could be done for example by sensing voltage or amperage like a meter does such as made by Fluke. It could do this in many ways including for example sensing the amount of amperage consumed, whether the voltage has jumped by some of it not be used by the bulb, whether the resistance has increased because the filament has broken, etc.

In a preferred embodiment there can be at least one other filament under over or even beside the main filament in a bulb. Preferably this would allow current through at all times but a switching means can also be employed. When the main filament breaks the current goes more through the secondary filament which is preferably designed to glow at a lesser strength than the main filament, alerting people the bulb needs replacing.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### REMOTELY ACCESSIBLE EMITTERS AND RECEPTORS

### ABSTRACT

Emitters and/or receptors can be worn separately by a user. The devices can communicate by a means including wireless with a computing means.

### BACKGROUND OF THE INVENTION

The present invention relates to the field of computing.

### SUMMARY OF THE INVENTION

Mobile phones are a potential health hazard with radiation. They are also annoying to have to carry around and dangerous to use while driving. It would be desirable to have a system to eliminate these drawbacks.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves mobile phones, Personal Digital Assistants, laptops, and other devices using emitters and receptors including for example displays, cameras, microphones, speakers, antennae, etc.

It may be desirable for these exampled emitters and receptors to be placed in preferred locations not physically connected onto the actual body of these and other devices.

For example in a preferred embodiment emitters and/or receptors can be placed on and/or in the body, pets, plants, cars, furniture, etc. For example speakers used with devices including Personal Digital Assistants, laptops, mobile phones, etc can be made as devices that are connected to the skin. One good example would be an earring shape that is worn and that can receive signals from the emitting devices. In this way the user need not hold for example a phone to their ear but could hear from the exampled earring.

Of course the word “earring” is not intended to be limiting but includes any shape that is attached in any way for example piercing, gluing, embedding, screwing, riveting, etc the device on, in, or near the ear. For example it could be implanted inside or near at least one eardrum. It can also be attached by any of these exampled ways onto anything else and brought into proximity to the ear as desired. For example the emitter and/or receptor may be attached to at least one fingernail, in and/or on at least one finger, or other part of the body.

Preferably communication with the devices described herein may include for example wires, sound, electrical signals on the skin, radio waves, electromagnetic radiation, infra red, all other communication signals known in the art, etc.

In a preferred embodiment a microphone may be used in a substantially similar way. For example it may be attached in ways including those mentioned with the emitter/speaker referred to. In a preferred embodiment the microphone, emitter and/or receiver, can be a piercing substantially on or near the lips, tongue, jaw, chin, eyebrow, forehead, in the hair, in at least one tooth, in the throat area, and so on.

Preferably charging these devices can be from many sources including but not restricted to for example solar energy, receiving a beam of energy including sound, electromagnetic radiation, using motion created by motion of the user to kinetically create energy substantially similar to the way some watches do, etc. Also they may recharge by using energy from the body, what they are attached to including biological chemical reactions, etc. As was made clear these can be attached to anything, not limited to a human or animal.

The examples and embodiments are referring to the devices on a person to illustrate the principles involved, not to limit the invention in any way to humans. Here as in any part of this application, the scope is preferably defined at least by the claims. Also in this application any part which can function as a separate device can be regarded as a separate invention with its uses and scope defined by the claims, not only by the context in which it is disclosed.

Preferably such devices may also include cameras and displays, and of course all of these examples are not intended to be limiting, and can include any kind of emitter and/or receptor in their place. Antennae for example may be placed as described as can other substantially electronic devices including miniature circuitry, mobile phone components, computer chips and circuits, and so on.

Preferably cameras as a preferred embodiment may be placed anywhere as described including for example embedded, pierced, glued, etc. In an example they could be attached to at least one fingernail. Displays of any kind can be used also in any of these ways described here.

In a preferred embodiment a display might be built into a device to be attached including contact lens like devices, retina implants so an image can be viewed by the user. It can also be built into a frame including eyeglasses, monocles, etc.

Preferably any of these devices can be attached including for example by chains, pins, rope, swivels, clips, etc. In a preferred embodiment emitters and/or receptors including display and cameras can be attached to and/or in a frame, including helmets, eyeglasses, caps, hats, etc. For example one or two small displays such as liquid crystal or similar screens could be attached to eyeglasses to receive signals from devices including mobile phones, Personal Digital Assistants, laptops, computers etc. These displays would show a 2D or 3D image to the user. They could also contain receivers such as cameras to monitor eye movement and use this as an input. They can have other properties including being substantially transparent as desired, having microphones, speakers, antennae, computer circuitry in or on them.

For example the devices could alter the images shown including changing the apparent focus according to what the user looked at, regard the user looking at an icon on the display as an indication to make a change including changing the image, opening files, starting sounds, manipulating machinery, turning devices on or off, changing stations on TV, radio, all kinds of media presentations, and so on.

Preferably attachments as described herein could hook onto eyeglass like frames and hinge upwards and/or outwards, substantially like some sunglasses attach to eyeglasses as seen in the art.

In a preferred embodiment a frame holding at least a speaker and microphone and also if desired a display and camera can be connected to the computing means including for example mobile phones, Personal Digital Assistants, etc. This frame would preferably be connected by means including for example a cable, wireless, infra red, sound, any kind of signal transfer means known in the relevant arts, etc.

In a preferred embodiment people often use a hands free with a mobile phone. A frame can be used to hold the speaker and microphone and it can connect to the exampled mobile phone, Personal Digital Assistant, etc in many ways including for example by plugging into the mobile phone by cable, wireless, Bluetooth, infra red, sound waves, other electromagnetic radiation, etc.

Preferably the frame can include a touchpad or other means to input data such as for example pressing buttons, dialing numbers, a trackball, joystick, wheels, knobs, potentiometers, etc. This controller data can be sent down the connecting means, in this example a cable, wireless, etc.

One advantage is the frame can look like a mobile or any shape desired, but also keeps the radiation away from the head. Looking more like a phone it can be less embarrassing to use as with a hands free kit people often see the user talking apparently to no one.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### FOOD COOKER AND SEALER

### ABSTRACT

A means is used to open parts of eggs and other foodstuffs, and insert materials such as spices, and then the egg is resealed. This enables them to cook in the example of eggs with the shell on and then be eaten with the flavorings inside.

### BACKGROUND OF THE INVENTION

The present invention relates to the field of cooking.

### SUMMARY OF THE INVENTION

Eggs cooked in the shell are relatively bland even though they are popular. It would be desirable to have a way to improve the flavor of eggs and still enjoy them as soft or hard boiled.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a device entering into an egg for example and has a means to insert flavors, spices, other food ingredients into the shell. Then the devices seal the egg with closing means including for example a putty like compound, a stopper, plug, a wrapping, a glue, etc.

In a preferred embodiment the egg can then be shaken to distribute the flavor through it and then cooked. This can give hard and soft boiled eggs with various flavors.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### ENERGY CONVERSION

### ABSTRACT

Energy can be stored in a chemical compound.

### BACKGROUND OF THE INVENTION

The present invention relates to the field of energy.

### SUMMARY OF THE INVENTION

The world is running out of oil. Electric cars have one problem in that they are difficult to run very far without recharging. Cars that run on compressed air have the same problem. It would be desirable to have a way to store energy in a smaller space so vehicles could go for longer without refueling.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves creating chemical compounds to store energy. This energy can come from many sources including for example nuclear energy, burning fossil fuels, solar energy, renewable energy, etc.

While energy is readily available in society one major problem is in storing energy efficiently. For example power stations commonly create power at certain times and then at other times such as at night the demand for electricity is lower. Because they cannot efficiently store the energy much of it can be wasted.

Also in vehicles it is difficult to store electricity to drive for long distances, for example in batteries. Electricity can be used to compress air for running vehicles but they also can only run for short distances before being refilled with compressed air.

Because of these reasons oil remain popular for driving many vehicles, but this contributes to pollution, extra CO2 in the atmosphere and global warming. Also many third world countries are rapidly developing and will also want to use the dwindling oil supplies to run vehicles, adding more pollution.

In a preferred embodiment fuels are made including using some gases directly from the atmosphere. For example methane is CH4, so this can be made using CO2 from the atmosphere and hydrogen from perhaps water. The methane can then be used as fuel in ways including for example to run vehicles, cars, ships, planes, fuel cells, etc. Because the fuel would be made by taking carbon from the atmosphere burning the fuel would only return that carbon to the atmosphere. This would be more neutral towards global warming than burning fossil fuels. Of course other compounds could also be made for fuel by means including taking CO2 from the atmosphere. Methane is an example. Other carbon compounds suitable for using as fuels are well known in the relevant arts, as is their synthesis.

In a preferred environment the Sabatier methanation process can be included as a means to make a fuel, methane in this example. The equation for the formation of the exampled methane is CO2+4 H2=CH4+2 H2O. Carbon dioxide with hydrogen can form methane plus water. In the Sabatier methanation process the reaction occurs at around 400 degrees Centigrade with a nickel catalyst.

In a preferred embodiment the ratio of hydrogen to Carbon Dioxide is 1:1 but any ration can be used though it may not be as efficient for the preferences here.

In a preferred embodiment once the exampled methane is made it can be readily used as a fuel. Many vehicles including cars running on natural gas, internal combustion engines are easily convertible to use it. Society already has an extensive infrastructure for transporting gas, so converting this to methane should not be impossible.

While methane production in this way may not be as cheap as removing oil and gas from the ground it has a potential to solve three very important problems. The first is that fossil fuels are limited in supply, methane formed in this way is virtually unlimited in supply and can replace oil and gas in the way it is consumed. The second is that this system is relatively neutral to global warning because it is preferably made from carbon that will be returned to the atmosphere, and then recycled to make more fuel.

The third is that methane is a fuel that takes a relatively small space compared to batteries and compressed air. Vehicles for example that run on methane or another fuel made from atmospheric gases including for example carbon dioxide, carbon monoxide, etc would go further between refueling. Hydrogen burning cars have more problems, for example hydrogen is much harder to store than methane.

In a preferred embodiment the carbon dioxide is preferably taken from the atmosphere in a means including for example freezing the air sufficiently for the CO2 to become dry ice. The technology for this is well known, CO2 is readily available commercially. The hydrogen can come from many areas including for example electrolysis from water, hydrogen from plants that emit hydrogen, waste products, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### VARIABLE PRESSURE IN TIRES

### ABSTRACT

Devices are placed inside tires to later the air pressure. This enables the tire to change its air pressure according to the situation such as for cornering and braking. The principle can also be used in shock absorbers.

### BACKGROUND OF THE INVENTION

The present invention relates to the field of vehicular transport.

### SUMMARY OF THE INVENTION

Tires have a standard pressure even though the maneuvers a vehicle makes could often be improved by changing air pressure. Also air compresses quickly and makes a tire become very hard. It would be desirable to be able to adjust tire pressure and regulate the compressibility of the air inside them.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

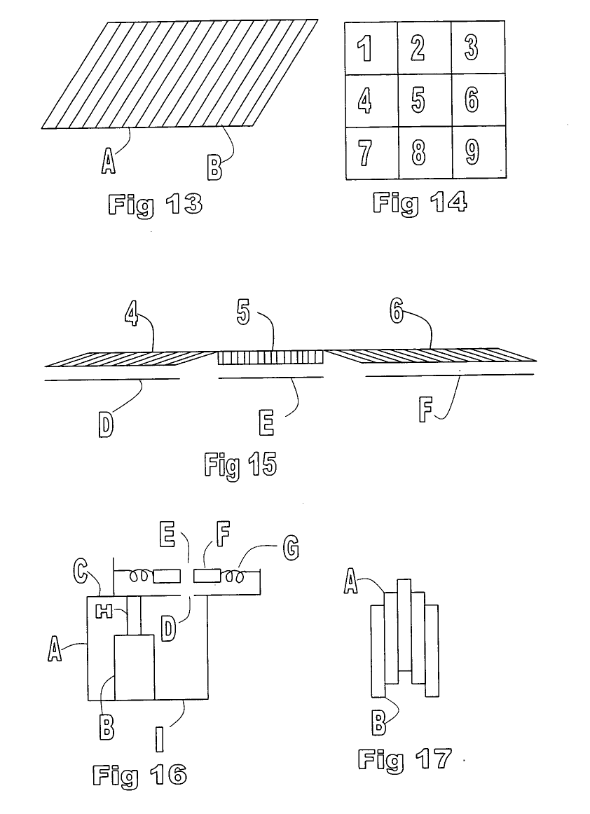

FIG. 16 represents a shock absorber.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a device to place in containers that can expand and contract according to a direction or stimulus. As the device expands for example in tires it makes the tire harder as the pressure in the tire rises.

In a preferred embodiment this additional hardness can be useful in situations including for example braking, cornering, accelerating, etc. In preferred situations the device can be contracted in size so this has the effect of lowering the pressure in the tire. This can be useful for example in driving in soft soil, and in situations where a softer ride is desired.

In a preferred embodiment the device includes a piston and container. The piston can be actuated by a stimulus including for example radio waves, wires, electromagnetic signals, be stimulated by driving conditions, etc. The piston can for example protrude from the device reducing the available space for the air in the tire, which makes the air pressure go up and the tire feel harder. The exampled piston might also be in a deformable sealed container and activating the piston makes the container increase in volume. This also acts to increase the air pressure in the exampled tire and make the tire harder.

In a preferred embodiment as a vehicle accelerates or decelerates this may cause forces in the device to expand or contract as desired. This can make the tires harder or softer according to particular driving situations.

In a preferred embodiment there can be a pump with a compressed gas reservoir sealed in a deformable container. As desired the pumping means releases gas into the container which expands and thus increase the pressure in the tire since less room is available in it for the other gas inside the tire. There are many ways known in the relevant arts to make a device expand in size so it displaces a larger volume. The mechanisms involved are well known and should not be necessary for one skilled in the art to read here.

In a preferred embodiment there can be a piston which protrudes out of a container and thereby displaces air, reducing the available room in the tire as before. The devices could be powered by a means including for example from the wheel's motion, by using the spinning of the exampled tire to wind a spring similar to ways watches wind themselves, batteries, capacitors, wires leading to a power source in the vehicle or another device, other generating means known to the art, etc. Powering a remote device is also a subject well known to those of average skill in the relevant arts, this is commonly employed on many other devices.

Tires typically are elastic while driving but this is related to the compressibility of the air in the tire. The devices however can vary this elasticity under compression. This is because the material inside the device can have a different elasticity than air, for example by using deformable means including springs, foam, etc.

In a preferred embodiment if the device included a resilient material for example foam in a deformable container with a partial vacuum, then this can be sealed but be as compressible as one prefers. If this was inside the exampled tire then when the tire was compressed in use it could become harder or softer than it normally would under that stress and compression.

In a preferred embodiment centrifugal force can make the device expand as the tire rotates faster, which preferably increases the air pressure in the tire at higher speeds.

In shock absorbers the principle can also be shown, for example in FIG. 16. A represents a container with at least one aperture, here it is shown as D. B is a shock absorbing means, which in this example can include a commercially available shock absorber. It can also include any shock absorbing means embodying the principles in this invention.

The surface C can represent a movable surface. For example in a vehicle the devices would be mounted so that the bottom surface I was connected to the mechanisms including the tires. C would be connected to the chassis so the shock absorber regulates the bouncing of the car. This is the standard way for example how a shock absorber is used in a vehicle, a first end connected to the tires and the second end to the chassis.

H can represent a piston that moves in and out of the shock absorbing means and connects to C, which is a preferred mode of operation in many commercially available shock absorbers. As C moved downwards in relation to the bottom of the device at I the piston would go into the shock absorbing means B.

F can represent a blocking means which can close an aperture, represented as D. There can be a plurality of the blocking means and a plurality of the apertures represented here by D. The apertures represented by D can be closed as preferred. For example it may be preferable to close them in conditions including for example when cornering, accelerating, slowing down, on uneven ground, etc.

According to a preferred embodiment the blocking means can close at least one aperture by using forces including inertia. For example shock absorbers are often used when accelerating, slowing down, cornering, etc since the exampled vehicle tends to dip or sink one side or corner. When a car suddenly brakes this is seen as when the front of car tends to lower because the weight of the chassis goes more onto the front springs and shock absorbers.

For example F might be a means including for example a plate, plug, stopper, screw, etc which when the vehicle brakes will move so as to block an aperture such as shown at D. When the vehicle deceleration reduces, F can move back, preferably including a means including for example from a spring like device shown as G. When the exampled aperture is blocked the air in A is sealed and this makes it less compressible. This includes making the shock absorber harder to compress as it would be working against the compressed air in A.

When F unblocks the aperture D then the shock absorber no longer is in a sealed container and can work normally. Also the devices shown by example in the tires can be included so that the air in A when sealed can be further managed in air pressure.

For example when A is sealed by F the amount of air in A determines how easily it can be further compressed. If the devices disclosed in the example of inside the tires were in A they could be expanded so less air could fit in A and so the air would be harder to compress. This would lead to effects including making the vehicle dip less in one section when the vehicle cornered, braked, accelerated, etc.

The exact setting of these devices would be found according to variables including in the example of a vehicle, the make of the vehicle, its weight, the power of its engines, the strength of the brakes, the kind of shock absorbers used, etc. By changing the variable aspects of this invention the amount of shock absorbing can be changed according to preferred situations as desired.

While shock absorbing, tires, and vehicles are preferred embodiments of the invention this is not intended to limit their scope. There are many devices in the relevant arts where being able to adjust the compressibility of containers is desirable, and the invention can be adapted to all of them.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### OPTICAL DIRECTION OF LIGHT

### ABSTRACT

Light is directed in preferred directions including in three dimensional displays.

### BACKGROUND OF THE INVENTION

The present invention relates to the field of optics.

### SUMMARY OF THE INVENTION

Three dimensional displays suffer from many drawbacks. One is that the view can change as the user moves but often the image is distorted. It would be desirable to control the light from a display to more closely mimic reality.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 17 shows optic fibers in a preferred shape.

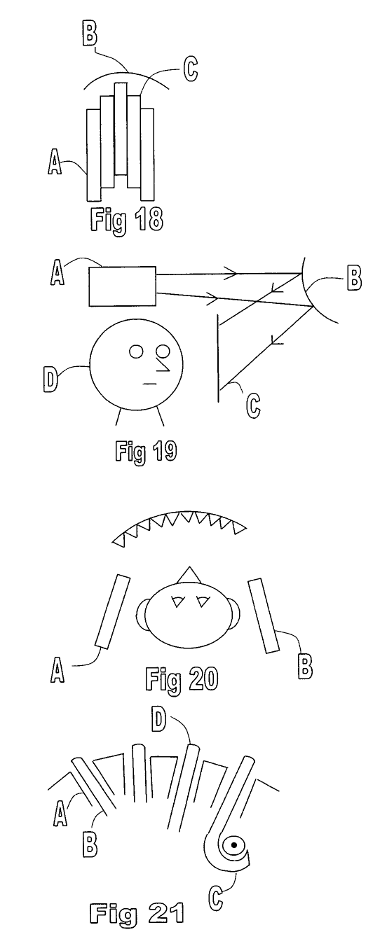

FIG. 18 shows optic fibers with a coating to improve their action as a lens.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to direct light. This includes light entering the faceplate material to at least one receptor and/or light exiting the faceplate material from at least one emitter to make for example a display.

Preferably this includes the aforementioned optic fiber faceplate material, which is often made from optic fibers placed parallel to each other and then fused together. One advantage of this material is that light and other electromagnetic radiation beams are directed down each fiber and exit substantially parallel to each other instead of being more scattered.

In a preferred embodiment the optic fiber faceplate material can be made into a refracting means by having at least one side of the optic fiber faceplate curved. Of course I refer to the sides where the optic fibers enter and exit, though in a preferred embodiment all sides can be shaped in this way.

In a preferred embodiment sometimes the optic fiber faceplate material is more difficult to shape so an additional substantially transparent layer can be placed on top of it. The beams come out of the optic fibers and usually go off in directions according to the angle of the surface of the optic fiber faceplate material compared to the direction of the entering or exiting beam.

For example a light beam refracts and changed direction when it enters a first transparent medium from a second transparent medium. The angle of refraction can also be determined by the types of the first and second transparent media. For example when a first transparent medium is glass and the second transparent medium is air then the beams from the optic fibers including for example visible light will refract at a certain angle. If the first transparent medium is glass and the second transparent medium is clear plastic, user later in a preferred embodiment, the beams will refract at a different angle.

The beams will travel up the optic fibers in the faceplate material and will be substantially parallel to the fibers. According then to the angle the material is cut the exiting beam into in this example the air will refract in a preferred direction. By shaping the optic fiber faceplate material a kind of lens is created.

In a preferred embodiment different sized fibers could be used in this material, of differing diameters, colors, transparencies, etc. For example some parts of the optic fiber faceplate can be a first color and others a second color. This can be used in ways including for example filtering preferred frequencies.

In a preferred embodiment the diameters of the optic fibers in a first area can differ in a predetermined ration from optic fibers in a second area.

In a preferred embodiment a plurality of optic fibers can also be placed at any angle to the others and then fused together. Uses for this can include directing parts of the beams in preferred directions such as for example in a three dimensional display and/or camera.

In a preferred embodiment it is difficult to shape the optic fiber faceplate material in some situations. For example to make the material in a shape of a fly eye lens sheet or lenticular lenses presents problems. The material cannot be easily molded in this shape, normally lenses can use a molten material including glass and mould it into the desired shape. One method includes placing the ends of the optic fibers into the correct shape before fusing them together.

In an illustration of this method one could imagine a plurality of drinking straws parallel to each other representing the optic fibers. To make the ends as a convex shape one could put on end of the straws in a concave shape and the straws would slide against each other to fill the concave cavity and one end of the straws would acquire the corresponding convex shape.

In a preferred embodiment this can be done with the optic fibers, to direct them into a mold of the preferred shape so they slide against each other to fill the mold as with the straws. They can then be fused together in this shape.

Once the shape is formed another problem is that the fibers do not have their ends cut to the required angles. They can be altered including for example grinding them, cutting them, sanding them, etc. In a preferred embodiment a transparent medium can be affixed to the ends of the fibers to smooth out the shape. For example they might be altered by means including for example buffing a material onto them, wiping a material onto them, spraying it on, etc.

Preferably this material could include for example molten glass, molten plastic, etc. If this material fills the gaps in the surface where the optic fibers are then this can mimic substantially the optic surface achieved from cutting the optic fibers directly.

In FIG. 17 optic fibers are placed into a shape so that one end A is convex as described. B can if desired be ground to another shape, for example flat. In a preferred embodiment at least one optic fiber can be directed onto an emitter and/or receptor. The material can then act as an emitter including a display, a receptor including as a camera, or the emitters and receptors can be mixed in a predetermined ratio so the material can act as a combination of both emitter and receptor.

In FIG. 18 the optic fibers have a substantially transparent coating on them which acts as a lens shape. This fills in the gaps between the optic fibers shown as C to make the light be directed as preferred like a lens.

Preferably the clear layer shown as B in FIG. 18 has a similar refractive index to the optic fiber material though this can be of different according to some preferred optical effects.

This can be useful in a preferred embodiment, for example where it is difficult to machine or otherwise create the surface of the optic fiber faceplate in the shape desired. In my PCT WO03025344 I disclosed using tubes to direct light in a two or three dimensional display, a two or three dimensional camera, and a combination of the two. Additional preferred embodiments are also disclosed in my PCT WO9910766 using tubes in displays, etc.

In a preferred embodiment this can be helped by creating the lens array as well as desired and having a further, preferably previously constructed mask that fits over it. This can be many shapes including for example at least one sheet of lenses, individual lenses, prisms, mirrors, filters, other optic fibers, a textured surface, an etched surface, with a holographic imprint, with at least one Holographic Optical Element, with additional coatings including at least partially reflective coating, etc.

At least one mask can be positioned in ways including for example placed, fused, joined, glued, bolted, melted, chemically bonded, etc. In addition a preferably clear medium may be inserted between the optic fibers faceplate and the mask including for example molten glass, molten plastic, glue, resin, fluids, etc.

Preferably the inside face of this mask is approximately the shape of the fiber optic faceplate surface. This can be machined to approximate the lens shape, have another shape, or even be flat. For optical effects it may be preferable to have the mask closely fit the optic fiber faceplate so the beams exiting the optic fibers are still substantially parallel to each other.

For example the optic fiber faceplate can include at least one recess in its surface so mask shapes including for example lenses, prisms, mirrors, etc can sit in the hollow. There are plenty of other shapes known in the relevant arts, including a more angular shape with facets, parabolic, etc. The shape selected will depend on many factors including ease of affixing the outer layer, the optic paths, chromatic aberration and shapes to correct it, and so on.

In a preferred embodiment the layer can be irregular and/or periodic in shape for many uses including for example preventing a moire effect, creating preferred direction of light for decorative purposes, sending signals in preferred direction as part of optic circuits, creating a three dimensional image, etc.

In a preferred embodiment multiple layers can be used including at least one more layer of optic fiber faceplate.

In a preferred embodiment Fresnel lenses can be used on the optic fiber faceplate material to direct the light in at least one predetermined direction.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### FILE TRANSFERS

### ABSTRACT

A system is disclosed including a means to receive payments for file transfers.

### BACKGROUND OF THE INVENTION

The present invention relates to the field of computing.

### SUMMARY OF THE INVENTION

Files are often traded on the internet without paying royalties. It would be desirable to have a system for collecting revenue from them.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to collect money in from users who trade data including for example files, MP3s, songs, movies, TV shows, AVI files, MPEG files, programs, software, operating systems, etc.

For years the rise of file transfer programs including Kazaa, Lime Wire, Bit Torrent, Napster, Gnutella, etc have created a problem with music, movie and software piracy. Since files are copied and transferred so easily it is quite difficult to stop people pirating files. File transfer programs, file trading programs, file sharing programs are defined as including for example a software means, a business model, a hardware means, a program, etc by which users engage in activities including for example file trading, file sharing, file downloading, file swapping, making files available online, distributing songs movies and/or software, etc.

Many systems have been tried including spoofing fake files and suing people for downloads but the pace of file swapping has not been appreciably slowed.

According to an invention there is a means of receiving money and other objects of value for the artists, companies, royalty collection agencies, etc from users, including those using file sharing programs.

According to a preferred embodiment each file sharing program is accompanied by a suitable means so the user can contribute money, preferably voluntarily though preferred parts of the system may charge for some services, files, tasks, etc. This can include credit card facilities, other merchant means such as Pay Pal, sending checks, transfers of money into bank accounts and all commercial means of performing transactions known to the relevant arts.

Preferably the user is able to have a payment means ready with funds, including for example one of the above, a preferred payment means set up in conjunction with and/or recommended by the file transfer programs and administrators, etc.

Preferably this payment means can enable users to direct money and other valuables to preferred destinations including for example donations, payments, rentals, purchases, leases, etc. Preferably the file transfer program has menus and other data structures including for example web pages, files, frames, etc that include destinations to send money to. For example they can include names of artists, movie companies, actors, directors, singers, band members, guitarists, software developers, any kind of related company or employee, and any other kind of destination.

In a preferred embodiment the user may be able to populate the menus and other data structures with additional names and destinations, so preferably easier payments can be made.

In a preferred embodiment users may produce lists of these donation destinations and options so other users can download or otherwise acquire these addresses to customize their file transfer program.

In a preferred embodiment there can be links to other areas including for example other lists of payment destinations, other programs to use with the file transfer program, web pages, ftp sites, e commerce sites, etc where the user can make payments.

In a preferred embodiment the user might contemplate downloading a file, and for various reasons decides to make a donation, payment, etc. For example the file might be copyrighted and the user decides out of perhaps guilt to pay something towards it.

In a preferred embodiment the user then selects a destination for the payment, donation, etc. Preferably this is arranged to be anonymous, and implies no liability on the part of the user, nor why they are making the payment unless they choose to disclose the reason.

In a preferred embodiment there may be a means where the user elects to have his identity and/or transaction details revealed to selected agencies or people. For example users may decide to add their name or other identifier including for example nickname, avatar name, etc to a list to show selected people and/or companies including for example the one who received the donation.

The amounts may vary. In a preferred embodiment the amounts have some preset icons including for example sliders, buttons, boxes to tick, pages to go to, etc to pay an amount including for example ten cents, twenty cents, 50 cents, one dollar, a means to input a customized amount, etc.

In a preferred embodiment the money may go directly to its destination, it may also go into preconfigured places including accounts, bonds, checks, wire transfers, etc for the person or company that the user selects to receive the funds.

In a preferred embodiment this money could be held until the relevant agencies including for example the RIAA, ASCAP, BMI, the artists, recording companies, movie companies, agents, etc agree to not prosecute people who use the file sharing program.

While in this system each user may not necessarily pay their fair share, the agencies negotiating the intellectual property rights issues including for example the RIAA, ASCAP, BMI, etc may decide the overall revenue received is sufficient to not prosecute the users of the file transfer means.

In a preferred embodiment the payments can be broken up into a plurality of accounts, at least one for each of the intended beneficiaries of the payment so the person or company it is for can request payment from it or draw from the accounting means as desired by them, or under further terms and conditions from the managers of the accounts.

In a preferred embodiment the payments can be transferred to at least one repository including for example a trust, a foundation, an overseas account, into shares, bonds, stock, purchasing goods, etc on behalf of the beneficiary. For example if negotiations are continuing the payments may be invested to give a return until they can be turned over to the beneficiary, returned to the users, or for another predetermined purpose.

In a preferred embodiment the issue of who gets the money may be between other parties. For example users may prefer to donate directly to an artist and it is up to the artist to settle with other agencies involved including for example band members, record companies, royalty collection agencies like BMI and ASCAP, movie companies, etc.

In a preferred embodiment donations might additionally be made to charities and other destinations including those requested by the artists and companies. Another destination might be preferred including for example legal funds for fighting lawsuits related to file transfers, web privacy, or any other purpose.

Some owners of intellectual property may agree to allow some material to be available to the file transfer means, and request a particular donation and a place to send it. Preferably this would not include the user having to make a payment before receiving the file, but this could also be included in the system under preferred circumstances.

In a preferred embodiment users could make donations to be held in an account for the intellectual property owners and agents until they agree to make their files available in the file transfer system. The accumulating funds may persuade them to take the money and make a deal. This would also tend to persuade more intellectual property owners and agents to allow their material to be traded.

In a preferred embodiment this can be like a form of shareware or freeware, the owner of the intellectual property agrees to use this system to be compensated.

In a preferred embodiment the system may also handle other property, including for example real estate, vehicles, foodstuffs, consumer goods, consumables, etc. These may be paid for in ways including the methods disclosed herein.

In a preferred embodiment the file transfer program administrators may hold promotions requesting donations for preferred artists and companies and explaining the reasons why. Preferably the donations would remain voluntary, though in predetermined circumstances payments can be arranged.

In a preferred embodiment some users may receive points and/or suitable recognitions for their donations and payments such as special names, classes, titles, perks, access to special programs and web sites, coupons, discounts, meeting with artists, signed copies of materials, receiving a limited edition, special membership, prizes, entry in a lottery, etc.

For example in Kazaa people receive different titles if they upload more than they download. Users who do things including for example donate a given amount overall, make a predetermined number of donations, donate a predetermined amount of money per megabyte of downloaded files could have additional prizes, titles, and could be rewarded by artists and companies with discounts, free goods, special concerts, previews, etc.

In a preferred embodiment entities including for example users, artists, companies, agents, etc could interact including for example communicate, complain, beg, negotiate, appeal, etc and come to better relationships. This could preferably be done by a means including for example in forums, polls, web pages, files, advertisements, private meetings, public meetings, demonstrations, etc.

In a preferred embodiment this can include negotiating agreements for the companies and artists not to engage in certain activities including for example spoofing of files, trying to track down user, etc The file transfer system may preferably recommend donations for some and recommend no donations for others, according to their behavior.

In a preferred embodiment payments may be accounted for by independent auditors and taxes collected.

In a preferred embodiment data including for example files, songs, movies, software, etc may be identified by entities including for example the system, the administrators, artists, companies, the RIAA, ASCAP, agents, etc and suggestions on who to donate to and how best to do it. Statistics on this identification would preferably be suppressed, though in some preferred embodiments they can be compiled as statistics on what kinds of files are being traded, preferably with the user being anonymous. These statistics could be marketing for purposes including for example marketing, advertising, monitoring of the system by the artists and agents, etc.

In a preferred embodiment this information can be sold to advertisers and other statistics collectors to determine how popular certain files and artists are.

In a preferred embodiment the user need not make payments including for example donations, rentals, purchases, etc to the same intellectual property owners and agents as the file ones included in making the file he downloads. For example some users may prefer to give to their favorite artists even though they download another artist's or company's files. Instead of or in addition to policing this it may average out by itself over time in a way satisfactory to the intellectual property owners and agents.

In a preferred embodiment as part of agreements the file transfer means administrators may arrange to redirect some funds donated to a particular destination to another one. For example under an agreement with a royalty collection agency such as the RIAA, ASCAP, BMI, etc funds for particular artists may go direct to them preferably in exchange for concessions from them.

In a preferred embodiment users may be able to search for artists or company files, and even be directed to download them direct from their sites, and pay donations or fixed payments directly to them. This could include linking to other file downloading utilities including for example iTunes. These may also advertise on the file transfer means with directions on how to get to their sites.

In a preferred embodiment users may also indicate how much they would pay for certain files, songs, programs, movies, and prices can be negotiated for them from the owners and agents of that material.

In a preferred embodiment intellectual property including for example songs, movies, software, etc can be custom produced for users, special versions of movies edited and made, special programs written.

For example the users may have a particular file they want as described and then the users might donate to a fund, which would go to the artist or company who supplies that file, movie, song, program, etc.

In a preferred embodiment pledges may also be accumulated though some users may change their mind under this system. When the particular file or files are available the users are contacted by a means including for example email, instant messaging, sms, voicemail, notices are placed in forums and bulletin boards, etc.

In the example of donations being accumulated if the artist or company does not supply the product the users may have specified an alternate destination for the money including for example another artist, a charity, a holding fund, etc, or receive credits and refunds.

In a preferred embodiment auctions and offers may be fielded by artists and companies, and users can donate or pledge toward the product. The closing date may be when the reserve is reached or if there is no reserve the product is supplied at the end of the auction. Preferably though not necessarily, in all these preferred embodiments the user's details remain confidential.

Products can also include the artists or people having chat sessions on forums, do interviews, special recording, limited editions, prizes, etc.

In a preferred embodiment files may have included in them additional material in many ways including for example by the file transfer means, the creator of the files, arrangements with authorities and associations including such as the RIAA, by users, according to negotiation with other users preferably in ways including for example forums, polls, email lists, conference calls, chat rooms, etc.

In a preferred embodiment this added data to files might included a counter so it can be seen how often the file is traded. Each time the file is transferred the file transfer means might do things including for example update the counter, write other data in it, count the transfer, etc.

In a preferred embodiment the attached data to files might also include other data including for example advertisements, reminders, messages from artists and companies, offers of discounts, nagging, begging, etc.

In a preferred embodiment the file transfer means might add advertisements into or onto files including for example songs, movies, programs, etc. Preferably these could be viewed, used, listened to etc by the user and include an incentive for them to do things including for example to buy things, donate, participate in activities, participate in a survey, etc.

In a preferred embodiment these advertisements might be a result of a negotiation with artists and companies that the file can be traded as along as the advertisement is not removed or altered. Such advertisements might be at the start or end, even in parts of the movie or TV, just as advertisements appear on television.

In a preferred embodiment users might fast forward through the advertisements and other messages but it may make the artists and companies happier about the files being traded. A particular player might be required for some files that cannot be fast forwarded or skip through advertisements, and that is not easily converted into other formats. For example there could be a custom compression format and the player might not contain fast forward. In a variation the player might be designed to detect where the advertisements and other messages are and not to skip them.

In a preferred embodiment predetermined advertisements might be used in different areas, cities, countries, etc at different times, seasons, etc. Coupons might be included for trial copies of programs, offers to purchase at reduced rates, advertisements of products, pleas from artists and companies for donations, etc. Competitions might be organized for users who can answer questions about what is in the advertisements.

In a preferred embodiment users might be directed to a means including for example web sites, programs, etc, and have to watch advertisements and answer questions in ways designed to avoid the users not paying attention or skipping parts of them. Doing this successfully might give benefits including for example downloads, watching special shows, concerts, discounts, rebates, special offers, etc.

In a preferred embodiment files might include programs that contain advertisements and the user might have to answer question by various choices and selection, after which the file can be interacted with including for example used, run, watched, listened to, etc legally. The answers may additionally change randomly or according to an algorithm so users couldn't cheat.

In a preferred embodiment advertisements may also require feedback including for example answering some questions, making a commitment, participating in a survey, etc to enable the file. This may include the user logging onto a web site and receiving an unlock code for the file, or access to a download. Preferably each file would have a unique download code, or require different ones at different times and situations so the user could not cheat.

In a preferred embodiment versions of movies might include advertisements inserted into the movie in scenes for traded versions, including for example banners at the top or bottom of the screen.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### LIGHTER FOAM

### ABSTRACT

Materials are made that can be lighter than otherwise. One method includes making a foam with a partial vacuum inside.

### BACKGROUND OF THE INVENTION

The present invention relates to the field of making light materials.

### SUMMARY OF THE INVENTION

Lighter than air devices used in society include kinds of balloons, dirigibles, etc. These have many drawbacks such as gas leaking or exploding, a difficulty in using them for large transports, and a lack of permanence. It would be desirable to have an invention to overcome these problems.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves foam that is substantially light. The foam is preferably made in a reduced gas pressure, including for example air, oxygen, nitrogen, helium, hydrogen, etc. It may also be made under reduced gravity including for example in a plane that moves in an upward arc to reduce gravity. In this case the foam would preferably set more quickly. Preferably the foam includes having features including for example bubbles, cavities, etc that are substantially sealed so gases don't leak back into them. Because bubbles for example are typically round they are very strong and resistant to the crushing effects of the atmosphere. In the invention the word bubbles refers to any piece of the materials used.

In a preferred embodiment under normal air pressure the foam would have a lesser air pressure in the bubbles. This would make the overall foam light than it might otherwise be, and if the bubbles are large enough and the vacuum inside them strong enough the material may be able to float in the air. This material would be strong because foam is by nature often composed of bubbles which are circular, thus able to resist the crushing force of the air outside.

In a preferred embodiment this material could then be altered, including being cut, shaped, molded, broken up into sections to make platforms including for example ones that are lighter than many other foam materials, ones that can float, etc. These could be used in many ways including for example making plane sections, floating buildings, balloon, zeppelin like vehicles, as insulation because the vacuum would conduct less heat, as sound absorbing material because the partial vacuum would reduce sound going through it, etc.

In a preferred embodiment the foam need not be the same consistency throughout, at least one section may have larger or smaller bubbles. Some sections including for example the outer areas could have smaller bubbles to be stronger and reduce the crushing pressure of the outside gases, for example the atmosphere, and perhaps handle abrasion of the material better. Other sections might have smaller bubbles to be cut through.

In a preferred embodiment different sections can be composed of different chemical materials. For example there could be a first kind of foam inside, and a second kind of foam outside. The first and/or second kind of foam could have characteristics including for example being stronger, more resilient, less porous, easier to cut, easier to shape, differing insulation properties, etc. The outer layer of foam for example might be stronger and more resilient while the inner foam might have larger bubbles to be lighter but be more fragile.

In a preferred embodiment the foam is made and then pluralities of the bubbles are punctured. The material is already in or would be placed into a reduced gas pressure environment. Then the material is resealed by a means including for example being enclosed in a container, a skin applied to the surface, a plurality of the outer holes in the bubbles are resealed, etc. This then gives the strength of the spheres in the foam and empties it of gases as desired.

In a preferred embodiment spheres are made including by blowing bubbles of material and these are punctured before or after being place with other spheres. At some point in the process the holes in the bubbles are repaired and the total array is again lighter with reduced gas pressure inside. The spheres may bond together like foam or remain separate. They can be of a rigid material or a pliable one at pushes closer together with the other spheres or foam.

In a preferred embodiment the holes in the bubbles may be created by devices including for example lasers, projectiles, wires, chemicals, shaking the foam, tubes inserted into them removing gas then resealing them, etc.

In a preferred embodiment cavities in the material may be excavated and the material resealed with a partial or complete vacuum.

In a preferred embodiment the foam can be used for its implosive properties including for example crash protection, buffering, shock absorbing, etc. For example a user in a device including for example cars, planes, trucks, buses, boats, etc might be propelled into the foam in a crash and the foam could implode from this pressure. Because there is little or no gas resistance in the foam it can behave in ways including for example crumpling, folding, compressing, fragmenting, etc more quickly and cushion the impact.

In a preferred embodiment the foam might be imploded by an input including for example lasers, wires, chemicals, sound waves, etc so it for reasons including to reduce its size.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### FOCUS IN IMAGES

### ABSTRACT

A system is disclosed to improve images.

### BACKGROUND OF THE INVENTION

The present invention relates to the field of optics.

### SUMMARY OF THE INVENTION

One major problem with cameras including film, digital and video is that some parts of an image are out of focus. For example if the camera focuses on something in the foreground the background is out of focus. It would be desirable to have a means to correct this problem.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to improve the focus of images taken by an imaging including for example video cameras, digital cameras, digital video cameras, web cameras, surveillance cameras, etc.

In a preferred embodiment the imaging means is capable of changing its focus from a first setting to a second setting. This ability is common on many cameras including for example SLR cameras for example where adjusting the focal length can bring preferred parts in focus.

In a preferred embodiment the imaging means for example a digital camera prepares to take a picture. The focus is preferably capable of being rapidly changed from a first setting to a second setting. Alternatively or in addition there may be a plurality of lenses at different focus setting pointing at the object to be imaged.

In a preferred embodiment there can be a plurality of lens arrays pointing at the objects to be imaged. For example a lens on imaging devices including cameras usually have a plurality of lenses in a line, which can be adjustable to change the focus, zoom in and out, adjust the amount of light going through the lens, etc. A simpler camera might only have one lens. Depending on the kind of imaging means it can have a plurality of these lens arrays, each of which is preferably set at a different focus. For example one might focus on the foreground, and another on the background.

When the imaging means takes the picture preferably each lens array take a picture which is preferably stored separately. This storage in a digital camera can include a computing means, flash memory, a Compact Disc, a Digital Versatile Disk, a video cassette, a floppy disk, random access memory, etc. Because memory can store separate images on the one medium it is preferable the images can be retrieved intact.

In a preferred embodiment the images can be stored in a compressed format. Because they would be similar to each other they can be stored in a compression format that takes advantage of this. For example if the first image for example was saved, the differences between the first and second image could be saved which is much smaller, and so on with as many images as were taken.

In a preferred embodiment the picture can be taken with at least one lens array that is capable of moving rapidly between a first focal setting and a second focal setting. This can be the equivalent of multiple lens arrays. The imaging means can store a plurality of images taken between and including the positions of the first focal setting and the second focal setting. For example it might store 4 images in the ways described.

In a preferred embodiment the images are preferably processed to combine the sections of the images in focus into at least one image. The final product might include according to the kind of camera a movie, a still image, etc where preferably all parts are in focus.

In a preferred embodiment this can be done by a computing means including at least one processor, circuitry, memory, etc. There are many preferred algorithms capable of processing the images. The images are compared, preferably in an overlay. The same sections of each image are compared to determine which are the most in focus.

In a preferred embodiment comparing the images will show some sections are more in focus in some images. Preferably the parts in sharpest focus will have the more abrupt or sharpest changes between pixels while those sections out of focus will have a more gradual change in color and brightness, contrast, gamma, etc.

In a preferred embodiment the sections with the preferably sharpest features are retained and combined in one photo, with care that the image doesn't show abrupt borders between sections from a first image and a second image. With accurate data received from preferred images, and preferably using other means including for example morphing parts of images, blending images, cutting and pasting, other effects known in the art, etc the final product should be more focused overall.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### FILE NAMESPACES

### ABSTRACT

A system including of naming files is disclosed. The name has many different attributes such as name, date modified, type, position, size, etc in the file name etc.

### BACKGROUND OF THE INVENTION

The present invention relates to the field of computing.

### SUMMARY OF THE INVENTION

File indexing is a complicated system, and one of the major areas of current research. The internet for example is difficult search because there is no much poorly indexed information. It would be desirable to improve the system to make files easier to find and protect.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to create preferred identifiers of data objects including for example files, data, code, programs, web sites, movies, songs, e-books, etc. Preferably these are in a computing means but the system can include any data.

In a preferred embodiment when files are indexed and searched it can be time consuming process because all the names must be searched through. Also computer systems rely on classifications including for example logical drives, folders, attributes of files such as zip, .doc, etc.

In a preferred embodiment files will be used as examples. The file gets a different namespace, similar to those used with fully qualified domain names with DNS.

In a preferred embodiment instead of or in addition to classifying files according to their locations this and other data can be a part of an identifier, including for example the name. For example in a computer called serveral, it might have a folder named temp, another inside it named bin, and contain a file in it named letter.doc modified on Jun. 5^{th} 2004.

In a preferred embodiment the file could then have a name for example as serverl; temp, bin; 06052004; doc; letter. The files then could be all stored in one directory preferably without the need for a folder system. In this example I have used a semi colon in between different attributes, to differentiate them from fully qualified domain names used in DNS. When there are more than one attribute such as nested folder of “temp” and “bin” I have as a suggested convention separated them by a comma. An attribute is defined herein as an aspect of the data object, including for example the data created, the date modified, the kind of program that uses it, the size, who or what has access to it, etc. The name of the exampled file which includes the attributes is defined here as a file namespace.

This system has many advantages including some of the advantages of fully qualified domain names. An index can be set in many ways well suited to databases. For example the file namespaces can be listed in a comma or tab delimited format and viewed in a spreadsheet. The index of file namespaces would then be in rows and columns. The rows would be the file namespace and the columns would be the attributes in the file namespace.

In a preferred embodiment it may be better to place commas between the attributes in the file namespace instead of semi colons. This would make the names compatible with comma delimited spreadsheet settings, but in these examples I have made them semi colons to keep them distinct. It would be easy to convert the file namespaces to any format desired however.

In a preferred embodiment the spreadsheet means can list attributes in a column and find the file. For example if an attribute represents part of a tree structure analogous to folders then by looking in the column under this attribute the name of the folder equivalent can be found. To look for files that run on a preferred program for example Microsoft Word this would be listed in a the column for what programs run the file.

Of course the spreadsheet is an example, databases and other data structures in the relevant arts are well suited to indexing the namespace in these embodiments.

Additional attributes can define further types and also be used as security. For example with server1;temp,bin;06052004;doc; read, write; administrator, power user; letter I have inserted more examples of attributes called read, write, and administrator, power user. While of course the order of attributes would need to be established and standardized for the sake of example I will add different attributes to show different advantages of the system. In the example of in a database and/or spreadsheet means there might be a column for what can be done with a file, perhaps analogous to the Discretionary Access Control List. These might include for example Full Control, read, write, modify, list folder contents, etc. In the example of administrator, power user there might be a column to define who has access. For example if a first column said read, write, read and the second column said Administrator, User, Backup Operator Group this might be interpreted as the read access goes to the Administrator, the write access goes to the User, the list folder contents goes to the Backup Operator Group.

As more attributes are included the systems described here become more complicated in these examples, but are relatively trivial for a database means to organize. All known functions of databases are contemplated as being available to use with the file namespaces.

In a preferred embodiment the attribute read, write indicates the file can be read and written to. The attribute administrator, power user indicates they can read the file and write to it. Additional attributes could include size, date created, etc.

In a preferred embodiment the file can have a namespace that is easier to index and contains information about the file and what can be done with it. An attribute “system” for example might mean only the operating system or a program could modify, read or run it. An attribute named “local” might mean only that computing means might view it. An attribute named “hidden” might mean it is normally hidden from the file management means.

In a preferred embodiment all the files could be in at least one drive or folder. A file manager means, database, windows explorer kind of program could arrange these according to the attributes desired. For example it is easy for the system to display files with the attributes equivalent to nested folders only if desired, for example here temp,bin in normal computer punctuation would be ;temp,bin;.

One advantage of the invention is there might not necessarily be file allocation tables or equivalent to be corrupted as the database of the filenames could be easily recreated.

In a preferred embodiment files could also be named in ways similar to DNS and IP addresses. Instead of or in addition to using the file namespaces there could be names like 231;345,98,99;489; with each number preferably indicating an attribute. I call these herein the NP addresses standing for Namespace Protocol. This could be translated by a system substantially similar to the Domain Naming System, here I will call it the File Namespace System or FNS. For example a series of numbers 231;345; in the namespace protocol or NP might mean in a friendly name “system; Administrator” meaning that the system attribute was represented by the number 231 and the Administrator attribute was represented by 345. So this can operate in ways substantially equivalent to the Internet Protocol address and Fully Qualified Domain Names in modern computing.

In a preferred embodiment the file namespace can be regarded as N dimensional in Hilbert Space where each attribute can be regarded as substantially like a dimension. For example if a file had potentially 20 attributes separated by semi colons then it could be described as being able to be represented in a 20 dimensional space.

In a preferred embodiment the exampled files can be represented including being graphed in this N dimensional space. For example humans can visualize three dimensions at a time, so 3 attributes at a time could be viewed in a 3 dimensional graph, and the user could move to any other 2 or 3 dimensions to get an overall view of the data. More on this was disclosed in my PCT WO9910766.

In a preferred embodiment if a file is desired and the user has all or part of the “friendly” attribute names the program goes to the File Namespace System and receives what I call the Namespace Protocol name which is composed of numbers instead of words. Preferably then the file namespaces might be stored as numbers rather than words because these would be easier for a computer to manipulate. When necessary the File Namespace System would get the file with the preferred Namespace Protocol numbers.

This is preferably equivalent to the TCP/IP system where an IP address is formed of numbers like the NP, and relates to the Domain name which here is the file namespace. For example 210.34.23.12 might be an IP address and www.example.com a domain name.

In a preferred embodiment a given number for an attribute might always mean the same thing, this would be similar to a static IP address in a computer. They can also be allocated by a service equivalent in preferred ways to the Dynamic Host Configuration Protocol. In a computer the DHCP service allocates IP addresses to a particular friendly name or domain name. Friendly name is a term in computing which means a name usually in words for something, which is easier to remember than a name composed of numbers.

In a preferred embodiment I call the substantially equivalent service in this system the Dynamic Namespace Configuration Protocol or DNCP. This service allocates numbers to the attributes according to preferred rules, and synchronizes with the File Namespace System. By making the Namespace Protocol numbers dynamic instead of never changing it may improve the indexing efficiency. For example if the DNCP gives out smaller numbers then they may be faster to index.

In a preferred embodiment preferred ranges of numbers may be assigned. For example a range of numbers in the folder attribute might define an overall folder and other numbers in that range correspond to folders inside it. This can be used in ways equivalent to for example subnets in IP addresses. A form of mask substantially similar to the subnet mask in networks can preferably be used to define preferred ranges. Files in the same subnet could preferably interact with each other but files outside this would preferably have to be routed and their uses challenged, proscribed, and access allowed or denied. The name of the subnet equivalent herein is the Namespace Subnet or NS. The DNCP service might preferably give out NP numbers to relate certain files to each other in a Namespace Subnet.

When a file is first used it is preferably allocated a Namespace Protocol number by the Dynamic Namespace Configuration Protocol program, service, server, etc which converts its attributes into numbers preferably separated by semi colons. Preferably these numbers may correspond to certain attributes, for example a system attribute could be always 32 unless the numbers are dynamically assigned.

In a preferred embodiment the numbers need not be a guide to what the file is or does, so an infecting agent including for example viruses, worms, Trojans, etc could not look at the numbers in the name and work out what they are by bypassing the system's safeguards. For example if the DNCP service was secured an infectious agent could not know what each file did, so it could not direct them to do anything.

In a preferred embodiment parts of the data structures can be made immune to infection from outside the exampled subnet or ranges of Namespace Protocol numbers. Certain subnets may additionally be able to interact with other subnets according to a means including for example rules, Discretionary Access Control Lists, permissions, privileges, passwords, etc.

Missing Namespace Protocol numbers might occur for reasons including for example unused attributes, those not needed to describe the file, etc and they can be shown as semi colons together for example 432;545;;;;54;65;;;98. This is similar to the system for IP6, the number IP address system for the internet, which uses colons.

In a preferred embodiment segments of code can also be assigned Namespace Protocol numbers so they will run in a predetermined order depending for example on the attributes. In some cases the NP numbers may run in one sequence, and in other cases other attributes will run. The code can then be ordered by expressing the NP numbers. The attributes may be different for other examples than the files referred to herein, including code, movies, books, songs, programs, etc.

In a preferred embodiment this can make it easier to debug code. For example if there is an attribute for reading a DOC file then it can easily be searched for every segment of code that contains this in its File Namespace looking for errors. Code could be classified according to the attributes of what it does, when it was written, etc. Scripts can also be written this way.

In a preferred embodiment as an analogy to network ID's and host ID's as used in networking the attributes could read from the left for the system attributes and from the right for the data including for example files, code, movies, songs, e-books, etc particular attributes.

In a preferred embodiment the attribute numbers can also define ranges with code, files, etc. For example in code that has a given Namespace Protocol number the individual numbers could define what the code can do. For the code segment to function it preferably can be designed to be used with other code that has a compatible range in its attributes. This makes it easier for a compiling means to spot errors and also for the programmer to more easily understand what the code's abilities are.

On a preferred embodiment the code can be seen as different mechanisms including for example cogs, levers, belts, copiers, cutters, pasters, deleters, transformers, etc according to what they can do and their ranges, defined substantially as the Namespace Protocol numbers and the Namespace Subnet.

If the code has multiple tasks and ranges in a given attribute these can preferably be defined by commas if suitable or as an example a dash can separate the ranges. For example 432-5234, 53-34, 98, 4323; may define ranges of use in Namespace Protocol numbers.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### IMPROVING PERFORMANCE FEEDBACK

### ABSTRACT

Indicators including light beams are placed on objects. As the objects move the beams indicate they trajectory.

### BACKGROUND OF THE INVENTION

The present invention relates to the field of performance feedback.

### SUMMARY OF THE INVENTION

Most sportsmen have trouble with their technique. This is usually from holding the bat, racket, club, etc wrongly or mistakes in the swing. These are however difficult to correct since the user find it hard to notice these small errors. It would be desirable to find a way to correct these mistakes more easily.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to determine the correct technique with moving implements including for example golf clubs, tennis rackets, squash rackets, baseball bats, cricket bats, etc. In a preferred embodiment emitters including lights, lasers, sound waves, etc are positioned are predetermined points on the implement.

In a preferred embodiment on a golf club there may be emitters including for example lights, lasers, etc which are directed outwards at preferred positions on the head and shaft of the club. In exampled positions they might point forward on the club head, directly behind, directly to both sides, or they can point at any predetermined angle.

As the user swings the club preferably in a room or against a screen he can see the light form a line that corresponds to how straight the swing was. In a preferred embodiment there may be a predetermined environment including for example a screen and a target to aim at on the screen, the screen may be substantially transparent so the user can see a target, etc. The line drawn by the exampled lasers can then be compared with the target in ways including by a computer, lines on the walls, photos taken of the swing, etc to see how accurate the swing was.

In a preferred embodiment a tennis racket can have emitters including for example lights, lasers, etc mounted on preferred parts of the racket including the shaft, the head, etc so when the user swings the racket he can see how accurate the swing was. The same technique can be used on any sporting and other implement including of course baseball and cricket bats.

In a preferred embodiment the emitters and/or the line drawn by them may be monitored by an imaging device including cameras, scanners (in the example where the devices emit an electromagnetic signal say like radio waves) instead of lasers) to collect the data from the swing of the implement.

In a preferred embodiment this can be analyzed in a computing means including for example software, hardware, measuring aspects of the lines drawn, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### RESTING POINTS FOR THE ARM USING COMPUTERS

### ABSTRACT

A system for resting the arm on when using a computer is disclosed. Sensors all around the arm sense any movement and can use it to control a computer.

### BACKGROUND OF THE INVENTION

The present invention relates to the field of computing.

### SUMMARY OF THE INVENTION

Computer mice, keyboards and joysticks are tiring to use because there are no supports for the arms. It would be desirable to have a resting mount for the arms that also contains controllers for a computer.

### DETAILED DESCRIPTION OF THE INVENTION

According to an invention there are devices for resting the hands, arms, and other parts of the bodies. Preferably these device are springy and capable of supporting the weight of the parts of the body being supported. The pressure by the parts of the body pushes down and in other directions, and this is sensed by the array. These movements can then be interpreted as computer commands including movements of cursors, moving in 3D, virtual reality, typing, art work, moving virtual objects, etc.

In an embodiment the mechanisms enable the user to rest the preferred body parts on them and so it is not as tiring to use.

### REFLECTOR AND HELMET

### ABSTRACT

The invention discloses a system including for creating a helmet viewer.

### BACKGROUND OF THE INVENTION

The present invention relates to the field of optics.

### SUMMARY OF THE INVENTION

Virtual reality goggles and 3D glasses are not popular, usually because they are uncomfortable to watch. It would be desirable to have a system that could have a large viewing screen without being too heavy to wear.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 19 shows a projecting means directing an image onto a reflective surface and then a translucent surface.

FIG. 20 shows two projectors directing images onto a surface for making 3D.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a projecting means on the top of, and/or to the side of a head and/or shoulder mounted apparatus. This projects an image onto a reflecting means such as a mirror which is preferably substantially in front of the user. This in turn reflects the image onto a translucent surface which is substantially between the user and the reflective surface. This can then be viewed as a display. This is shown in FIG. 19 The projecting means A shines onto a reflector B and a translucent surface C which the user D sees as a display.

In a preferred embodiment this translucent surface can include for example a 3D light directing means such as lenticular lenses, fly eye lenses, tubes pointing in preferred directions, a plurality of Holographic Optical Elements, slits, apertures, all 3D devices known to the art, etc. These elements are well known in the art and are often affixed to displays, so a person of average skill in the art should be able to easily affix then onto C. Also making a mount such as disclosed is well known in the relevant arts. The system involves a kind of helmet, hat, etc which is easily constructed, and mounts to hold B and C in the preferred positions.

In a preferred embodiment 3D signals can be seen by the user substantially more detailed than by eyeglasses. Typically in 3D it is viewed by red and blue, polarized and other kinds of 3D glasses. This reduces the 3D experience because the eyes mainly have to look straight ahead, which is not a natural way of viewing things all the time.

In a preferred embodiment of the invention the viewing surface is substantially increased in size, to view 2D and/or 3D. Preferably this is done by using a 2D and/or 3D translucent surface that can be looked at without special glasses.

In a preferred embodiment the viewing means is large than eyeglasses, sitting with a mounting means on the shoulders and/or head. The head can preferably turn around and see different parts of the translucent surface. The eyes preferably have a wide angle of vision, up and down, and side to side with a large translucent screen.

In a preferred embodiment the optical effects including 2D and/or 3D can be assisted by wearing different colored or polarized contact lenses, eyeglasses, etc so one eye for example might see red and the other blue. Then a blue image and a red image are directed onto the helmet surface. This can result in a three dimensional image.

In a preferred embodiment the projecting means can include for example LCD's, OLED's, cathode ray tubes, and all other image generating devices known to the art.

In a preferred embodiment the viewing surface can be substantially reflective and direct image from projectors in positions including for example under the chin, to the side, from above, etc. This can be combined with the other projectors if desired so parts of the image might come through the translucent viewing surface and part reflected off it.

In a preferred embodiment there is a non flat surface in substantial parts of the viewing surface including for example corrugations, bulges, parabolic shapes, facets, lenses, tubes, filters, etc. These surfaces preferably run substantially vertically, or at right angles to the level of the eyes. For example in FIG. 20 projector A is near the left ear and projector B is near the right ear. Projector A shines onto the viewing surface, and the corrugations are arrayed to reflect this into one eye only. Projector B shines on the other facets of the corrugations, and these reflect the images into the other eye.

In a preferred embodiment the surface may include filters. For example Projector A might emit red light and Projector B might emit Blue light. If the surface included an uneven surface for example corrugations one side might be colored red to direct the red projector image to one eye, and the other side of the exampled corrugations might be colored blue to direct the blue image from Projector B to the other eye. The corrugations and other uneven surfaces may not be necessary in a preferred embodiment. For example the reflective surface can be designed to reflect in preferred directions. By making the surface rougher but still reflective light shining on it from any direction can be directed to the eyes. For example the reflective screen surface can have a texture like sandpaper, but where the surface is also reflective. Depending on the resolution the analogy to very fine sandpaper is preferred.

Images from the projectors can then be seen in either 2D or 3D. To make 3D the user can wear 3D glasses for example with red and blue lenses. Projector A can then project red light over substantially the whole of the translucent screen and Projector B can also project over preferably the same or similar areas. The glasses then filter out light so each eye sees a different image.

In a preferred embodiment at least one of the corrugations can be replaced or augmented by at least one holographic imprints on the surface to reflect at preferred angles, and at least one image deflecting devices known to the art including for example lenses, prisms, tubes, etc can be used. Additional projectors may be placed at other angles to further increase the viewing angle.

In a preferred embodiment the helmet can be relatively light as the reflecting surface need not be heavy, but it should be sturdy enough not to warp and distort the image. A shoulder mount is the preferred way to mount the devices but they could also be mounted on the head like a hat, with the reflective and translucent surfaces hanging down. Included in the invention is a preferred embodiment to use a smaller viewing surface for one eye.

One advantage of the invention is the size of the helmet can make the screen further from the eyes than the usual glasses and so make it easier for the eye to focus on it.

In a preferred embodiment there can be sensors to detect where the eyes are looking and how they are focusing, and the images can be defocused outside of where the eyes are focusing on, to augment the natural tendency of the eyes to focus on objects and outside this appears blurry. This is because one part of the retina can see more details than the surrounding areas.

In a preferred embodiment the eyes can be tracked and the details not in the direct field of view can be decreased in detail as the eyes can perceive less detail from off the center of what they are looking it.

The devices here in this US application are not intended to limit in any way, on any page. Parts from any invention, preferred embodiment, device, object, anything described here can be considered also as a separate invention in itself if it is novel and non obvious and their individual scope is not limited by the context of their disclosure, but should be best left to the claims. In this way any of these could be used with any other described in this application, without limit.

In a preferred embodiment sound can be included in the 3D experience or sound can be used by itself. Speakers are directed to preferred parts of the body and head and played to give a particular mix of sound. For example speakers can be affixed to and/or be near parts of the body including the skull, the arms, the ribs, the collarbone, the stomach, and all other parts. These speakers can play sound to be directed into the body like a bone phone but to create a preferred pattern of different strengths of sounds in different places. In addition different sounds like different parts of a band or different parts of a sound track can be played to different parts of the body. The mixture of these sounds makes for a preferred sound listening effect.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### DEPLOYABLE HOOKS

### ABSTRACT

Implements can attach to a material and act in ways including being retracted or forming a permanent bond.

### BACKGROUND OF THE INVENTION

The present invention relates to the field of connectors.

### SUMMARY OF THE INVENTION

Velcro is a useful connector with many applications. It has the drawback though of being noisy to disengage. It would be desirable to have a connector that could be opened more quietly. Gluing objects together is often fragile because the glue has little strength when repeatedly deformed. It would be desirable to reinforce glues to make them stronger the way steel reinforces concrete.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 21 shows implements while retracted.

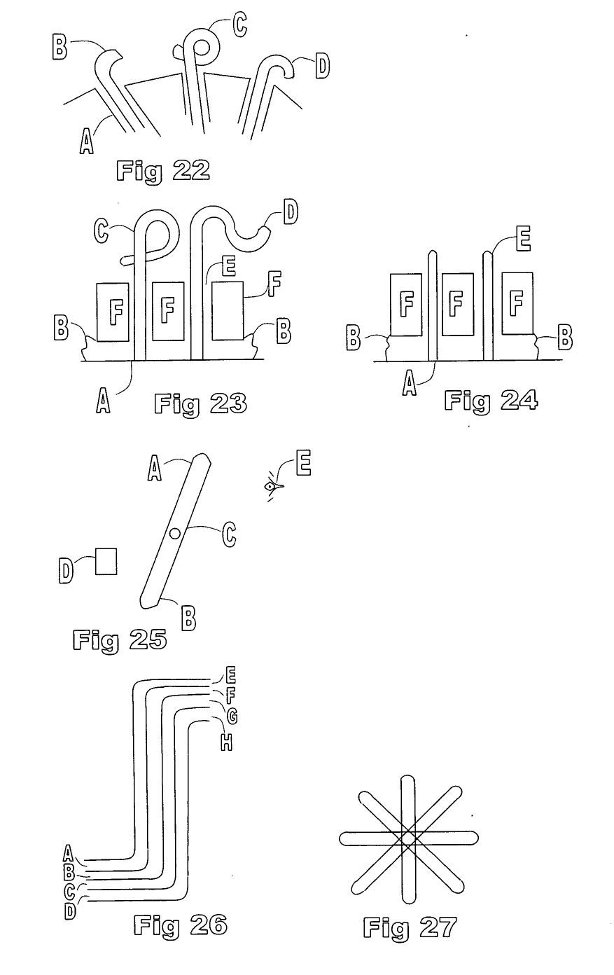

FIG. 22 shows implements while extended.

FIG. 23 shows implements extended and connected to a movable surface.

FIG. 24 shows implements retracted and connected to a movable surface.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves preferably retractable implements including for example hooks, pins, wires, nails, screws, rivets, plastic strips, spring steel, etc which can partially or wholly be extruded from recesses and enter in ways including for example hook into, pierce, screw into, rivet into, twirl into, tangle with, intertwine with, etc other materials including for example cloth, wool, string, twine, cotton, steel wool, fiberglass, wood, glue, resin, cement, other hooks, etc.

The implements are preferably resilient and springy, and so if and when they are retracted they can alter in shape including for example deform, straighten, thin, flatten, etc to fit into the recesses. If they are not springy then they may not need to straighten or otherwise change shape to be retracted.

In a preferred embodiment when the implements are extended they can change into preferred shapes including for example twirls, hooks, loops, curves, angular shapes, arcs, spirals, etc. When retracted each preferably goes into a storage means including for example a tube, a recess, a pocket, a hole, a crack, etc.

For example in FIG. 21 the implements B are recessed into tubes A. They may be completely in the exampled tubes or protrude a predetermined distance D. C represents a means to cause the implements to protrude substantially more from the exampled tubes or to be brought back into the tubes a predetermined distance.

In FIG. 22 the implements are more extended from their recesses A. B shows how a preferred embodiment of at least one implement can curve when extended. This can preferably enable it to hook into a material including for example a kind of steel wool, tangled line, wool, cotton, furry materials, hooks, plastic, organic materials, leather, nylon, etc. The flexibility of the implement could be an attribute of materials including for example spring steel, plastics, organic fibers, etc. C shows another preferred embodiment where at least one implement can twirl and preferably hook into the materials disclosed. D shows a preferred embodiment of at least one implement that can form a hook shape, and may include a barb.

In a preferred embodiment if there are enough of the implements they can hold on securely-to objects including for example parts of a zipper, a fly, a shirt sleeve, buttons, button holes, Velcro, hold down canvas, annexes, car covers, covers on the back of utility cars, tangled wires, fur, etc.

In a preferred embodiment the material with the recesses containing the implements should be placed in close proximity to these materials so when the implements protrude a predetermined distance and preferably deform they securely hook into the material. A preferred material to hook into with the implements includes wool. The hooks would tend to get between the fibers and there would preferably be enough of them to hold securely.

In a preferred embodiment arrangements of materials would include for example knitted, netting, woven, etc so the implements could hook into them. There are plenty of other materials like this known in the relevant arts

In a preferred embodiment retracting the implements can be done in many ways including for example rotating a knob, pulling a lever, by a spring, pulling on a string, etc. For example in FIG. 23 a surface A is connected to a plurality of the implements. B represents a material preferably springy or elastic so that if A is pulled away from the material containing the tubes F the implements cannot be fully pulled out of the holes. If they were it would be difficult to reinsert them. E represents the recesses, tubes, etc containing the implements. C represents a first deformed shape of an implement which of course can deform to any shape. D represents another shape.

In FIG. 24 A has been moved away from the holed material F which has straightened the implements. B is preferably under more tension so A is not moved too far. If the implements had been hooked into something they would have retracted out of the material. The invention can be used in many ways including for example to hook into something like a button and then release it, to connect into a buttonhole and then retract, to hook into a fur and then release, to hook into a woven material or netting and then release it, etc.

Of course these are examples and the same principles can be used with any suitable materials, and none of this is intended to limit the scope of the inventions. For example the hooking means could be a much stronger material like spring steel and hook into a strong net so it can hold a substantial weight.

In a preferred embodiment once hooked into a material this can be made permanent by covering it with a cohesive means including glue, fiberglass, concrete, molten plastic, resin, molten metal, etc. The implements have a flexibility that complements the cohesive means in a way analogous to reinforcing in concrete, glass fiber in resin, etc.

In a preferred embodiment the implements can be made non retractable so when released they form a permanent lock, in combination with all other aspects of this invention. They can also include barbs like on a fishing hook to hold on more securely.

According to a preferred embodiment these devices can also hook into each other. For example the device in FIG. 3 could have hooked into another substantially similar device. Preferably the implements have characteristics including for example barbs, angular sections, hooks, twirls, etc so they tangle together and are harder to pull apart.

In a preferred embodiment these devices are used in conjunction with a cohesive means to join objects together including for example pipes, wire grids, plumbing, roof sections, fencing, etc.

In a preferred embodiment there may be some objects with irregular shapes that need to be joined, but there may not be flat surfaces to use standard glue. The devices are intertwined together around the objects to be joined and preferably a cohesive means including glue, resin, cement, etc is placed around it. The pieces act in a way analogous to reinforcing in concrete and maintain cohesion in the glue. Preferably the glue would be resilient so it could bend with the pieces, but hard setting glue can also be used, like with concrete.

The pieces are an example, any kind of material can be used to reinforce the glue. For example grid like shapes can also be used, even cloth.

In a preferred embodiment the pieces may change shape based on a stimulus to become more or less intertwined. They may be designed to be relatively straight but to curl up under the action of a catalyst. For example the pieces could be a springy material including for example spring steel, springy plastic, etc but held substantially straight by less deformable pieces of material on their sides. They might be in recesses or a plurality of them could be not in any recesses.

This material can be altered in many ways including for example being melted, chemically weakened, dissolved, broken, etc and as it does the pieces preferably deform in ways including coil, twirl, curl up with each other, etc forming a mass that is difficult to untangle. This can optionally be covered in a cohesive agent like glue, fiberglass, resin, concrete, etc.

In a preferred embodiment implements can come out of the aforementioned tubes arranged in a predetermined orientation for a tactile display. For example there could be clusters of tubes pointing in preferred directions, including for making a 3D tactile display. This is similar to arrays of tubes in my PCT WO9910766 where preferred tubes point in different directions. Instead of or in addition to light emitting from these tubes the implements can extend and form a different shape. Preferably the implements would not need to deform as much because they are to create certain shapes according to how much they protrude from the tubes.

In a preferred embodiment the implements can be retracted by mechanisms that control a plurality of individual implements. For example if each implement can protrude a predetermined distance then any kind of texture and shape can be made. For example a kind of carpet material could be made and the texture determined by how much the implements are adjusted to protrude or retract.

In a preferred embodiment the implements can be directed to form different kinds of textures including for example wool, fur, etc. They can also create complex 3D shapes as some protrude more than others, which blind people can feel and recognize information.

In a preferred embodiment depending on how long the implements were it would create a certain kind of texture, 3D shape which could be useful for many purposes including for example tactile displays for the blind, friction surfaces to be customized, changing of shapes of bristles in brushes and combs, changing of the fabric feel in carpets rugs and clothing, etc. The implements would preferably be materials and textures including for example twine, rope, wood sticks, wood shavings, bendable plastic pieces, carpet material, wires, optic fibers, tubes, fluid conduits, etc.

In a preferred embodiment if the various protrusions were retracted the surface would be smoother, and different protrusions could be retracted to make various effects including for example textures, messages, optical images when using tubes and optic fibers, etc. The protrusions could be extended and retracted in any pattern by mechanisms including for example using forces such as magnetism, electricity, electrostatics, levers, cogs, heating and cooling, chemical reactions, etc.

None of the examples here are intended to limit nor are any in this overall application submitted here. Indeed these various characteristics described here an in other sections can be combined with each other in all possible ways. Any object, method, process etc of any part of this submission can be combined with any other object, part, process, etc in any way, not limited by the context in which they are disclosed. The scope of this is best left to the claims.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### FORMATTED DOCUMENT

### ABSTRACT

### BACKGROUND OF THE INVENTION

The present invention relates to the field of document formatting.

### SUMMARY OF THE INVENTION

The internet and other networks are difficult to manage because there is so much fragmented information. It would be desirable to have a means to organize it automatically.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to follow links more easily. On the internet there are more and more web sites with hyperlinks which reference other sites, images, files, sounds, movies, etc. This can be very confusing, as the user starts following links and can get lost or confused trying to understand all the information linked to and how the data objects relate to each other. This can be solved by the invention, herein referred to as the system.

In a preferred embodiment there is a means to organize and format data which is written in programming languages including active server pages, java, virtual machines, HTML, ASPX, XML, and all other kinds of computer code known to the relevant arts.

In a preferred embodiment this system would be better deployed if there were standard ways to write the code for these commands in programming languages. Preferably entities including for example web site creators, forum creators, document formatters, etc could make them more easily compatible with this system. This is not necessary but may be desirable if the system became popular.

Herein document refers to any kind of page in a computer means including for example web pages, PDF files, Word documents, spreadsheets, etc.

In a preferred embodiment say the user is reading a document with ten links in it. Five of those links also have links to other pages. These may link to the internet, in a network, to a database, server, any computer means, code or files known in the relevant arts.

In a preferred embodiment the system would be designed to take predetermined parts of the link data and present it preferably in the one document. Take the ten links as the first example. The link should contain additional identifiers of the format and dimensions of the relevant material it links to. This is easy if it is a sound, movie, image, but harder if it is text.

In a preferred embodiment the system should then take the required material from each of these ten links and embed, display or otherwise make it available to the user on the page he is reading. For example say the links with images, sounds and movies can be displayed. For example the movie and sound parts may be displayed as icons to be activated and the images displayed or thumbnails inserted.

The text would appear in the document, as much as is relevant in the link, and/or is defined by the designer of the other web pages or the current page. If the user inserted another link in the document the system should automatically get the data and present it in a predetermined format. The document can be self assembling according to a format and rules. It can also search for more information according to guidelines and assemble that in the document.

In a preferred embodiment this text brought from the link may appear changed including for example in a different font, font size, color, be underlined, in italics, bold, footnotes, etc to differentiate it from the original page.

For example a link can be set up to link to two positions in a document, the start point and the end point for text from the link to be transferred to the main document. Hyperlinks can be set up to open at a certain line in a web page. If the document contained two of these links they could be configured by a coding means to transfer all the data between these two lines into the main document.

In a preferred embodiment a link to a web page contains 10 lines of interesting text and it is desired to have this automatically placed in the main document. This is so the user doesn't have to follow the link to read the data, it is placed in the main document and formatted for him to read it there automatically. There culd be two HTML links, one of which points to the start of these ten lines and one to the end of it. This can tell the document's formatting code to transfer all the data between those two lines.

It would be preferable to have a command which said the equivalent of go to this web page and bring back the next 10 lines of data after line X. This command does not seem to exist though it could be easily coded.

In a preferred embodiment the system will display all ten links with their relevant material and the user can read it all as one document. In the example of whether these ten links have links in them, data from them could also be transferred to the main document, to as many levels as preferred. If there were too many the document would become undesirably large.

This system can be used in any computing means, operating systems, programming languages, markup languages, etc.

In a preferred embodiment this can be used to manage posts in forums. For example the user is monitoring ten forums and posting in them, and has five friends which also post in them. To manage this he might create links to each forum in the document along with inputting the names of his five friends to monitor.

The system searches these forums and places in the document preferred posts by the user, in a predetermined format. This format might include for example categories of posts, times posted, subjects, lengths of threads, etc.

The system can also retrieve the posts of his friends and other threads to be monitored to be placed in a desirable format as disclosed herein. It then becomes easy to follow the threads.

In a preferred embodiment the user can see all his posts and those of his friends. He may in addition be monitoring subjects based on links to URL's, keywords, etc in other forums. These may at times appear on his page as they are found by a searching means. Additionally search engines may look at data sources including for example the internet, local networks, dictionaries, encyclopedias, etc for other relevant material.

In a preferred embodiment on clicking an icon he might be able to add more data including from for example forum threads, web pages, newspapers, blogs, etc. He might in addition simply respond to his friends and other selected posters and only see their responses. This is like a kill file in certain ways, including for example he might only sees posts from people he has accepted. For example he might set this up so he sees all posts except people he doesn't want to see, he only sees subjects and keyword threads and/or posts he prefers, posts and/or threads he doesn't like are filtered out.

In a preferred embodiment the forums become like one large forum as all the different parts can be combined and laid out as preferred. As with the document with the links it becomes much easier to follow. Additionally posts, threads, etc can be differentiated according to their positions, colors of fonts, types of fonts, font sizes, italics, being underlined, parts in bold, etc.

In a preferred embodiment the user may decide to expand and contract various parts. For example he might find some links are more interesting and set the document to follow more links and display more results. In pages that do not define the start and end points of the relevant material the system might print the first X number of lines. For example it might show the first 20 lines on the linked page which can serve to acquaint the user with what is one the page, or the user can activate a control to show more of it. Keywords and other desired data can be highlighted in links as explained herein.

In a preferred embodiment he might decide to expand the forum list by searching for more forums on a particular subject, possibly including using an internet search engine. This when found would be displayed on at least one page for the user.

In a preferred embodiment the user could create their own documents including for example encyclopedias, books, research, indexes, chapters, regulations, manuals, etc. By selecting defining means including for example keywords, subjects, links, servers, preferred online and network resources, help files, FAQ's, themes and styles to place the information in certain patterns, FTP resources, search engines, databases, spreadsheet files, etc the document could assemble itself, preferably with inputs and guidance from the user and/or others. There could be predetermined templates which could be loaded along with keywords, guidelines, etc which would the assemble themselves.

In a preferred embodiment the system could also look for other documents with a similar means of assembling themselves as disclosed and use some of their materials. This might be easier as that document may have done some additional searching.

The preferred embodiments disclosed here may use some extensions to known languages including for example java, active X, HTML, XML, etc to do these any other tasks. The actual tasks though are not difficult for computers to do, and for programmers to encode.

In a preferred embodiment galleries of objects including for example images, movies, sounds, PDF files, 3D files, etc could be accumulated and assembled into a desirable viewing system and document.

In a preferred embodiment file sharing program may in addition be used to accumulate data for these documents.

Procurement and updating of data can also be done by devices including for example bots and spiders, programs well known on the internet. These programs can visit web sites and other repositories of data on the internet and look for new material or changes, then report this data back to the document forming means. This in turn updates the links and information so the documents remain current.

In a preferred embodiment of the invention if a data source including for example network computers, servers, web pages, FTP sites, any information source reachable by any network connection known to the art, etc. is visited by means including spiders, bots, personal web research and surfing, etc there may be a manual or automatic means to request the data source to arrange their data to comply with the systems described here, and perhaps to request they create systems like these on their own data sources.

In a preferred embodiment to improve the means to set up these data sources various kinds of code including for example scripts, batch files, java, WScript, WMI, etc can be used. For example a user desiring to set up a document described here could have a menu and wizard driven system where multiple choice was included in the options. Included could also be browsing to particular data sources including web pages for example, selecting the data and its position, size, etc so it shows up in the document.

For example if a user was including web site matter he could browse to the web site and select the data to include. Additionally he could select areas to monitor and update, and how often. There could be parts including for example chapters, sections, inserts, pop ups, banners, frames, flash data, shockwave data, etc that can be defined to appear and be updated in the main document.

In a preferred embodiment the system can be set up to also assist in maintaining one's own data sources for others to use in ways including by scripting, menus, wizards, etc. Different data in the data sources can be selected with this system and identifiers associated with them so when others, including spiders and bots come to the data source they can more easily know which data is what kind and how it can be updated and displayed.

For example with a file server or FTP site there can be many files and they can be hard to understand unless they are all opened. In this example there can be attributes defined on the files such as special identifiers and extensions for how they should be handled in setting up the documents.

In a preferred embodiment there can be special files including for example data, scripts, locations, times for replication, etc to make this setting up of the documents easier. If this was standardized of course it would be easier to implement but the files could be set up with wizards, menus, etc in an easier way.

In a preferred embodiment data sources are contacted by a means including search engines, bots, spiders, etc and messages can be left requesting the data source be set up to be compatible with the system. These messages could include for example emails to addresses available, messages on forums, blogs, guest books, etc. Care would have to be taken to avoid being perceived as spamming the user.

In a preferred embodiment a substantial percentage of the internet, file servers, networks, etc could be indexed according to the invention so that users could create documents, encyclopedias, forums, indexes, books, etc and have these populated with data substantially automatically. Standardization would help this process.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### PROJECTILES WITH MISCELLANEOUS INTERIORS

### ABSTRACT

Projectiles including bullets can be created with types of chemicals inside. These can create more pain and incentive for the person shot to give up but much less chance of serious injury.

### BACKGROUND OF THE INVENTION

The present invention relates to the field of ballistics.

### SUMMARY OF THE INVENTION

Projectiles are an effective mechanism but often create too much injury. Often they are difficult to use when a person needs to be stopped but not hurt. It would be desirable to have a projectile that was less lethal while still being effective.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves different material in the insides of projectiles including for example bullets, pellets, shells, etc to those normally used. These can include for example hot materials, barbs, capacitors, sound emitters, etc.

In a preferred embodiment the interior of the projectile contains a material that causes pain on the skin, or in breaks in the skin. This could include for example materials that sting for example toxins from insects and snakes such as wasps bees rattlesnakes, etc. As the projectile hits someone it breaks open and preferably breaks the skin.

The material is preferably designed to cause a lot of pain, and the amount of pain preferably distracts the person shot while not harming them from the chemicals used. An insect bite can often quickly cause a lot of pain. If the person shot gets a dose of this or other chemicals it could be the equivalent of being stung by many insects.

There are also other materials which can cause pain on open skin, and these are well known to the relevant arts. Doctors for example would encounter these regularly with patients. Materials that taste hot including for example chilies, mustard, jalapenos, etc can have this hot compound concentrated in the projectile.

In a preferred embodiment the bullet contains barbs inside it which act in ways including for example embed themselves in the person on impact, the shell falls away exposing the barbs while the bullet is in motion, etc.

In a preferred embodiment there can be a capacitor to send a surge of current into the victim, similar to that of a taser. To increase the amount of voltage the bullet can be for example longer and thicker, giving room for a larger capacitor. Also it can have trailing behind it additional powering means connected with wires. For example there could be a propeller spinning from the speed of the flight charging a capacitor.

In a preferred embodiment the material in the bullet is heated before it is fired, in some cases to the point of being plasma restrained in the shell. When it hits someone the material is released and burns the person, which feels like a more serious injury. Additionally it may contain pain causing chemicals. One advantage is that the person being hit cannot realize whether he has been shot by a normal bullet and suffered great injury or by these means where the pain need not be accompanied by as much injury.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### CONNECTIONS BETWEEN PROGRAMS

### ABSTRACT

A system is disclosed for making computer programs more secure.

### BACKGROUND OF THE INVENTION

The present invention relates to the field of computing.

### SUMMARY OF THE INVENTION

Computers are very vulnerable to hacking. Once a virus gains entry to a system there are few safeguards. It is desirable then to create a system that even if a virus gained access it could not infect it.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to improve computer security. Hacking computers is one of the biggest problems with the internet today. Once a hacker gains access into a computer there are very few protections. Spyware and viruses are hard to protect against once they infect the computer, especially if they are a new kind that hasn't been identified yet.

There are some other protections available in the art, for example where firewalls restrict access to private networks from the internet. Also Microsoft for example uses Discretionary Access Control Lists with NTFS. In this system each file and folder can potentially be restricted in access.

In a preferred embodiment there is a system of making operating systems secure against all attacks. It includes many of the known uses of encryption in networks that are known to be effective, but includes their use to isolate segments of code from each other.

For example the IPSec protocol can be used but any protocols involved with encryption are contemplated, including for example Extensible Authentication Protocol, CHAP, MSCHAP, Kerberos, LT2P, PPTP, 3DES, PGP, etc.

In a preferred embodiment at least one access controlling means including for example Discretional Access Control Lists and equivalents are used on predetermined data objects including for example code, programs, DLL files, INI files, the registry, files, drives, controllers, folders, etc. These preferably restrict access from a first segment of code to a second segment of code, for example programs from other programs, so they can only interact in preferred ways.

For example an email client like Outlook might download an email that is infected and this normally would infect the computer. Files however that do not need to interact with an attachment or file from Outlook could deny kinds of access to them.

In a preferred embodiment predetermined files and code may be accepted and others rejected. Some code might have a restricted access on what it is allowed to do including for example read only, modify other code, delete, etc. The invention can be used for all kinds of code including for example browsers, media players, firewalls, anti virus programs, code to format drives, code to overwrite and alter system files, etc.

In a preferred embodiment the invention contemplates that the origins of all code be identifiable so it can be proved where the data comes from. There is an acronym called CIA in computing standing for confidentiality, integrity, and authentication. Preferably the invention secures in ways including these three criteria.

Data when transferred can be encrypted so its confidentiality is safe. Data integrity can be achieved by for example checksums so an infectious agent for example cannot alter it. Authentication is achieved in ways including determining the origins of the code.

For example if a virus can spoof the origin of its data it can gain access to restricted areas. The system can guard against this for example by using safeguards such as in Kerberos. For example since code is assigned IP like addresses Kerberos can secure communications between them.

In a preferred embodiment the programs and other code needs to be able to communicate with each other in a secure manner. Outlook for example would only need to communicate with certain programs and files. It might need to direct code and files to other programs but for example it should not need to access certain files as well.

In a preferred embodiment IPSec is used as an example of the principles involved. Each data object including for example code, programs, files, services, etc is preferably issued with an identifier including substantially the equivalent of an IP address.

Preferably these addresses may be issued from a DHCP server or equivalent, and/or they may be statically defined. Preferably these could be dynamically assigned at some point so the IP address number could not be predicted. In addition these data objects could have ports which again would preferably be non standard and harder to guess.

Usually programs are capable of sending information to the internet and receiving it. Those that are not capable of this can be adapted to follow the invention.

In a preferred embodiment, to make the examples easier and to avoid conflicts each segment of code, for example a program would have an IP address assigned in a subnet. Preferably this would be a new system using numbers starting with 127.0.0.1, and ending in 127.255.255.255. Only 127.0.0.1 is used so far as the local host computer. In these examples the other IP address numbers are assigned to code including for example programs, files, services, etc.

In a preferred embodiment programs that typically interact with each other may be given numbers in the same subnet. For example there might be a subnet 127.0.1.0 with a subnet mask of 255.255.255.0. This allows for example 254 addresses, from 127.0.1.0 to 127.0.1.254 for programs to use to communicate with each other. So this may include needed code segments including files from preferred programs, each preferably with its own IP address or equivalent. Subnets can be defined by a means including the conventions known in the relevant arts. They are well known in computing and substantially the same systems can be shown as examples herein.

In a preferred embodiment the data including for example code, programs, files, instructions, requests, interrupts, etc, instead of or in addition to being sent directly to a destination can be for example routed into the TCP/IP stack or equivalent. The data is assembled into packets in the stack and then these packets are sent to a repository including for example RAM, hard drives, flash memory, networks, etc. It can also be sent directly to the IP address or equivalent of the receiving data objects, for example programs, code, etc. In the stack the data can be encrypted with for example IPSec.

In a preferred embodiment when a first segment of code wishes to send data in a secure manner to a second segment of code it can use a security protocol like for example IPSec, Kerberos, PPTP, etc. The packets are encrypted with the example of IPSec, and then decrypted at the destination. In a preferred embodiment it might be useful to have a separate TCP/IP stack for this process, or even two or more, perhaps one for encrypting and one for decrypting.

In a preferred embodiment the encryption and decryption can be done in the TCP/IP stack or related code, programs, etc. This can instead of or in addition be done by predetermined programs which can do this task for at east one data segment, section, etc. For example there can be specialized programs which encrypt and decrypt, this could also be done by hardware to speed this up.

In a preferred embodiment for security no code can change settings in the security protocols and stack. Interactions may additionally encrypt the files and do key exchanges including for example Diffie Hellman.

In a preferred embodiment code including for example programs, files, services, etc would also receive and send data to preferred ports and not respond to other ports. This could be an equivalent of a firewall for example where code is restricted to receive data only from preferred addresses and ports.

Of course in all these examples there is no intention to limit. These are particular examples in a strong kind of security and all manner of more relaxed interactions can occur as well.

In a preferred embodiment since the various files are preferably protected with Discretionary Access Control Lists and equivalents they cannot be infected except by an infectious agent getting through the equivalent of the TCP/IP stack. These lists preferably define who or what is allowed to access the protected code including files, and what they can do to them. For example they might be allowed to read them, modify them, delete them, etc. The Lists might additionally contain information about what addresses and ports it can allow access to. This can be done in a network for example with Kerberos where only for example authenticated users who have signed onto a network can access certain data.

Preferably the address the data comes from can be authenticated as genuine. This might include from exchanging passwords.

The examples from using TCP/IP are to explain the invention not to restrict to using the terms herein including for example TCP/IP, ports, IP addresses, IPSec, Kerberos, passwords, key exchanges, etc: All these are intended to embody the broadest terms. TCP/IP is a protocol, any data protocol could be used and it may be preferable to design a special one for this task. IP addresses can be any kind of identifier and/or addressing system, which can be a special one for this task or any of the enormous numbers of them that have been used in computing. One might for example use NetBIOS, IPX, Appletalk, etc. The structure of the protocols and addresses can be created in literally more than millions of different variations. IPSec is simply an encryption method of which there are almost endless variations. Some may be more secure but for this task perfect security may not be necessary as an infectious agent would be unlikely to be able to crack the encryption.

Kerberos is also a system of encryption, etc which can be duplicated in enormous numbers of variations. The tickets used in it for example can be varied almost endlessly in their format, packet size and layout, numbers of packets, timing, etc. Key exchanges can be done by many known algorithms, it might also simply be done by a pre shared password without a key exchange. Again all these embodiments preferably need not be as secure as the infectious agent has few resources to crack them.

Since an infecting means including for example viruses, spyware, etc would not have any passwords it should not be able to gain unauthorized access no matter what its code is. Also it could not contain a computing means strong enough to break the encryption employed.

In a preferred embodiment files can be further disguised and encrypted. For example the names of code including for example files, programs, scripts, DLL files, anti virus data, etc can be changed, along with the names of folders, drives, and all other attributes. When a program wishes to send something it preferably does not know the current names of the files of the receiving program. It needs to send its requests and code to at least agent including for example a translation center.

This exampled center examines the credentials of the requests, and if valid it can respond in preferred ways including for example it renames and/or encrypts the files, code, etc being sent so the receiving party will understand them, it discloses the new names of the target code, data, etc so the code knows what are the real names and of the files and/or how to encrypt them, etc. An infection agent even if it gained access to the files would not recognize the names.

In a preferred embodiment files can have additional code added to places including for example their beginnings, at selected points, at the end of them, etc. The translation means would preferably know how to strip out this decoy code or it could pass this knowledge onto the code that intends to use these files. For example this could make all the file lengths different from what the infecting agent expects, even make them all the same length. The infectious agent would have virtually no way of working out which were the correct target files to infect.

In a preferred embodiment programs and other code that interact with each other can be in a closed system and not be open to the possibility of infection from outside code. An infection means that did penetrate the system could only get to at best programs that had no access that was useful. For example a worm could not have any access to programs that could send emails. If it had its own SMTP engine it could not run it because the system would only recognize code that came through the translation manager. It would have to be encrypted with for example IPSec, have authenticated passwords from a key exchange, have a valid IP address that could be checked, etc.

In a preferred embodiment code could be rewritten so that icons including for example words, line numbers, known symbols used in that programming language, ranges, libraries, code locations, etc that had a first meaning in the given programming code now had a second meaning.

Preferably this second meaning would be incorrect so the code could not run unless retranslated into the first meaning. Preferably also additional symbols could be introduced that had no or a wrong meaning in that programming language.

Restoring the code to its original working order would be accomplished if desired so that preferred code can interact with it after authentication.

In a preferred embodiment different code in the computing means might remain in this altered state. A recognition means would know what the new and changed symbols meant and so could run this code accurately. This code could then perform the preferred functions but an infectious agent or other unauthorized code could not recognize it, and nor could the altered code recognize any other code.

For example there could be a plurality of sections in the computing means each of which ran substantially autonomously with code that was different in ways including for example structure, symbols, ranges, syntax, etc to the other section.

In a preferred embodiment each section could perform its preferred function with its altered code. When a first section needed to interact with a second section then it could use one of the aspects of the invention herein. For example a first segment of code could have at least one IP address and the second segment of code it was to interact with could have at least one IP address. Secure connections between them can be done by the exampled IPSec, Kerberos equivalents. A code segment might have a plurality of IP addresses so it can respond to different data objects which could be in different subnets.

The translation manager could also transform the code to the correct format for the destination. Each first section might share some code icons with a second section so some code might be routed directly between them without the need for translating them. This can be useful if certain interactions are safe and can be done more quickly this way.

A good analogy would be ten different people are working together in a factory, and each speaks a different language to the other. They might decide to learn words off each other but only ones that were safe methods for them to communicate. They could work together like this and each could do their jobs, and communicate safe instructions to each other.

If someone came into the factory (representing an infectious agent or other dangerous code) and knew for example one language then they could affect one worker's job (like damaging one part of the programs running such as the email client through an attachment) but only say to the other workers safe instructions so the damage would be isolated. The different workers would be different sections including for example operating system, email client, video output, sound card drivers, office programs, anti virus programs, firewall, art programs, etc. The infectious agent might corrupt one but not the others.

In a preferred embodiment the code could have a set of symbols and commands that for example the operating system recognized, and it might not recognize any other ones. Since the infection agent could not know this its code could not be recognized. This could include even assembly language as well as of course C, C++, C sharp, java, XML, HTML, Visual Basic, etc. Certain commands that normally might be written in a syntax might be given a unique icon to represent them and this icon is defined in a plurality of section. If then this code needs to be sent in a trusted manner between the section then the icons can be sent and this is understood by the receiving means. For example the command in a first section might be written in a first syntax that cannot be understood by other sections. It send an icon representing a preferably safe command to a second section which interprets the icon as a second syntax unreadable to the first section.

A good analogy is the workers in the factory who might have a safe set of common language words in this example to say get me a cup of coffee. A first worker might say the word “abacus” which might have no meaning in this context as an abacus but whenever the first worker says abacus the second worker knows it means to get him a cup of coffee. This is easier than taking the language of the first worker to get a coffee and translating it into a second language to get a coffee.

In a preferred embodiment the operating system or other agent may at predetermined intervals change at least one of the code icons including for example syntax, symbols, commands etc used, and negotiate preferably a secured connection with the translation manager through the TCP/IP stack. The translation manager could receive an updated copy of the icons and thereby be able to translate the code for different sections if desired.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### LAG IN COMPUTER CONNECTIONS

### ABSTRACT

A system for reducing the adverse effects of lag including in online gaming is disclosed.

### BACKGROUND OF THE INVENTION

The present invention relates to the field of computing.

### SUMMARY OF THE INVENTION

Online games have a major problem in the time it takes for controller data to get from them to other internet players and back again. If players are moving then it is often unclear exactly where they are. It would be desirable to have a system to reduce this uncertainty.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to reduce the bad effects of lag in a computer network. Preferably this includes the internet and online gaming but can include all communications.

In a preferred embodiment online games have a problem with the time it takes for a signal to go from a first computer to a second computer. Since the players are often moving around, the images a player sees are of an earlier time, often about 250 milliseconds before. Because of this players can avoid being hit in a game by jumping around unpredictably.

In a preferred embodiment a user can have his controls lagged by the approximate ping time between the computers. If for example it takes 250 milliseconds to send controller data from a first computer to a second computer the controller data can be delayed by the ping time, in this example 250 milliseconds.

If a player tries to move game objects on the display then any movement would be preferably lagged by this ping time, say 250 milliseconds before he would see the effect of his controllers on the screen. The other players' signals in this example would be received in 250 milliseconds so everything seen on the display by all players would be happening at the same time. While the user's controls would feel less responsive it would be more intuitive as it would be better synchronized with the data from the second computer.

The ping could be regularly monitored so if it changed the lag could be adjusted on all player computers.

In a preferred embodiment the lag may vary for different servers and networks. For example some networks may have a lag of 100, some of 200, others 200 milliseconds. To standardize this lag a user's computing means may increase this lag to a preferred amount by slowing the signals down. In the example of a 100 millisecond lag the system might slow the signals down, perhaps by buffering it for 150 milliseconds. For a signal of 220 milliseconds it might be slowed by an additional 30 milliseconds and so on.

In a preferred embodiment these systems can be used for any tasks in any computing means outside gaming where lag is experienced. For example in remote control of machinery on the internet there is the same lag problem. A doctor might be using instruments including for example scalpels on the internet and the lag can make it difficult to estimate movements over it.

In a preferred embodiment workers might use tools to repair machinery over the internet by remote control, and if the machinery is moving it makes it harder to estimate. For example if there was a moving piece of machinery that needed to be secured, with the lag it would be very difficult to anticipate where exactly it was.

These examples are not intended to limit the scope of the invention, which is best left to the claims. In the broadest sense the invention reduces the problems associated with a time delay in a control system.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### THREE DIMENSIONAL FORMS

### ABSTRACT

An invention is disclosed to make three dimensional shapes in a substantially transparent material. Lasers focus on a small area and create a change.

### BACKGROUND OF THE INVENTION

The present invention relates to the field of optics.

### SUMMARY OF THE INVENTION

The invention discloses techniques to make three dimensional shapes including in a transparent medium.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves materials which can be chemically altered by lasers. Preferably these materials are substantially transparent or translucent. Preferably they contain chemicals which are inert in relation to each other without being acted on by a laser, but can react when hit by a laser beam.

In a preferred embodiment this combining can be in many ways including for example from a chemical reaction, parts recombining in ways that affect the transmission of light, etc. The host material can contain icons including for example small capsules, small particles, grains of chemicals, bubbles, etc These icons are preferably substantially transparent but when they are hit by a laser the shapes react to have a color and/or transparency change. This can be used for decorative purposes, and include also circuitry, optical effects, optical waveguides, etc.

A laser can then be focused onto small areas and create this change, and by moving into different paths create three dimensional figures in the material.

In a preferred embodiment the icons can have a temperature they vaporize or otherwise undergo a chemical change at, which the laser is capable of causing. As the laser heats it for example creates a bubble of gas, and the laser is preferably carefully tuned so that the bubble sets in this position. When the bubble cools the material is no longer a vapor but a shape remains that is a different color and/or transparency.

In a preferred embodiment a fiber optic faceplate material is used. This consists of optic fiber fused together in parallel to each other. Parts are removed in ways including for example drilled out, cut out, melted out, abraded off, etc of the faceplate and objects as desired can be inserted. Then the hole is preferably filled with a means including for example an optic fiber faceplate piece that fits in the hole, circuitry, optic waveguides, optical circuitry, transistors, integrated circuits, gases, a vacuum, etc along with additional materials including for example some of the same or material of a similar transparency to make the drill areas harder to see, materials to block light, to alter its path, refract it, reflect it, etc.

In a preferred embodiment the shapes are then affixed in the faceplate and can have desirable optical qualities including for decorative purposes but also the inserts can include for example circuitry, optic transistors, light pipes, optic fibers with a different orientation, liquids, chemicals, molten glass, molten plastic, clear materials, filters, displays, CCD's, motors, OLED's, LCD's, emitters and/or receptors, conduits etc. Also the faceplate can be cut up to make insertion easier, and then reassembled in ways including for example fused back together, glued, held together by pins, bolts, braces, frames, etc.

In a preferred embodiment the parts inserted can include optic fiber faceplate material inserted at predetermined angles so signals from one set of optic fiber material can be diverted to another. They can also include lenses and mirrors of at least one signal altering means including for example parabolic, hyperbolic, flat, irregular and periodic shapes so the signal coming up the optic fiber material can go into the signal altering means and be reflected and/or refracted as desired.

In a preferred embodiment pieces of the faceplate material can be reassembled with other objects described herein so light and other radiation can be directed in preferred directions instead of the normal parallel only in optic fiber faceplates.

In a preferred embodiment the faceplate can be altered by the laser as before, by having the laser focus on predetermined parts of it from the side, or from an angle sufficiently away from the parallel fibers so the index of refraction is sufficient for the laser to penetrate the material. While this can preferably be used in thinner material this can alter pathways in the fiber optic faceplate material for optical effects, circuitry, etc.

In a preferred embodiment ultrasound can be focused into all these materials disclosed here so that at the focus point the material is altered including for example fractured, cracked, etc creating a change in color and/or transparency. This can be used for decorative purposes, and other uses disclosed here.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### MULTI LAYERED OPTICAL DISK

### ABSTRACT

Layers in an optical disk selectively undergo a change. This enables a laser to interact with them.

### BACKGROUND OF THE INVENTION

The present invention relates to the field of optics.

### SUMMARY OF THE INVENTION

Optical storage devices hold large amounts of data but this is limited by the size of the pits which can be written to them by lasers. In a magneto optical disk part of the surface is magnetized but this is limited in how small the magnetized areas can be. Digital Versatile Disks have two layers but it is difficult to have more than two layers without the laser beam finding it hard to read the material. It would be desirable to increase the number of data layers in a storage device.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a multi layered optical device. A plurality of layers are normally substantially transparent, but a layer can undergo a change to make it easier to interact with a reader and/or writer.

Preferably the reader includes for example at least one laser, a magnetic reader, current from wire and/or tube connectors, etc.

As these layers are selectively stimulated they can change characteristics, including for example becoming more reflective, changing color, changing an index of reflection and/or refraction, etc.

In a preferred embodiment the layers can undergo a change in many ways including for example an emitter shines a beam on a preferred layer and causes it to undergo a color change. For example there might be a plurality of layers and each is stimulated by a different means including for example a different laser frequency. This emitter causes the layer to change including to heat up and this preferably causes a color change. The layer can then be read by for example a laser, and if desired the laser can burn new data into the layer.

Chemicals that change color when heated for example are well known in the art. This is often used in rewritable optical disks as a means to write data. For example the surface is in a first color state and a laser heats areas on the disk to create a second color state. The laser can then read the differences between these two colors. When the laser erases the disk it can change the second color back to being the first color. If a layer can change color under a stimulus it can be then heated by the layer to make marks that can be read as data.

When a layer is no longer being irradiated it can return preferably to a transparent state. The emitter may then irradiate another layer with preferably a different frequency, read and/or write more data, etc. The data in the layers could also be pre written while the disk was being created. For example each layer could be a coating and is stimulated to a second state with a change of characteristics including color, reflectivity, etc. Then the data is written to the disk and the material return to the first former state.

A clear coating could then preferably be added and then another coating to make a data layer.

In a preferred embodiment these layers could be a material similar to that used in rewritable DVD's and CD's where the laser can rewrite the surface. As each layer is selected and made capable of being interacted with, the laser reads data from it or writes data to it. In this way a plurality of layers can contain information.

In a preferred embodiment at least one laser may spin around or move in another predetermined pattern while the optical disk remains stationary. This can enable the layers to be connected to more easily without the spinning. For example each layer to be read and/or written to can be connected to from the side, from a connector that comes from the top or bottom, etc. Preferably the connector is relatively small so as to not take up too much room on the disk.

In a preferred embodiment the connectors can include wires, light pipes, optic fibers, tubes, etc. For example the layers might be conductive and be connected to from the side, top, bottom, etc by a means including for example wires, tubes, etc that can deliver an electrical current to the layer. This energy can cause the layer to change to a second state including a different color which can be read and/or written to by a laser.

In a preferred embodiment the layer may include a connection means on a plurality of sections. For example there may be a plurality of small electrical and/or optical conduits in it. The electrical conduits including nanotubes may deliver current more evenly over the layer to effect a change so the exampled laser can operate on it. They may also magnetize preferred areas. The laser could then be reflected back from these at a different angle which can be read as data.

In the example of optical conduits radiation may be delivered to different sections to effect a change including that of color.

In a preferred embodiment the connectors may join to circuitry including for example Random Access Memory, flash memory, motherboard like circuitry, integrated circuits, optical transistors, etc. Signals sent into these connectors can make changes including those which can be read and/or written to by the exampled laser.

For example the circuits may represent a kind of memory and the beam from the laser example creates changes including changes in the memory. The laser can create these changes which can then be read by the connectors substantially as they would read circuitry including RAM.

In a preferred embodiment the layer can receive electromagnetic radiation including visible light preferably from the side. The exampled light can diffuse across the layer by internal reflection if there is a sufficiently different refractive index between the layer and the surrounding materials. The radiation can cause the layer to effect a change which can then be read and/or written to by for example a laser.

In a preferred embodiment the layers can be easily constructed by one skilled in the art. A first layer can be created in many ways including for example lithography, the way computer chips are made, depositing a coating, burning areas to make conduits by a laser, etc. Then the layer can be covered by a substantially clear material and another layer created, as many layers as required.

The layers may also have connectors going from a first layer to a second layer including for example wires, light pipes, circuitry, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

In a preferred embodiment the optical disk may be composed substantially of optic fiber faceplate material. This is created by optic fibers substantially parallel to each other and then fused together. A preferably thin layer of the material can be used, preferably so the optic fibers have a first end pointing to the top of the disk and a second end pointing to a data layer. A laser can be directed onto the surface and the optic fibers channel the beam onto a layer. This can then be written to in ways including for example by making pits in the surface, making a color change in the layer surface, etc.

One advantage of the invention is that the fibers can channel the laser light in a highly focused beam. Preferably the receptor to detect the reflected beam would be above or below the fibers so the beam is directed into it. The laser may be at a predetermined angle as the fibers will direct it down to the data layer. The faceplate can have parts of the fibers blocked to better focus the laser. For example if there are data tracks the space between the tracks may be blocked so laser light shining on those sections is masked. This can make the reflected signal appear sharper.

In a preferred embodiment a surface of the disk has a mask which has apertures through which the laser can reach the data layer. This mask can be on the upper surface where for example the laser is directed onto the surface or it can be on the lower surface between the faceplate and the data layer.

Preferably the mask has a spacing between data points on the layer. For example a disk might be written to by creating pits or a color change on spots on the layer separate by lands or other colors. A land is the flat area between holes. Since the lands are not written to, the mask can further protect these areas so the change made by the beam is smaller and more focused. This makes the data easier to read since between the data points the mask makes sure there is no signal.

In a preferred embodiment the laser might be capable of writing or reading a spot of a predetermined diameter. If these spots were for example touching then the disk might be hard to read. The mask however would cut out the area between the spots more cleanly so it they could more easily be detected. The mask would preferably decrease the size of the spots enough to create a sufficient gap between them. The mask can also be used on other optical disks without a faceplate material by making the mask at the bottom of the clear material next to the data layer.

The optical disk would include Compact Disks, Digital Versatile Disks, and magneto optical disks. In the example of DVD disks the mask might preferably be used on the lower layer only.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### LIQUID CRYSTAL OPTICAL EFFICIENCY

### ABSTRACT

Liquid crystals can be set up end to end to increase their speed. The rotating end on a first liquid crystal moves opposite in direction to the rotating end on a second liquid crystal. This doubles the relative motion between the two and doubles the overall response time.

### BACKGROUND OF THE INVENTION

The present invention relates to the field of optics.

### SUMMARY OF THE INVENTION

Many displays suffer from a slow response in pixels. It would be desirable to increase this response time.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a way to speed up the changes in some display parts. In an embodiment this includes liquid crystals.

Liquid crystals in some mechanisms work by twisting under the application of an electric current. This causes one end to turn and so the light coming out of this end is polarized in a different direction.

In a preferred embodiment to speed up the response time of for example liquid crystals they can be placed end to end so the light beam travels through a plurality of liquid crystals. Then as a current is applied to each crystal they can turn in opposing directions.

For example two liquid crystals are affixed on their outer ends so the two movable ends point in at each other. On a stimulus they turn but in opposite directions to each other. Before the current is applies they are set up so that light polarised in exiting the first liquid crystal lines up with the second liquid crystal so that it goes into the second crystal.

As the current is applied, the two moving ends pointing at each other turn opposite to each other so the overall relative speed of turning is twice what it normally would be against a fixed surface. As the ends turn they end up at substantially right angles to each other so the polarised light coming from one liquid crystal is blocked from entering the second crystal.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### MAGNETIC SUPPORTS

### ABSTRACT

An electromagnet can increase the strength of a connector by increasing its magnetic field.

### BACKGROUND OF THE INVENTION

The present invention relates to the field of magnetism.

### SUMMARY OF THE INVENTION

Many connectors suffer from a lack of strength. It would be desirable to be able to increase the strength of materials when required.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to make a strong connection between a first object and a second object.

In a preferred embodiment electromagnets and/or permanent magnets are arranged in line with the South Pole to the North Pole. The attractive power then tends to hold the magnets together like a cable. If the magnetic field is strong enough this can be stronger than some materials used in cables.

In a preferred embodiment the magnets are connected together by means including for example fused together, glued together, welded together, bolted together, nailed together end to end as explained herein. This can further increase the strength of the array.

In a preferred embodiment a solid piece of material is used instead of the separate magnets and electromagnetic wiring and coils at preferred positions along its length are activated. This has many uses including to increase the strength of the core material.

Any materials known in the relevant art can be used as cores for the electromagnets, and as the permanent magnets supplied here.

The connecting means described can be used when a connector is desired to be assembled, and in addition when one is needed to increase its strength.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### CREATION OF PRODUCTS BY INTERACTIONS

### ABSTRACT

A voting means can be set up to create products including for example movies, TV shows, fashion items, etc. All aspects can be put to the vote and commentary in forums to gauge the public interest in them.

### BACKGROUND OF THE INVENTION

The present invention relates to the field of product development.

### SUMMARY OF THE INVENTION

Reality shows have become a popular form of entertainment. It would be desirable to extend the idea of including a voting audience to other forms of products.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a system of creating media shows including for example games, TV shows, movies, documentaries, feature films, advertising, etc.

In a preferred embodiment all aspects of these can be voted on by the public by a means including for example through the internet, email, messaging, forums, phone polling, letters, all other modes of communication, etc.

In a preferred embodiment ideas for a film are presented preferably online for example on a web site, file repository, forum, etc. The users look at these ideas and also are able to offer ideas of their own. Preferably each of these is subject to votes at various times and unpopular ones may be terminated or changed.

In a preferred embodiment data including for example the stories and all other characteristics are evolved, changed, removed, and all other possible interactions known to the art according to substantially numbers of votes and comments by the users.

This can extend to for example the kinds of characters, their personalities, costumes, ages, dialogue, numbers, romances, fights, etc and so on with all characteristics any known character in a media story can have.

In a preferred embodiment all aspects including for example scripts, storyboards, backgrounds, special effects suggested, vehicle designs, etc can be posted and voted on. Users may also vote their proxies to members who have a higher decision on how the project progresses.

Preferably financing of the project can also include users, who may donate or invest money and receive returns as negotiated.

In a preferred embodiment the system is similar to a reality show, but where more features are voted on and suggested by the users. Additionally users can suggest story lines in separate sections, submit artwork and develop ideas as autonomously as desired by the organizers. In addition these can be voted on or can be kept secret until the stage desired is reached.

As an example of this process Gary Kasparov the world chess champion played a match against the rest of the world, with people voting on the game moves.

In a preferred embodiment experts can be brought into the project being developed, can suggest ideas and have them voted on by the users.

Preferably alternatives can be pre posted. For example there may be several plot ideas and if one is selected by the users a plurality of additional plot idea is already worked out, which can be looked at and voted on or altered if the users vote to.

In a preferred embodiment the structure can resemble the roots and branches of a tree. The stories and other characteristics can be developed as alternatives in decision branches while the roots of the story can be voted on as backgrounds, characters, settings, etc. Including with voting, forums, suggestions, etc all of these can be changed as desired by the organizers.

In a preferred embodiment additional celebrity helpers can be employed including for example noted playwrights, authors, actors, etc. These may be contracted to work on the project and even appear in it. Other people including for example directors, producers, etc may be selected and work with the process. Actors and actresses may audition for the roles and be voted on.

In a preferred embodiment game structures can be decided on by means including for example voting, discussions, chat rooms, forums, suggestions, etc with aspects of the project including for example backgrounds, characters, other aspects voted on by the users, etc.

In a preferred embodiment software can also be designed in this way, with all aspects including for example menus, names of processes and programs, abilities, security, speed of running, user friendliness, etc as decided on by the users.

In a preferred embodiment web sites can have features to vote on including for example display movies, soundtracks, anime, TV shows, books, fashions, electronic goods to design, etc and all other products known to the art for users to view and in addition discuss, vote on, critique, etc.

In a preferred embodiment fashions can in addition be displayed in this manner for all kinds of goods including for example clothes, jewelry, consumer goods design, hats, shoes, cars, food, bikes, white goods, sporting goods, etc and these can preferably be sold as a product line. The users can preferably receive royalties and payments as agreed by the organizers. Costs can be debated by users as to how to budget any of these projects.

Preferably projects can include any endeavor whatsoever including for example decisions on management of businesses, distributing aid, designing buildings, organizing meetings, etc.

In a preferred embodiment decisions can be made by users and/or the organizers according to demographics of users, in terms to designing projects to appeal to particular groups more than other, as happens with modern movie production. People's jobs and positions in the organization can be voted on and elected by users as desired.

Preferably users may acquire shares in the projects and all business structures known to the art can be employed including for example public companies, cooperatives, foundations, partnerships, etc.

Of course none of these disclosures are intended to limit.

The scope is best left to the claims. Additionally in this application each part that can be considered to be a separate invention, the context of its disclosure is not intended to limit it in any way, and its scope is best left to the claims, and the claims in future divisionals, continuations, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### MICROWAVE UTENSILS

### ABSTRACT

Utensils are made containing materials which heat up in microwaves. Food is placed inside them and gets cooked by the heat of the utensils. Also a partial screen in the utensils can heat food partially by microwave and partially by heat.

### BACKGROUND OF THE INVENTION

The present invention relates to the field of cooking.

### SUMMARY OF THE INVENTION

Food cooked in a microwave often doesn't taste as good as with conventional cooking. It would be desirable to be able to cook with a combination of heat and microwaves.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to treat food including for example to cook, heat, boil, fry, toast, etc food with conventional heat and warm it in microwave ovens. Preferably containers are made of materials which heat up in microwaves from the radiation. This can include containers with water inside cavities in them. Water is well known for heating in a microwave but there are other materials which also heat in this way.

Preferably the material used including for example water heats from the microwave and this cooks or warms the food. The material can be thin enough, or the container can have gaps to let in microwave radiation so the contents can be heated both by microwave radiation and conventional heating.

In an embodiment this could be used for cooking for example roasts, steak, chickens, bread, any kind of suitable food that preferably needs the conventional heat as well.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### IMAGE ACCESSORIES FOR COMPUTERS

### ABSTRACT

Small displays can be hooked onto eyeglasses for watching 3D. These can be combined with a stereo set of cameras to use with mobile phones and Personal Digital Assistants.

### BACKGROUND OF THE INVENTION

The present invention relates to the field of telecommunications.

### SUMMARY OF THE INVENTION

Mobile phones and other portable computer devices often have small displays. It would be desirable to have a system that made them easier to read.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to transfer images and other data including sound from at least one computing means including for example laptops, computers, servers, Personal Digital Assistants, relay stations, mobile phones, etc.

In a preferred embodiment a computing means including for example mobile phone and Personal Digital Assistants, etc can have at least one plug to transfer this data, including and RF out to hook to a television.

In a preferred embodiment the computing means can be placed on a stand and the light from its display is magnified and focused as preferred onto a larger display screen. This screen can be between the computer means and viewer, and it could also be a screen that is angled to be viewed by the user with the computing means above, to the side, even under the screen.

Preferably a display can be connected to the computing means, including for example mobile phones, Personal Digital Assistants, handhelds such as from Palm, etc by a connecting means including for example wires, wireless, infra red, ultrasound, other electromagnetic radiation, etc so the display can be viewed separately.

In a preferred embodiment this display can be attached onto eyeglasses, and it could also include a special frame to be worn like a helmet or eyeglasses. Preferably there would be two displays to be hooked up so there is one for each eye. In the example of mobile phones they could include two cameras and other imaging means, for example separated with one camera substantially on each end of the device so users could image something in 3D, and send this data to the other devices including the exampled mobile phone which can then be viewed in 3D by a means including the dual displays on the helmet, eyeglasses, and other wearable means. It may be useful to have a barrier between the displays so in the examples of helmets and eyeglasses one eye cannot see the other eye's display.

In a preferred embodiment the displays could include optic fiber faceplates on or near their display surface to direct the light from one display more to one eye than another. This is made from fused optic fibers in parallel to each other. For example the faceplate can be cut so the fibers run at angle to the front and back surface like a parallelogram. This can direct the light more to the preferred eye.

There are many other kinds of 3D viewing means known to the relevant arts, including of course virtual reality paraphernalia including VR helmets and glasses.

In a preferred embodiment the cameras can be stereo as disclosed and connect to the computing means by ways including for example wires, wireless, Bluetooth, infra red, ultrasound, other electromagnetic radiation, etc. This can include a frame that holds a plurality of cameras so they can take 3D images, and transfer this into the computing means and send it over networks, store the data, send it to the aforementioned display means, and other desired activities.

Of course there are many display means known to the relevant art, LCD's are a good example but there are also many others including OLED's cathode ray tubes, etc.

In a preferred embodiment the computing means can contain or be connected to a projector which can project images to the displays. It could preferably have surround sound and equivalent kinds of sound data which can be connected to. Connection here includes for example wireless, wires, cables, plugs, infra red, other electromagnetic radiation, sound, etc. By connecting the correct number of speakers surround sound can be listened to from the computing means including for example mobile phones, Personal Digital Assistants, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### SOUND AND LIGHT FILTERING

### ABSTRACT

Narrow bands of light or sound can be used to deliver messages while recording. These can be filtered out later.

### BACKGROUND OF THE INVENTION

The present invention relates to the field of acoustics and lighting.

### SUMMARY OF THE INVENTION

Teleprompts are a cumbersome solution and require a reader to stare at them instead of the camera. It would be desirable to have a more efficient system.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves sounds which can be broadcast on a narrow band of frequencies and that can preferably still be understood by listeners. In a preferred embodiment there can be a plurality of these bands so the sounds broadcast, including voices, can be heard in different inflections.

For example in a recording studio voice directions can be given, and then a narrow band filter can remove this narrow range from sounds recorded so the broadcasted sounds are removed. Also software can synthesise sounds in this narrow band to replace the other sounds that would have been removed. Transforming the sounds to cover the filtered frequencies is well known in the art. For example filters can remove the hum from microphone leads and guitars, and the recording can fix the missing sounds.

In a preferred embodiment light in narrow frequencies can be broadcast to shine messages, even images onto walls, etc so people including broadcasters can read them. In a preferred embodiment this could be directed onto a at least partially one way mirror so a reader can use it as a teleprompter. A narrow band filter then removes the signals so they cannot be seen by others.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### NUMBERS AS CURRENCY

### ABSTRACT

Large numbers can be used as a form of currency, along with hashes of them and their factors.

### BACKGROUND OF THE INVENTION

The present invention relates to the field of ecommerce.

### SUMMARY OF THE INVENTION

One of the reasons money is so efficient compared to checks is that they have an intrinsic value, but checks can only be exchanged for money if they are valid. It would be desirable to have a kind of electronic money that would work like standard money, to be able to use anonymously.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves an invention, aspects of which were disclosed in my PCT application WO03025344, numbers can be used as a currency. A number can be valued by a banking means at a certain price. In a preferred embodiment this can be in the form of a sufficiently large number which has certain factors or other variables associated with it. Preferably these variables, including factors as an example here are difficult to calculate such as are used in cryptography. A good example is RSA Laboratories which selects numbers of which the factors are difficult to find.

In a preferred embodiment a user would purchase from a service, including banks, e commerce businesses, money transfer business substantially like PayPal, Western Union, etc a number which can preferably be publicly displayed. At least one factor is given to the user, preferably also with a hash of the factor to also display publicly. A hash is a way one cryptographic function well known to the art, for example MD5. If a person inputs the factor into for example the MD5 algorithm they will get the hash number of the factor. It is difficult though to find out the factor value from the hash of it.

In a preferred embodiment the user has security for his money because the banking means will preferably only redeem this number for money if the presenter can also disclose at least one factor of the number. In a preferred embodiment the number may by used in a plurality of transactions, and on each occasion at least one factor is disclosed. Each time a factor is disclosed the number may be worth a lesser amount. For example the number might have 5 hard to guess factors so disclosing one as a payment will give a lesser number with 4 hard to guess factors. It can then still be used as currency.

In a preferred embodiment the user may choose to store this number and its factors as the equivalent of a safety deposit because no one can steal its value without getting the factor. The user may protect the factors in many ways including for example encrypting them by another mean known in the art, so the user has a decrypting means including a password, PIN, etc.

Sin a preferred embodiment should the user wish to make a transaction with the number he could display the number to the other party including merchants, bankers, buyers, sellers, customers, etc. Additionally he can display a hash of at least one factor upon which the other party can confirm this hash represents the desired factor. The merchant for example could check the hash with the bank which would redeem the number for money to confirm it is valid.

Preferably the transaction is made in a secured manner including for example Secure Socket Layer, Transport Layer Security, symmetrical and asymmetrical encryption, secured MIME, and any other secured way of communicating known in the art. The user after being assured the number and hash of at least one factor has been approved inputs the factor number. This can be inputted from many devices including remembering the number and putting it into a keypad, from a smart card or similar device, transmitted from a mobile phone with SMS test messaging, over the Internet, FTP, and other protocols known in the art, over a phone line, and so on. Preferably this process includes the option for the user to retrieve the factor(s) if for some reason the transaction fails, and/or to be issued a replacement number.

In a preferred embodiment this could be done by a third party including for example an independent merchant facility, a company that takes the details of the transaction such as is often done with billing on the Internet today, etc. For example at least one factor is preferably received in encrypted form by the independent party and ideally they cannot themselves see a factor before the transaction is approved.

In a preferred embodiment this can be done in ways including for example by the devices including computer programs communicating securely, making a hash of the factor, comparing it to the hash tendered by the user and/or a hash tendered by the banking means, the authority that is prepared to redeem the number for a transaction.

In a preferred embodiment when the transaction is approved the user may receive change including at least one number in what amounts he desires. He might also receive data including hashes of the factors. Preferably the factors are sent securely encrypted so no one can read them in clear text over the transmission medium. He may input this data directly into a mobile by a SMS message or a similar means, into a computer, laptop, Personal Digital Assistant via the Internet, direct links including wireless, Bluetooth, cable connections, by a voice message to him and/or to a message bank, etc. The data can also be sent to a preferred place including a bank, lawyer, accountant, notary, Savings and Loan, government office, etc to be collected as desired later.

In a preferred embodiment the transactions can be done anonymously so it becomes the equivalent of currency as used today. Of course the invention can be practiced with any algorithm, factors are used as an example only and are not intended to limit, nor is any aspect of this application intended to limit the scope. This is best left to the claims.

In a preferred embodiment any algorithm known to the art can be used here, factors are useful in that they are difficult to guess. The factor for example could be replaced by a first number and there need by no mathematical relationship between the first number and the large number, here called the second number.

In this case of course the second number can never be derived from the first number because there need be no algorithm to derive it. This can be more secure because no one could ever find the factor of some currency by trial and error. One advantage of a factor is the user can prove he owns the number because he has the factor. The hash functions can also be signed by a digital certificate to indicate it is from a reliable banking means.

In this example the second number can be randomly picked and represent the redeemable value decided upon. One disadvantage is that someone could try to guess the first number and claim the money. This could be avoided for example by many means including for example having large differences between the first numbers, similar to the technique used with credit card numbers. Since there would be so many unused numbers in between the chances of someone guessing a redeemable number would be remote.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### OPTICAL DISK WARPING

### ABSTRACT

Optical disks can be constructed to degrade over time making them unreadable.

### BACKGROUND OF THE INVENTION

The present invention relates to the field of optics.

### SUMMARY OF THE INVENTION

Optical disks are susceptible to piracy, because they last so long. It would be desirable to make a disk that had a limited life span, and then became unusable.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves optical disks and other kinds of recordable disks including CD's and DVD's. These can be designed to become unusable after a predetermined time period. Preferably this can be to allow data on them to have a limited life so they can be sold as disks with a limited life span.

In a preferred embodiment this can be done by selected parts of the disk warping and distorting in shape. After the disk is opened from a sealed container they can encounter a warping means including for example chemical reactions with the air, interaction from the lasers in the players, vibration while being played, etc. This can cause parts of the disk to change including for example softening weakening, thinning, warping, distorting, fragmenting, breaking, etc.

In a preferred embodiment the central hole of a disk is important to align the disk correctly. If the usually clear area around the hole, or to be clear, the area between the hole and the data is made to change including for example deforming, warping, fragmenting, stretching, etc the disk will be unusable because the disk cannot be held steady.

In a preferred embodiment it would be difficult to repair because while it might be possible to replace this section with an undamaged piece, or add a bracing to it to make it stronger and more usable this would be very difficult to do precisely enough. If the changed area was cut out, sanded down, etc it would still be unlikely to be aligned well enough. The laser needs to precisely track the data on the disk and if it was misaligned on the spindle inside the player it could not do this.

In a preferred embodiment the invention can be used in any parts of the disk. For example the disk parts with data on them can be configured to change as described earlier including warping, stretching, etc.

In a preferred embodiment the warping for example can be accomplish by a springy material in the center area which is held rigidly by materials around it. As these materials are softened for example by contact with the air the springy parts distort freely. For example the parts may absorb water from the air as does glycerine and become softer.

In a preferred embodiment the center area could soften in ways analogous to a record buckling in the sun.

In a preferred embodiment the spinning of a disk could make a first chemical, preferably near the hole, move outwards with centrifugal force to contact a second chemical, creating a chemical reaction that has an effect including for example warping, stretching, twisting, buckling, etc.

In a preferred embodiment part of the area near the hole could vaporize, or turn to a liquid, and this could make the disk unbalanced and vibrate, and/or the hole could become bigger and distorted. This would make it unplayable.

In a preferred embodiment the disk materials could absorb water from the air, making them softer.

In a preferred embodiment the disk could be packaged with a plug in the central hole. Removing this plug activates a warping means. For example removing it might mix chemicals around the hole. Also the area around the hole could be designed to stretch after a short time without needing a chemical reaction.

In a preferred embodiment the inside of the hole could be soft and after being played a number of times widen and distort by itself to make the disk unplayable. This has the advantage of not needing the disk to be sealed from the air.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### CIRCUITRY IN READING MEDIA

### ABSTRACT

Parts including computer circuitry can be imbedded into pages in books, so they can function as a hybrid of the two.

### BACKGROUND OF THE INVENTION

The present invention relates to the field of computing.

### SUMMARY OF THE INVENTION

Reading books is very popular, but the information is difficult to synchronize with computers. One can scan documents, or have programs to read text, but these are a laborious method. It would be desirable efficiently connect reading materials to computers.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves media, including for example paper, books, magazines, pamphlets, cloth, optic disks, etc that have a computing means including fro example circuits, transistors, resistors, integrated circuits, random access memory, flash memory, optic fibers, computer plugs, infra red ports, USB ports, displays, LED's, etc embedded in and on them.

In a preferred embodiment circuits detect movement including for example writing, pushing, tapping, clicking, doodling, sketching, finger movements, mouse movements, etc on the media by implements including pens, mice, sticks, wheels, balls, pins, rollers, etc. They may sense the implements in many ways including for example magnetic induction, pressure, sensing light or other electromagnetic radiation, sounds including ultrasound, vibrations, etc.

In a preferred embodiment the implement may contain devices including for example emitters and/or receptors, sensors, magnets, electrically charged parts, lasers, antennae, speakers, microphones, etc.

Preferably the implement can actuate impulses in the media including closing switches, altering pathways, creating and diverting electrical signals, writing, sending and/or receiving data, drawing, sending data to and/or receiving it from a repository, etc.

In a preferred embodiment implements are used for tasks including for example writing and/or pointing out icons on the media and this can be sensed and the stimulus can be directed to circuitry, computers, displays, memory, etc.

In a preferred embodiment there can be embedded in and/or on the media displays, speakers, microphones, antennae, etc that can be actuated as the user moves the implement on or near the media. For example using wireless the user need not touch the media, and this can control lights, displays, speakers etc.

In a preferred embodiment the media can be paper or similar in concept with these devices embedded in it, preferably in this example to be bound in books, magazines, etc. The user can read these and preferably by using an implement activate devices including displays, microphones, cameras, printers, etc. Controllers can activate sending signals accessing other objects including for example computers, a network, the internet, wireless, etc.

In a preferred embodiment these devices can be made inside the media, paper, etc in ways including for example similar to imprinting motherboards, integrated circuits, batteries, solar panels, wires, etc. Preferably these can be done in layers, so that the matter printed on the surface in 2D or 3D is connected to these devices.

The exampled book then becomes an extension of the network, internet, etc and further information can be gotten through it by queries, and information stored in it and through it as a conduit to networks, computers, internet, and other storage and computing means.

In a preferred embodiment grooves and other icons on or in the surface can be touched by the implement which completes a circuit and creates an action including for example lighting a display, actuating sounds, flashing lights, activating circuitry, etc.

In a preferred embodiment the mass of the implement may be sensed by a means including for example capacitance, magnetism, a laser emitted from it, etc and these can actuate the devices described. Grids of wires could sense the implement and also be touched creating circuits and signals.

In a preferred embodiment a substance on or in the media including for example ink, graphite, dye, can complete circuits in grooves, writes embedded in the media and actuate circuits, also record what was written, drawn, transferred to the media, etc.

In a preferred embodiment optic fibers and optic pipes can be embedded in the media so an implement including those configured with a laser, light, reflector, etc can send light down these conduits and actuate all the stimulus as described herein including for example activating circuits, starting displays, speakers, antennae, accessing networks, acting like writing by following where the tip of the implement is, etc. It may also be connected to for example Personal Digital Assistants, mobile phones, laptops, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### PASSWORD SUBSTITUTION

### ABSTRACT

A system of remembering passwords is disclosed.

### BACKGROUND OF THE INVENTION

The present invention relates to the field of encryption.

### SUMMARY OF THE INVENTION

Passwords can be secure on computers but they are hard to remember. People typically write them down and this can be a security risk as bad as using easy to remember passwords. It would be desirable to have a means to store hard to crack passwords safely.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to make a computing means more secure. One of the major problems with passwords is if they are hard to remember they are harder to crack. If they are hard to crack then usually people need to write them down and this leaves them vulnerable in many ways including by social engineering.

In a preferred embodiment this can be reduced by a password managing means including for example at least one program, hardware device, laptop, Personal Digital Assistant, wearable computer, mobile phone, computing means worn on a keychain, etc. The password management means can also include hardware devices in a ring, brush, brooch, bangle, chain, necklace, pen, mouse, trackball, joystick, display section including the casing, implant, eyeglasses, etc.

In a preferred embodiment an entity including for example the device, the user, a third party, a program, software, accessories, etc creates at least one hard to crack password, or it may be generated elsewhere and be entered into the password management means. Then at least one hard to guess password is stored in a repository, preferably in the device though if encrypted it can be safe enough to store elsewhere even written down.

In a preferred embodiment encrypting the hard to crack password may be done by a hash function including for example MD5, SHAL, etc.

In a preferred embodiment the password management means or a third party assigns at least one easier to remember password to correspond to this hard password. Preferably when it is time to use the hard to crack password the user inserts at least one easier password into the password management means.

In a preferred embodiment at least one hard to crack password is transferred to its destination including for example a wireless connection, an infra red connection, down at least one cable, laser, light, at least one user reading or hearing the hard to crack password and transferring it, etc.

The destination can include for example a computer to insert the password, a logon screen, a receiver to accept the password, etc. The connection is preferably secured by encryption including for example Kerberos, IPSec, DES, 3DES, PGP, asymmetric encryption, etc.

If the user inputs the password manually they read or hear it from the password management means. For example it can include a display, a speaker, a connector for an earphone or headphones, etc.

One advantage of the invention is that the user only has to remember the easier passwords, and ideally would not have to write them down. The password management means is secure when connecting because of encryption. Kerberos for example would preferably authenticate the password management means and allow access according to the credentials of the user.

In a preferred embodiment the password management means is secure as long as hackers cannot access it and try to guess the easier passwords. Preferably to make this more secure it could only accept passwords tries into it for example once a predetermined time period.

In a preferred embodiment the password management means may include other password management used in computing For example it may stipulate the easier passwords must have a predetermined level of complexity so they are not too easy to guess. Also it may require the easy passwords be changed after a predetermined period of time. It may also require that a predetermined number of different easy passwords must be used for a predetermined time interval before a particular password is reused. This prevents people having a favorite password and cycling though the others quickly to get back to being able to use it.

In a preferred embodiment the user would keep the password management means secure. Keeping it in places including for example on key chains, on pendants, chains, etc makes it harder for the hacker to get it, and in this way it cannot be hacked from the internet which is the most dangerous place.

In a preferred embodiment computing devices including fro example mobile phones, Personal Digital Assistants, laptops, etc may be used as a password management means. The user might have a service where they and/or the password management means can converse and otherwise communicate with, preferably in an encrypted manner with a repository that stores the password. When at least one easy password is inputted the hard password is received by means including for example displayed on a screen, heard, downloaded, received by SMS message, web page, HTTPS web page, email, S-Mime email, wireless connection, voice mail, computing reading the password, etc. or inputted from the computing means. In an encrypted phone line it may be secure for the phone service to repeat the hard password for the user.

In a preferred embodiment these devices may include for example additional security measures for example digital certificates, fingerprint analysis, retina identification, signature identification, voiceprint analysis, etc. They might preferably keep many passwords for the user for different situations.

Preferably the password management means can have rules including for example how often to change the hard to crack passwords, how difficult they should be to crack, how long they should be, who can access the password management means for which functions and passwords, random number generators to create passwords, alternate questions to ask or other options if the easy passwords are forgotten, etc.

In a preferred embodiment the user is authenticated when they access the password management means. If they forget their passwords they can preferably receive access to the device by authenticating themselves to the administrators. For example there could be other users who have privileges to reset the easier and/or hard passwords if forgotten. They could for example have their own means to access including a secure connection for example wireless, infra red, cables, writing passwords down, inputting their password into the device, etc.

In a preferred embodiment the user might also contact the manufacturers or their agents and ask for a special code to reset the device. For example they might have passwords which they can give out to reset the device, to access the current hard to crack passwords, etc. If these are different each time and the user of the device is authenticated then it is safe to do so.

One advantage of the invention is it narrows the danger from hackers to getting control of the password means. The passwords might additionally be disclosed in images hard for computers to read and/or in audio hard for computers to understand. People are usually good at controlling where their keys, jewelry, mobile phones, Personal Digital Assistants are, and it is difficult for hackers to control these long enough to work out the passwords.

In a preferred embodiment the password management means can show a hard password for any easy password tries attempted. The hacker would have to note them all and try them, and the main computing means could have security that quickly logs and shuts down substantial numbers of failed attempts. Trial and error on the device can then be further discouraged.

Preferably the password management means would have controllers including fro example a keyboard, mouse, trackball, wheel, buttons, keypad such as used to enter PIN numbers, joystick, touchpad, etc, or other ways to select numbers, menus, etc and to input easy passwords.

For example it might include the means to track the movements of eyes, fingers, hands, legs, the head, etc and convert movements into controller data.

In a preferred embodiment the password management means may include code that runs on a computer that also requires the hard to crack password. Preferably this would be well protected to be harder to hack. For example after a user pressed Control Alt Delete or with any other log on or password requirements a window or other access might run the password management means.

In a preferred embodiment data in a format including for example emails including the hard to crack password either encrypted or not, SMS like messages on mobile phones, a courier service, voicemail, etc could be stored with a computing means including for example laptops, Personal Digital Assistants, mobile phones, on the internet, etc. When the password is required it can be sent to the user. For example such a message service is quite common on mobile phones, called SMS. Encryption can be used to make this harder to intercept.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### FREQUENCY CHANGES IN A SIGNAL

### ABSTRACT

A system to modulate the frequency of light in a beam is disclosed. This can be used in a display instead of using red, green and blue light.

### BACKGROUND OF THE INVENTION

The present invention relates to the field of optics.

### SUMMARY OF THE INVENTION

In some situations color displays using 3 colors such as red, green, and blue are unsuitable. It would be desirable to be able to make a display show the real light frequencies of objects.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to modulate the frequency of light and other electromagnetic radiation.

In a preferred embodiment a spectrum producing means including for example a prism, a mirror, etc is affected by sound waves so that electromagnetic radiation including light coming in a first side has its spectrum coming out a second side at a changed angle. The principle of changing the angle of the exiting beam with sound waves is known in the relevant arts, this is used for example as an optic switch. A light beam can be directed to a plurality of destinations by changing sound waves being directed into a transparent medium.

In a preferred embodiment a prism for example is used. The beam enters the prism on a first side and exits as spectrum from the second side. As the light exits from the second side in a spectrum there is in a preferably fixed position at least one receiver including for example a light pipe, conduit, etc that receives predetermined frequencies from the spectrum and delivers them to a destination including for example a display, an optical circuit, optic fibers, optical transistors, optical switches, etc. The receiver may also move to change the frequency of the section of the beam it receives. For example in a first position it might receive part of the blue spectrum, and in a second position it might receive red light.

As the sound waves are applied to the example of the prism, the angle of the beam exiting the second side changes. This causes the frequency of the part of the beam entering the receiver to change. For example without the sound waves and other preferred stimulus the beam entering the receiver may include blue light. As the sound waves are applies the beam exits the second side of the prism at a changed angle and red light for example might enter the receiver. The receiver preferably only receives part of the spectrum so as the angle changes the frequency of the beam also changes.

In a preferred embodiment a light pipe will receive changing light frequencies according to the actions of the sound waves in the prism means. The receiver of part of the beam can direct this to a destination including for example a pixel on a display, an optical transistor, a means to sequentially cover a display screen in a predetermined pattern, a filter, an optic switch, an optic circuit, etc.

For example if at least one beam from the receiver is changing frequency according to a stimulus including for example a signal from a computing means, color frequencies from an image, inputs from an optical or electrical circuit, changed positions of switches, controller data, data from a memory or repository, data from an integrated circuit, signal from receptors including CCD's, etc this can be directed to create a display. The beam is preferably narrow in diameter so it would appear as pixel sized on a display. The beam is preferably moved across the surface of the display in a predetermined pattern to create a complete image.

In a preferred embodiment relating to adaptive camouflage, details of which are disclosed in my PCT's WO9910766, WO0131384, WO02054378, WO03025344, the beam can be used in ways to create a 2D or 3D display including one for example that acts as adaptive camouflage, a computer screen, a projector, a television, instrumentation lights, lights displaying controller data, etc.

In the example of adaptive camouflage this is more difficult to detect as camouflage, because substantially the same frequencies as real objects would emit are being mimicked by the invention. Preferably other frequencies can also be received and emitted to more closely recreate the correct emissions of objects to mimic for camouflage for example as absorption lines in the spectrum.

In a preferred embodiment to direct the predetermined frequencies of the beam to individual pixels the initial beam is modulated as disclosed with the prism means, so the preferred frequency goes into a collector. This beam then goes into another direction altering means which directs beam into preferred light conduits for many uses including for example pixels on a display, optical conduits, light pipes, optic fibers, optic circuits, routers, etc.

In a preferred embodiment the beam can be sequentially directed to preferred positions on a display by a system of rotating mirrors as disclosed in my PCT WO03025344. This can be used for example to distribute the beam with the preferred frequencies to an adaptive camouflage surface.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### PROTECTION FROM INFECTIOUS AGENTS

### ABSTRACT

Biological devices are employed to reduce infection, including from viruses. Also the principles can be applied to computing.

### BACKGROUND OF THE INVENTION

The present invention relates to the field of medicine and computing.

### SUMMARY OF THE INVENTION

Viruses and other infectious agents can create havoc in both biological systems and computers. It would be desirable to have a means to reduce their impact.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves using a means to combat virus infection.

In a preferred embodiment one of the reasons viruses are difficult to stop because they often mutate. This renders the defenses of the body and some drugs temporarily ineffective. The operation of the virus can sometimes however be used to disable it. For example viruses typically infect cells in the body. They go into the cell and use the genetic machinery of the cell to make more viruses. Once they are in the cell however they are ineffective unless they succeed in making more viruses.

By making the viruses enter some biological material it cannot replicate in, that virus has been rendered ineffective.

Viruses typically interact with specific chemicals and biological compounds on the cell wall. Instead of or in addition to stopping the virus from getting to a cell wall or entering it, this can be used as a defense to the virus.

For example with genetic engineering and other means in the relevant arts it is relatively easy to make variations of specific cells that lack certain aspects. In the case of AIDS which attacks T-Cells for example it would be relatively simple to make a fake T-Cell that lacked the ability to replicate a virus but had the same biological compounds on its surface.

The definition of fake here includes biological material that is wholly or partially not a normal functioning T-Cell. T-Cell is an example here because AIDS attacks them, any kind of biological material including any kind of cells that are attacked from any kind of infectious agent are included. For example this invention may be used with common cold viruses, Hepatitis, Herpes, etc. Additionally the principles are also applicable to computer systems and data.

A virus would then encounter this fake T-Cell and enter it as if it were a fully functioning T-Cell. Once inside there would preferably be no way for it to fully or partially replicate, and so that virus would be neutralized. Preferably the fake exampled T-Cell would be able to allow a plurality of viruses to enter it.

In a preferred embodiment the fake cell would be programmed to die or fragment after a predetermined amount of time. Also the cell need not actually be a cell or even be alive in a sense. For example the main requirement is there is enough of a real cell or a mimic of it so the virus can attach to it, and preferably enter it. A portion of biological material could be constructed that has this ability of the skin to interact with the virus, but the virus might not be able to detach from it. This would be akin to a kind of flypaper where the virus would stick to the fake call and be neutralized.

In a preferred embodiment the fake cell might have a means to be detected by the virus and a means for the virus to enter the cell, but a limited amount of additional functions. The virus would also be neutralized.

Of course AIDS and T Cells here are just examples, but refer to the concept of any kind of infectious agent including viruses known to the art, and any kind of host material where the infectious agent can interact with, and other actions including entering it.

In a preferred embodiment these fake cells would be able to be introduced into the human, animal, etc and circulate in the bloodstream. Because they can preferably be unable to perform functions unrelated to infectious agents they should not be a substantial danger to the body. Viruses for example should encounter these fake cells and be neutralized.

Of course viruses could also be infecting other normal cells at the same time and replicating successfully in this way. It may be necessary to introduce large numbers of the fake cells so that the chances of the viruses encountering the fake cell are increased. Also since the fake cell can preferably still receive viruses when normal infected cells are dying and cannot be further infected it has more chance of encountering other viruses.

In a preferred embodiment the invention also contemplates the principle in computers. For example there can be computer code known to be vulnerable to infectious agents including for example Trojans, worms, viruses, etc. This code can be preferably not attached to certain other code which might lead to a danger from the infectious agent.

For example an email client such as Outlook Express may receive email attachments. The attachment in this example is the infectious agent though of course there are many other embodiments of an infectious agent getting into a computer such as for example infected floppy disks, infected CD's, infected zip files, programs that have been altered with an infectious agent inserted into the code, downloaded infectious agents through file trading software, etc. The means to deal with these other methods of infection is also included in the invention.

The email client might contain, preferably in a quarantined area, code known to be vulnerable to the infectious agents, for example viruses and worms. This code is preferably connected to data which can be altered if the code is run by an infectious agent. Running of the code and changing the data can preferably be detected by many means including for example checksums on files, the date modified, etc. Preferably at least some of the code and data can also be set to be protected by Discretionary Access Control Lists and other means.

Because the code is vulnerable it is interacted with by the infectious agent which can do many things including for example neutralize the infectious agent if it runs only once, detect the operation of the infectious agent, etc.

In a preferred embodiment other infectious agents can also be tested in this way. They are placed in a position to interact with the vulnerable code and the results noted.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### REFLECTIVE COMPUTING

### ABSTRACT

In optical circuitry emitters can shine a beam onto a reflective surface to reach a plurality of receptors. Also computers can submit tasks to a forum as a form of distributed computing.

### BACKGROUND OF THE INVENTION

The present invention relates to the field of computers.

### SUMMARY OF THE INVENTION

Distributed computing directs data to other computers, but this is inefficient as there needs to be a central source and coordinator for the tasks. It would be desirable to allow computers to distribute tasks between themselves.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves optical circuits which may be used including by reflecting signals from at least one surface, instead of or as well as other optical paths and conduits known to the art.

In a preferred embodiment components in circuitry (optical and/or electrical) signal to each other, by a means including for example light pipes, wires, optic fibers, tubes, etc. Signals can also be reflected and/or refracted from at least one surface to their destination.

In a preferred embodiment of the invention parts including for example resistors, transistors, integrated circuits, motherboards, memory, storage hard drives, tape drives, wires etc may include an optical component which can emit and/or receive electromagnetic radiation including light. This example of light would normally travel a conduit from a first component to at least one second component but its mode of transport can include being reflected and/or refracted to at least one second component. In return a signal may be reflected and/or refracted back to the first component and/or to at least one third component.

In a preferred embodiment at least one reflector can be positioned so a plurality of computer components can send and receive signals in this manner, reducing the need for other optical conduits and paths.

In a preferred embodiment the components can send signals over a wider area and reflect these from at least one surface on to a plurality of other components so more than one can receive a signal.

In a preferred embodiment signals may include identifiers in digital and other formats so components can preferably identify which signals are for them. They may in turn send data including preferred identifiers to destinations including other components. Of course this is not restricted to optical, there are many other signals known to the art including for example radio waves, infra red, ultrasound, electrons, magnetic fields, electrostatic forces, etc.

In a preferred embodiment at least one reflective and/or refractive surface may include for example lenses, at least one concave and/or convex surface, parts tinted in preferred colors, filters, holographic elements, tubes, optic fibers, etc to do tasks including for example to modulate, absorb and/or reflect predetermined wavelengths to at least one destination and stop or modulate the strength of other predetermined wavelengths being reflected to at least one destination.

In a preferred embodiment tasks may be broken up with a first segment to be transmitted in a predetermined frequency so that this data can be restricted in its destination. Preferably other segments of the task may be directed to other components. Preferably parts of the reflective and/or refractive surfaces might have characteristics including for example certain colors, textures, albedo, filters, etc. Preferably at least one component may have at least one filter to allow a first frequency and deny a second frequency.

In a preferred embodiment at least one spectrum producing means including for example a prism can be used to cause a first frequency to go to a first destination and a second frequency to go to a second destination. Components might emit and/or receive a plurality of predetermined frequencies and so can select the preferred destination by emitting the correct signal.

Preferably facets can be positioned and orientated with any of these devices to direct beams to at least one component or another destination.

In a preferred embodiment the invention can be used to broadcast tasks to a plurality of sections of a circuit. For example task details are broadcast by reflection and/or refraction to preferred components. These may include for example parts of a circuit array, integrated circuits, transistors, light pipes, optical transistors, optic switches, CPU's, controllers, memory, data storage, RAM, flash memory, computers, etc.

Preferably components may signal their availability to do at least one task according to criteria including for example how busy they are, and other factors including for example their speed, ram, how far away they are, bus speed, clock speed, bandwidth, queues, congestion, etc.

Preferably components might reply by a means including for example wires, optical circuitry, at least one reflective and/or refractive means, preferably on at least one different predetermined frequency so there are few or no conflicts with other broadcasted signals.

In a preferred embodiment a collision avoidance algorithm can be used so a plurality of components can broadcast with the same frequency and avoid corrupting data. A good example is the one used in Ethernet. If two components broadcast at the same time then preferably each can wait a random time interval before rebroadcasting data. If there is another collision then they wait a longer random time before rebroadcasting and so on.

In a preferred embodiment at least one predetermined frequency may be broadcast from a first component to a second component. The second component may include at least one filter to receive signals from the first component.

In a preferred embodiment a first component might include at least one filter so it can receive only signals for it, and also it can have a means to broadcast at least one predetermined frequency including for example filtering the emitted beam, lasers, lights, electron beams, sound waves, etc. Of course components can also have conduits to each other including wires, light pipes, etc.

In a preferred embodiment to assist in signal transmission and reception a first component might receive and/or transmit signals and route these to and/or from a second component. The second component may have functions including for example processing the data and directing it to a destination including for example back to the first component, to at least one repository, to storage, to memory, to at least one integrated circuit, to at least one CPU, to a bus, to circuitry, to at least one light pipe, to a switch, to a transistor, etc.

In a preferred embodiment circuits including for example motherboards, circuit boards, CPU's, integrated circuits etc can be used with a plurality of components as disclosed herein.

In a preferred embodiment to decrease the time lag in transmission and/or reception at least one reflective and/or refractive surface can be closer to the components. At least one reflective and/or refractive surface might be located in positions relative to a plurality of components including for example under them, over them, to one side, in between, etc, in any topological shape. For example the components could be set in or on the surface of shapes including for example cubes, spheres, cylinders, a torus, etc transmitting and/or receiving into at least one cavity or recess, and also to at least one reflective and/or refractive means outside it.

In a preferred embodiment broadcasts can also be done over any connection means including for example wires, circuits, networks, nets, a mesh, wireless connections, the internet, etc. For example computers could communicate like this and do a kind of distributed computing. Here entity refers to at least one computing means and/or human in any numbers and ratio.

In a preferred embodiment a plurality of entities could interact to broadcast and distribute tasks. This might include where a first entity agrees to actions including bidding to do a first task, participating in an auction to do a task, tendering to do a task, a Dutch auction on doing a task, agreeing to do a first task in return for a benefit including for example payment, reducing a debt, bartering to do a first task in exchange for a second computing means doing a second task, etc.

In a preferred embodiment connections can be formed between the entities in ways including for example the internet, wireless, Bluetooth, a network, at least one subnet, cables, etc. They could communicate in a format including for example a forum, a chat room, a common folder, a common file, a common file repository, by email to each other, by a mailing list, by SMS messages, by voicemail, by web pages, by telephone line, by optic fiber, by ADSL, etc.

In a preferred embodiment a plurality of the entities can connect and interact in ways including for example to leave messages, explain tasks to be done, where tasks can be located, notifying a second entity of a task a third entity has, etc.

In a preferred embodiment this can include a forum or auctioning means, where entities interact. Tasks may also be distributed in all the ways disclosed herein between humans, so the invention can also include a means for human tasks to be more efficiently allocated.

In a preferred embodiment some tasks can be publicized including for example by broadcasting, advertising, bartering, word of mouth, human networking, canvassing, debating, etc.

In a preferred embodiment some tasks may be arranged by barter where entity A wants a task done, and entity B may offer to do it in exchange for something else being done, being paid, etc. Preferably there can be rings or other topographical shapes of users, for example Entity A gets Entity B to do something, Entity B gets Entity C to do something, and Entity C gets Entity A to do something.

In a preferred embodiment there will be a first amount of calculations to be done for example as in SETI at home. The offers and acceptances to perform these examples of calculations might be traded between entities, often automatically by algorithms and software.

Instead of or in addition to the current art of distributed computing, the network of entities is preferably more decentralized, and though tasks might initially be started from at least one source including as done in distributed computing, the entities involved can further subdivide these tasks amongst themselves. Because of the interactions the entities might find more efficient ways to distribute the tasks.

In a preferred embodiment at least one interactive environment for entities might include for example internet forums, newsgroups, documents which are updated by a plurality of entities, etc. The interactions can be in at least one format including for example language people can understand, computer code, data in protocols including for example TCP/IP, IPX/SPX, data files, etc. As tasks are completed and negotiated they can be interacted with in ways including for example archived, stored, deleted, altered, recorded by an accounting means, administered, stored in a database, etc.

In a preferred embodiment programs including for example like Gnutella, Kazaa, Napster, Bit Torrent, etc can distribute data and tasks between entities.

Of course these tasks need not be data including for example code, calculations, rendering, modeling, decrypting, data mining, monitoring, speech recognition, artificial intelligence, etc and all other computing tasks known to the art, though all of these are contemplated as part of the invention. They can also include all other tasks known in life including for example searching for information, links, bargains, selling things, renting, loaning, financing, relaying data, etc.

In a preferred embodiment hyperlinks may be included in tasks, as well as locations of files, data, etc. Criteria to determine accepting a task might include for example bandwidth available at certain locations and times, so tasks can be efficiently performed.

Preferably a means including for example tasks, transactions, business, etc described herein can be based on many criteria including for example algorithms, random selections, using chaos, strange attractors, probability, supply and demand, credit and repayments, etc.

The aspects of the invention including for example shapes, colors, examples, embodiments, reflectors, etc are not intended to limit the scope of any of these inventions in this US application. They are intended to include showing by example the principles of the inventions. The scope of the overall devices and the scope of all the individual parts, pieces, components, etc are best left to the claims for their definitions and other explanations.

In a preferred embodiment entities including for example at least one computing means, computers, programs, integrated circuits, CPU's, networks, web sites, etc preferably can broadcast to a preferred range of other entities. This can result in collisions where a first entity sends data which corrupts the data of a second entity. The invention might include for example an Ethernet like protocol where if more than one entity broadcasts at the same time as another entity and corrupts data they might each wait for a random amount of time before resending.

In a preferred embodiment a first entity might have a token and can broadcast to other preferred entities until it passes the token to another. These systems are well known in the relevant arts, including network designs.

In a preferred embodiment, systems including using at least one token giving at least one range of privileges might be used. For example the tokens might represent different things the entities can do. A first token might allow a first entity to broadcast its tasks without interruption for an interval. A second token might allow an entity to direct the broadcast to entities it selects. A third token might allow a second entity to answer the first entity.

In a preferred embodiment a system of interaction can be used including those used to update domain controllers in Microsoft Server 2003. For example equivalents to Update Sequence Numbers and replication can be maintained by entities to ensure they know which tasks have been allocated, which ones are available, which ones have been finished, etc. For example a first entity working on a first task might have to wait for a second entity to finish a second task before the first task can be completed. This might in turn depend on a third task which has not been allocated. To keep track of this UPN's and an equivalent numbering system can be used. This can also be used to have a plurality of nodes where entities connect to, and replication can occur between nodes so all can be up to date on the status of each task. This allows the interactions between entities to be further decentralized, rather than having to use on forum for example.

In a preferred embodiment there can be nodes that keep an updated record of the tasks, which can be accessed by the entities.

In a preferred embodiment negotiations can be modeled on protocols in computing such as in APIPA, DHCP, etc. For example in the analogy of Dynamic Host Configuration Protocol a first entity might need to have a task performed and broadcasts (Discovery in DHCP) it to other entities. A plurality of other entities might offer (Offer in DHCP) to do the task and may include their estimates of cost, their resources, how long it might take, etc. The first entity might then request a second entity does the task (Request in DHCP), and the second entity might accept (Acknowledge in DHCP) or decline for example if it can no longer do the task or has since accepted another task (NACK in DHCP).

There are many kinds of formats to bring order to broadcasts in computing which can also be used including for example those in NetBIOS, etc. These protocols are designed to work on a network where data collisions can occur, which can be solved by methods including collision avoidance in Ethernet. Using a forum based communication means for example the entities would post their tasks in a preferred format.

In a preferred embodiment the invention can include a marketplace like structure where entities trade kinds of tasks commercially. For example entities might include for example employers, customers, workers, contractors, tradesmen, unemployed, managers, all kinds of occupations known in the art, etc.

Each entity can preferably broadcast their requirements including for example what they want and how much they will pay for it. Bids on these tasks can occur as shown in any of the embodiments and examples herein. For example a customer might require someone to mow a lawn for a price or asks for offers, and this is broadcast to entities who have specified which offers they should receive. An employer might offer jobs. A tradesman might offer services. A bank might offer loans.

Preferably an entity can have a profile which includes their history, their configuration, their abilities, their location, guidelines on price, etc. As statistics on tasks replicate on the marketplace nodes for example an entity anywhere would be able to see how performance on a given task varies in different places.

The invention can be monitored to see how the tasks are being performed in the example of the marketplace, the computer, circuitry, software, forums, distributed computing, etc.

In a preferred embodiment an entity might have a history of attributes including for example success rates, success in line with estimates, computer power available, RAM available, bandwidth available, uptime, payment history, credit balance, changes in configuration, etc which can assist in determining which entity does which task.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### RELATIONAL DATA

### ABSTRACT

Data can be represented in an absolute or relative for a means including compression and controlling graphical data.

### BACKGROUND OF THE INVENTION

The present invention relates to the field of computing.

### SUMMARY OF THE INVENTION

Computer graphics have a difficult time displaying even relatively simple environments in games. This is despite the fact they are very efficient at computing many other forms of data. It would be desirable then to increase this efficiency.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves data including for example images, movies, sound, compressed information, computer graphics, etc ordered in a relative manner. Icons including for example letters, numbers, symbols, values of pixels in an image, punctuation marks, etc can be referred to as data objects and these are ordered in data including for example movies, images, text, code, syntax, grammar, etc.

The definition “relative” herein includes ordering data according to the invention. This can include data being described not in its absolute sense of what characteristics a second segment of data has, but how different its characteristics are from a first segment of data. Characteristics of a data segment might include for example numerical values, ASCII values, relative levels of red, green and blue in a pixel, ranges and other values in code, etc. A data segment can include any kind of data for example code, images, movies, text, etc.

In compression if some icons and icon clusters including for example words, letters, symbols, pixel values, etc are common enough then this can be used to compress the size of the data. For example predictions are sometimes made in video compression that vectors of data will continue in a given way so allows it to be more compressed.

According to this invention data is instead measured from a first data structure to be relative and it can be measured from a second data structure to be static.

In a preferred embodiment a movie can be seen as a succession of static frames. To show the movie one can simply show one frame after another. Compression can compare the frames with known compression algorithms including for example those based on Lempel Ziv and Huffman Encoding.

In a preferred embodiment a movie can be seen as a starting frame and where each succeeding frame is written as data in terms of its difference from the starting frame, the preceding frame, or whatever frames are desired to be compared with according to an algorithm.

In a preferred embodiment the only frame in an exampled movie that would be a clear image might be the first one. All the other frames might have their data written according to the difference between that frame and the first frame.

A good analogy is in backing up on computers. For example a user backs up all his files on January 1^{st}, like a snapshot of the hard drive at that time, and schedules a differential back up for each day. This snapshot can be an analogy to the first frame in a movie. With a differential backup only the data that has changed from the first backup is recorded. So if the user has changed certain files then only those are backed up. The differential backups are an analogy to the relative frames, which are stored as data according to their differences between that frame and the first frame. To restore all the data the first backup must be restored and all the changes after that are restored.

One advantage to this is if few files are changed then the differential backups will be small. If the changes eventually involve most of the files then the differential backups might become nearly as large as the original backup.

The principle is similar in relative compression. If there as a movie in which almost nothing changed from the first frame then each succeeding frame could be expressed in terms of the difference between it and the first frame. This could result in a high level of compression. If a lot of things constantly changed after the first frame then this technique would result in very little compression.

In a preferred embodiment if the original snapshot of the hard drive was taken, and then after a time the hard drive returned to exactly this state then the differential backup on that data might be zero. This is not a perfect analogy because the backup would still record the dates on files had been modified. If the backup did not record this then each time the hard drive files return to the same state as the initial snapshot the differential backup would be of zero size.

In a preferred embodiment the user might decide to back up in full every Sunday and every day thereafter has a differential backup. So each differential backup during the week might be growing larger and larger if lots of changes were made. If few changes were made the differential backups would not grow as much.

In the analogy of a movie, each seventh frame might be preserved as a static frame snapshot of the scenery in the movie, and the next 6 frames saved according to the differences between those frames and each seventh static frame.

The user might instead decide to do a full backup according to any time interval, every 14 days, 1 month, etc, 7 days is an example. He might also decide that when things were busy he would make full backups more often and then when things were quieter he would make full backups less often.

In the movie analogy this would be equivalent to making the intervals between the static frames longer or shorter depending on the amount of changes in the movie. The differences in the frames would be equivalent to differential backups. The static frames are like full backups or snapshots of the hard drive at the time. Instead of being a snapshot of a hard drive the static frame is a snapshot of the movie at that moment in time.

The user could also structure his backups so each was a differential backup of the day before. For example he makes a full backup on January 1^{st}, and on the second makes a differential backup. Then on the third he makes a backup of the differences between the hard drive data on the second and the third day. The next backup might have the differences between the third and the fourth day, and so on.

One could write text the same way. Each word could be written as the differences required to make it the same as the word before. For example the sequence of words bat, bar, car could be written as bat, 00-2, +100. Here 00-2 means take the same two letters as the preceding word and take two off the next letter and two from “t” makes it “r”. The next word +100 would mean add one to the first letter “b” of bar and leave the other two letters the same.

According to a preferred embodiment the invention would make it harder to read the data objects, including for example words, frames, etc without referring back to the original frame, word, etc. To avoid referring back too far for example every Nth frame or word might be static, in that every Nth frame, word, etc is written as it appears, and these may be additionally compressed. Then the data objects between them would be written relatively as described.

In a preferred embodiment the absolute way of writing words in text is good for looking at particular words but poor for showing how the words change, though this pattern is usually unimportant in text. In other data including for example movies, computer graphics, etc this change might be more important.

In a preferred embodiment this is data including for example a movie of a rotating ball, in normal static frames of this. For example it could be in DIVX, MPEG, etc.

Because the changes of the ball would be hard to predict the motions would be harder to compress in standard compression for example Lempel Ziv, Huffman Encoding, etc. If we represented each frame relatively though we would see a recurring pattern and this could potentially be compressed more easily.

In a preferred embodiment for moving objects it may be useful to represent them according to the invention. Certain kinds of data might be better compressed with current techniques including Lempel Ziv and other kinds of data better compressed with relational compression as disclosed herein. By combining these two techniques a novel and inventive form of compression and data representation is attained.

In a preferred embodiment it is hard for computers to draw graphics quickly in games when there is a lot of motion on the screen. For example avatars, defined as the moving characters and shapes, in a game, program, etc are often drawn with facets or polygons which are drawn quickly to simulate movement. Instead of or in addition to this relative rendering would include for example drawing each movement of the avatar as a difference to the frame before. Since the avatar's movements would return to the first position selected the movements can be represented as a series of rings.

For example if the avatar was spinning around this could be represented as relative data like the spinning ball was.

Preferably a rendering means including for example a video card for example could operate frame by frame by changing the pixel values from the previous one. It might do this by a means including for example a buffering, memory, computer processing, etc.

In a preferred embodiment including of drawing computer graphics controllers would alter with the invention what is on a display. For example the ball referred to earlier was spinning, and its movement could also include moving around the screen. Looking at the relative data we couldn't see a ball in a given frame but we could see changes in frames, and if the ball was moving in a uniform pattern with a uniform spin we could find this pattern.

In a preferred embodiment once this pattern was understood we could change it in ways including for example speed the ball's movement up, flatten its trajectory, increase its spin, etc by altering the regular patterns. Since these patterns in this example are regular they should be compressible so they become in effect a reduced size set of instructions to dynamically represent the ball's movement. Of course being able to compress the data is not essential to the invention. It can also include for example creating a means for controllers to alter graphical representations of data, for example manipulating the rotating ball.

In a preferred embodiment we could add to this body of knowledge by changing the ball's characteristics including its shape, size, trajectory, bounciness, light coming from a given direction, reflectivity, color, etc. If we after each change maintained a periodic pattern we would see these changes in the dynamic data and eventually create algorithms to dynamically represent any motion of the ball we wanted.

In a preferred embodiment we can add shapes, backgrounds, and by increasing our list of algorithms we can in principle be able to describe any motion of any shape. From this knowledge we can construct a graphics program and in principle duplicate any graphical movement in movies, games, etc.

In a preferred embodiment sounds can be analyzed, such as in speech recognition. Voices are listened to and relatively represented, with patterns found. Similar patterns might occur in differing characteristics including volume, pitch, speed, etc. The more detail and inflection in the speech the more patterns the dynamic analysis finds. By comparing similar patterns differing ways of saying the same words could be more apparent.

Relative analysis of movies could in this way recognize jittering in the movie that is jerkiness in the way the camera is being held and filter this out. In music this is similar to relative pitch, the way some people hear music as the intervals between notes rather than the absolute values of each.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### RELAYING DATA BETWEEN COMPUTERS

### ABSTRACT

Computers including mobile phones can use each other as relays.

### BACKGROUND OF THE INVENTION

The present invention relates to the field of computers and telecommunications.

### SUMMARY OF THE INVENTION

Mobile phones and other wireless devices often have difficulties in communicating. It would be desirable to improve their reception.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to use icons in a network to transfer data to other icons. Preferably these icons include for example mobile phones, Personal Digital Assistants, radios, laptops, computers, and all variations of these known to the art.

Preferably the communications include for example wireless, radio, infra red, electromagnetic signals, lasers, light, sound, ultrasound, wires, etc.

In a preferred embodiment icons in at least one network can use other icons to send information to and/or receive information from a controller. For example icons could send information, preferably encrypted, to relayers including for example computers, hardware, routers, base stations, antennae, mobile phones, etc to other icons until the data reaches the controller.

The icons can also receive information from other icons by relaying. Sending to and/or receiving from other icons can of course include other available devices for example Personal Digital Assistants, mobile phones, laptops, etc.

Controllers herein are defined as including for example the hardware, software, administrators, managers, protocols, system, etc that manage the communications and other aspects of the invention.

In a preferred embodiment this enables signals between icons to often not need base stations, because icons can use other icons to send information along. Preferably this is enabled by ways creating sectors including for example zones, segments, boundaries, subnets, areas, realms, etc. Controllers of the icons including for example base stations, antennae, administrators, computers, software, etc may create predetermined sectors in which the devices can communicate with each other more readily.

A useful analogy is a subnet in a network where the icons in the range of this subnet may receive a network mask that indicates which subnet they are in. The icons in a subnet can communicate with each other with less congestion because the traffic is preferably restricted to only icons in that network unless there is a specific need to access outside it, and/or for the outside to access the subnet. To communicate with other subnets a router is normally used.

Preferably in the sectors the icons can emit to and/or receive from each other. To emit to and/or receive from outside the sector preferably can also be done. A good analogy is local calls in a phone network which can be made easily, but outside that sector the call contacts a means in charge of another sector. A similar analogy is a subnet in networking communicates with another subnet through a router.

In a preferred embodiment icons in a first sector might communicate more freely with each other and when they are directed to communicate with a second sector this connection might preferably be made from the controllers of the first sector to the controllers of the second sector to relay the communication.

In a preferred embodiment the icons might have their sectors substantially similar to a format including for example subnets in IP4 and IP6, protocols including Netware, wireless protocols, domains, subdomains, network forests, Realms in UNIX, zones in DNS, scopes in DHCP, area codes for long distance calling in telecommunications, etc. There are many available protocols for such communications known in the art which could be readily adapted for the invention.

In a preferred embodiment a plurality of icons might have a unique identifier including for example like the unique identifier of a network card, a SIM card in a mobile phone, a phone number, identifiers in the hardware of a mobile phone, CPU's with identifiers in them, etc.

In a preferred embodiment the identifier can be assigned by the user and/or the sector's controller. For example a DHCP server in a network assigns IP addresses to icons. A serving means could assign identifiers to the icons dynamically and/or they could get the same identifier for a predetermined time interval. For example an icon might receive an identifier on joining the sector. It could receive this for a predetermined amount of time in ways substantially similar to leases with DHCP.

Preferably there is at least one sector identifier including for example a subnet or equivalent so the icons can determine which are in the same or a different sector.

In a preferred embodiment each icon has at least one unique identifier so there is little or no chance that two devices have the same identifier. If two icons for example share the same identifier then other icons might not be able to determine which one they were communicating with. In networking this is readily solved by having each network card have a unique identifier. Preferably also the sector identifier should be allocated so no two sectors have the same one, to avoid similar conflicts.

Icons might require a collision avoidance algorithm including for example the ones used in versions of Ethernet. This might allow for example a plurality of icons to use the same frequency in the example of wireless communication. Preferably a sector has a frequency it can use separately from other nearby sectors.

In a preferred embodiment the invention also contemplates a means to assign friendly names to the icons. Friendly names are ones usually composed of words that are easier to remember for humans. Preferably there is at least one serving means to keep records of these names and associate them with the identifiers of the icons. A sector might also have a friendly name which is recorded.

In a preferred embodiment the identifiers of the sectors including for example the friendly names and other identifiers can be recorded in at least one serving means. For example when an icon in a first sector is directed to contact an icon in a second sector it can follow a number of steps including for example contacting the controllers and serving means of its own sector. They preferably locate where the second sector is in a directory, or can pass the request on to another agent. The serving means can include for example DHCP servers, WIN servers, DNS servers, global catalogs, domain controllers, etc.

In a preferred embodiment the invention can be operated and maintained by the controllers of the sector including for example the administrators, but it additionally can work in a system like APIPA where a first icon picks an identifier (preferably randomly or according to an algorithm)and broadcasts it to see if other icons are using that identifier. If no other icon responds that it is using that identifier the icon retains it for itself. In this way the devices can select their own identifiers and communicate without identity conflicts.

For example when icons cannot contact a controller of a sector they could broadcast their identifiers to each other to create their own temporary sector to communicate. If at least one icon can contact the controller of the sector then data can be relayed through other icons to the controller. This enables icons in poor reception areas to communicate.

In a preferred embodiment the icons may use other devices as relays for data. For example if a first icon needs to send data to a distant location it may send data preferably in packets and encrypted to a second icon nearby, and this passes the data long to a third icon, etc. Icons might additionally pass data between themselves according to their position by examining GPS data and antennae positions in the network.

In a preferred embodiment data including for example files, music, movies, text, creating and maintaining forums and chat rooms, songs, etc could also be shared in this way. Trading and transfer systems including for example like Gnutella, Napster, ITunes, Kazaa, Lime Wire, etc can be used to share data between icons.

For example a user searching for data might send requests which are passed on to other icons in the sector, and if necessary to the controllers so it can be passed on to other sectors or any other destination.

In a preferred embodiment icons can use distributed computing and equivalents to accomplish tasks by sending out tasks to other icons. Some icons that do tasks for other icons might accumulate credits, payments, etc so they can in turn have other icons do their tasks later, and/or they may be compensated in other ways. Tasks can include for example icons doing calculations, rendering, storing data, relaying data, assisting in searches, participating in games, indexing, etc.

For example there could be fees for icons for various services from the controllers according to how they use a sector, and those that undergo activities including for example being more passive and relay data, do computations for others, act as data repositories, allow their cameras to be used, etc may earn credits for a given amount of free usage or other payments later. Icons can be positioned to support the network so as to use or sell their credits later. For example icons might act as relayers to accumulate credits.

In a preferred embodiment information can be sent between icons and/or the controllers to calculate the overall usage, usage of various services, usage by various icons, etc. It may be for example that much of the activity is not billed by the network as the icons can act relatively independently to do these tasks. The icons and/or controllers of a sector might also relay to other data structures including for example landlines, other wireless protocols and networks, infra red, computers, RFID's, wired networks, phone lines, internet, etc.

In a preferred embodiment activities including for example caching, storing, compressing, etc of data likely to be requested can be undertaken by icons, and icons can preferably receive credits and/or payment for this. For example in file sharing some icons might cache or otherwise store requested data, files, songs, games, movies, etc so they are available for other icons.

Preferably an icon might not be aware of the nature of this data as it can be encrypted or unavailable to be personally from that icon. For example at least one data repository in an icon might not be available for that icon to access only the controllers of the sector and/or other icons.

In a preferred embodiment data including for example sounds, video, temperature data, air pressure, usage, congestion, bandwidth, strength of signals, humidity, etc can be distributed if desired to other icons. It could also be collected by at least one serving means to analyze the data for reasons including weather prediction, sector maintenance and repair, metering usage, etc.

Of course the accumulation of this data and indeed any of the characteristics disclosed herein of all objects can be used in any context and application, not just the ones disclosed here. For example with the current mobile phone and computer networks it would be possible to map temperature, humidity, air pressure, etc with sensors in phones and create a map of these statistics.

In a preferred embodiment users of icons might desire views in locations including for example shops, parks, beaches, rivers, boats, cars, buses, trains, etc any location known to the art, and so could receive data including for example images and sounds available of these in real time or cached.

In a preferred embodiment images could be merged and/or morphed together to create a larger view including for example panoramas, mosaics, artificial viewpoints, etc by transforming images by a means including geometrically, with a computing means, etc. Preferably 3D images and movies could be synthesized from this data.

Preferably data and other characteristics can be voted on by users and icons whether it should be kept or discarded.

In a preferred embodiment icons may include features, for example enabling users to poll others on certain topics, send messages, images, movies, etc to each other.

In a preferred embodiment a first segment of a sector may be encrypted or otherwise restricted in some ways including for example movies, songs, text, web cam images, conversations, forums, chat rooms, etc so a second segment of a sector cannot access these aspects.

Preferably a first icon might communicate with at least one other selected icon for tasks including for example file sharing, chat rooms, forums, distributed computing, etc. Other icons may not be allowed to know and/or monitor this. They may be permitted access to other services from those icons however.

In a preferred embodiment users and/or icons might belong to a dominion similar in concept to for example groups, organizational units, Realms, domains, regions, scopes, etc that could be analogous to those used in Microsoft and other company network systems. For example a first dominion might include users and/or icons that have elevated privileges to manipulate data and fix bottlenecks of data. A second dominion might include users and/or icons that have privileges to back up data, a third dominion might have privileges to contact and pinpoint particular users and group members, etc for as many dominions as required.

In a preferred embodiment there might be access for the users and/or icons to data transformers including for example printers, scanners, modems, routers, faxes, etc managed by predetermined dominions.

In a preferred embodiment users and/or icons might acquire privileges for tasks including for example to reduce traffic. speeding data transfers, working on changing positions and sizes of caches, removing troublesome users from the network for certain amounts of time, etc.

In a preferred embodiment there can be accessories for the icons including for example levers, cogs, drills, legs, arms, grasping tools, additional cameras in predetermined configurations, motors, cutters, sanders, vehicles, rollers, welders, blenders, juicers, toasters, refrigerators, microwave and other kinds of ovens, etc.

In a preferred embodiment accessories and connectors can enable the icons to do many tasks including for example battling each other like robots, cutting up foods and other materials, knitting, sewing, directing vehicles by steering braking and accelerating, clean houses and other places with sweeping mowing wiping polishing vacuuming painting washing, activate washing machines refrigerators ovens driers mowers, control flying devices, diagnose mechanical and electrical problems, control televisions DVD's video recorders TIVO's, scanners, emitting laser beams, opening and closing locks and doors, and so on, to control all machines known in the relevant arts.

In a preferred embodiment icons can emit and/or receive sounds and other radiation, and from the reflections determine the shape and dimensions of objects and enclosures. Preferably this would include directing the emitted radiation to substantially cover the areas being measured.

Preferably communications including for example controller data, code, commands, etc can be sent to the icons, and at least one specialized connecting means translates these into the appropriate data structure including for example protocols, code, instructions, etc to control these devices.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### RETINA DISPLAYS

### ABSTRACT

Displays can be connected directly to the retina to create a more complete virtual reality experience.

### BACKGROUND OF THE INVENTION

The present invention relates to the field of optics.

### SUMMARY OF THE INVENTION

3D glasses provide a limited and often unrealistic virtual reality experience. It would be desirable to make this more realistic.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a display means that can be affixed onto part of the eye. Included in these areas are for example on or in the eye lens, on the inside of the eyelid, on the retina and other parts of the eye that can shine an image on the rods and cones, direct an image directly to the nerves, etc.

In a preferred embodiment the display is affixed onto and/or into the retina so the images can be seen. The display can also be transparent according to a stimulus, so the user can see other objects naturally through the display.

In a preferred embodiment one side of the display can have receptors that take an image that would normally fall onto the retina and translate it into an image the display shows.

One advantage of this invention is that virtual reality images can be shown, perhaps with the equivalent of those seen in the Matrix. Since the display goes directly into the retina, and other places as discussed earlier the imaging would be very realistic.

While some preferred embodiments of this may not be possible in principle such a display is already possible to help blind people, and could be implanted in animal eyes, simulated eye models, and so the actual invention can be built today in preferred embodiments of the principle.

In a preferred embodiment the display can be placed off center in the field of vision, for example below or inside the line of sight. In this way information could be seen out of the corner of the eye. The display also need not be very detailed, it can in any of these examples simply be callable of rendering text, warning lights, though ideally a display capable of showing graphics would be preferred.

It could be in one or both eyes. It could also be able to receive signals from electromagnetic radiation including microwaves, radio waves, infra red and display the data from them. Wires and other communicators could also connect to the display/receptor means to a computing means inside the body, connecting to the skin, to an antennae which transmits and/or receives as desired, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended,to be within the scope of the invention. Such variations are not to be regarded as a departure from the spirit and scope of the invention.

### DISPLAYS USING MOVABLE PIXELS

### ABSTRACT

Pixels can be designed to change their orientation and to create a three dimensional image.

### BACKGROUND OF THE INVENTION

The present invention relates to the field of optics and stereoscopy.

### SUMMARY OF THE INVENTION

Three dimensional displays suffer from many drawbacks. It would be desirable to adjust each pixel to create a better image of the user.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to create 3D and other optic effects. In the art it is known that balls and other shapes (hereafter called imaging shapes) can be created in a display. They can rotate according to various forces and present a differently colored side and by this display an image.

In a preferred embodiment of the invention these imaging shapes, for example balls can be made to reflect light coming from the front or behind them. By creating different shapes the light can be directed to preferred directions to create 3D and other optical effects.

For example the imaging shapes can contain tubes in them of preferred shapes, and the light can come from behind and be directed at a preferred angle, or straight ahead.

They could also have mirror shapes on them so light coming from the front, for example from a projector could be reflected to create 3D images and other optical effects.

Other examples of the imaging shapes can include for prisms, lenses, parabolic mirrors, tinted filters, creating signs that point to preferred directions, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### SEARCH ENGINE

### ABSTRACT

A system is disclosed to make search engine enquiries reflect more of the choices of the user.

### BACKGROUND OF THE INVENTION

The present invention relates to the field of search engines.

### SUMMARY OF THE INVENTION

Results from search engines suffer from many drawbacks. They often return results that do not strictly reflect the desires of users, and often contain results paid for by advertising. It would be desirable to know which selections a user made from a search engine.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a search system that monitors the choices of the user. In a previous PCT application WO03025344 I disclosed a search engine based on aspects including determining which results a user selected.

In a preferred embodiment the displayed search page, preferably in for example a web browser, HTML viewer, Word, a file manager, etc substantially includes code, for example HTML, XML, Java, ASP, ASPX, other programming languages, etc. The “system” is herein defined as a search engine including for example a means to return answers to a user's enquiries, a means to determine the user's selections, a means to deliver search results, a means to determine which results would best suit the user's enquiry, etc.

The response to the user's search preferably includes a plurality of search results he would select from. Typically the user selects a result from the list and this leads him to the result he selected. This could be a file including for example an image, a web site, a HTM file, a PDF file, an MP3 file, etc. This can be seen for example in Google, Yahoo, etc.

In a preferred embodiment the results of the user's enquiry contain hyperlinks. Usually the results are listed in numerical order with the first result at the top of the list. There are many search engines and any format used in the art to display results can be included.

Instead of or in addition to the links pointing directly to the locations of the search results at least one link points to destinations including for example the system, a proxy, an agent for the system, a computing means the system can obtain information from, a proxy server, a folder on the system, a file on the system, code on the system, etc. This means that when the user clicks on that link his selection goes directly or indirectly to the search system. The search system then knows what the user selected. The locations of the search results would normally be for example the web site, files, etc the user is looking to go to.

In a preferred embodiment the search engine might return for example 10 results, each with a hyperlink. Normally these links would point directly to the user selections. For example:
Result 1 might be www.microsoft.com/file.pdf
Result 2 might be www.nytimes.com/image.jpg
Result 3 might be www.yahoo.com/sounds.mp3

And so on. Of course these are example search results and are not intended to limit the scope of the invention. The user could have virtually any web site or files on the internet or a network in his search results. In this example there are PDF files, JPG images, and MP3 sound files but there can of course also be HTML files, HTM files, ASP files, typical web pages, etc.

The problem is if the user clicks on these links the search system will not know which one they selected and so cannot accurately know which links are the most popular.

In a preferred embodiment the hyperlinks and other links point to an agent the search system can gain information from, so the search system then knows which link the user selected. Then by a means the user is directed to the link result he selected.

In a preferred embodiment the links point to the search system, which as an example herein is called www.exampleonly.com. The destination of these links would preferably be parts of the search engine system including for example proxies, files, images, other links, a database, etc.

For example the first result might on a Microsoft site. Instead of or in addition to the link pointing to Microsoft it would point to www.example.com, and/or a proxy or agent for them.

The link might include these characteristics:
www.exampleonly.com/identifier of search/date/time/username/search terms/other information.

The identifier of the search might mean the search system has kept an identifier so that if a user links to them with that identifier the system knows which search they did. For example when the search was made the search system might assign a number, e.g. 43432355432 to the search. It also might put this number in the link so when the user clicked on the link the search system knew which search it was from. For example:
www.exampleonly.com/43432355432

The link might additionally contain an identifier of that search result. For example the search system might simply give an identifier of “1” meaning this link is from the first search result:
www.exampleonly.com/43432355432/1

It might have an identifier for that search result, for example 789080 giving:
www.exampleonly.com/43432355432/789080

The search system might not need an identifier for the overall search, only for a search result and so:
www.exampleonly.com/89080
   might be sufficient. Of course the identifier can be of any type, symbols, letters, etc. For example d1r2r2ee, etc.
www.exampleonly.com/d1r2r2ee

The hyperlink might include the date, the time, the user's name, etc. It might include the search terms the user enquired about.

In a preferred embodiment the information can go to the search system by any means. For example data might be sent to the search system when the user clicks on a link by using code including for example Active X, Java, XML, spyware, code, etc.

The format of hyperlinks herein are just examples. One might for example use a predetermined syntax including for example locations, identifiers, dates, user details, etc in the link including for example dashes, forward slashes, question marks, equal signs, with any kind of symbol used in hyperlinks. As long as the search system knows how the links are constructed and what the data in them means, then they can be in any format. Preferably they can be in a format so the user does not realise information is being sent to the search system though this is not necessary.

As each search is made the system would preferably create an identifier for this search, and for each of the search results. In this example there would be ten identifiers from a search with ten results, and perhaps an eleventh identifier of the overall search. This can be kept by the search system to compare with links the user clicks on. They can also be kept for example to record statistics of which links were selected, most popular, how long the user took to decide, whether the user saves the link and uses it again, etc.

In a preferred embodiment when the user clicks on the link the system would know which result he had selected because it and/or its proxy, agent, etc would be contacted by the link. It would know from the information in the link which search enquiry it came from and which search result it indicates the user selected. If it now sends back information to the user that directs him to his search request the user gets his request and the system knows what he selected.

In a preferred embodiment it can return a web page or other data to the user saying they are being redirected to the web site, and if it doesn't work to click on a link. This is well known in web design where a user moves his web site and has a redirection to the new site. The system can redirect the user to his search result selection.

In a preferred embodiment the search system can return a web page to the user preferably showing more information about the link and asking him to click on a link which would direct him to the web site. The user might change his mind but the system knows the user did intend to go to that site. If the user clicks on the link he gets to the search result he wanted.

In a preferred embodiment hyperlinks in the search result might include details about the link destination. For example with the first search result the link might contain details of the web address of the Microsoft site, and the web address of the search system. The link leads to the search system which then redirects it like a proxy server to the Microsoft address. If the enquirer selects this link then it goes to the desired object including at least one file, site, server, program, web page, etc.

For example the first search result might be in a format including for example:
www.exampleonly.com/www.microsoft.com/file.pdf
   or
www.exampleonly.com/microsoft.com/file.pdf

If it was a HTM file the user was being directed to it might look like for example:
www.exampleonly.com/www.microsoft.com/file.htm

The advantage to this is now the search system knows which link the enquirer selected and so can compile statistics knowing exactly which links are selected.

In a preferred embodiment the enquirer sends to the search system the preferred result and the search system send back code via at least one programming language including for example java,.NET, C, C++, visual basic, ActiveX, a separate message including an open window, web page, etc assisting in the opening of the desired link.

In a preferred embodiment user might try more than one link in the search results. The system might preferably note the last result tried by the user is probably the best one. It may be desirable in this process for pages to open in a new window so the enquirer can more easily go back to the original page.

If the user regularly uses a link that goes through the exampled proxy, or other embodiments of the invention then the search system can determine from this additional information about how popular this link is, and determine statistics for purposes including advertising.

In a preferred embodiment cookies can be used in the enquirer's computer for additional information. The URL to go through a proxy may contain additional information including for example
http://www. (address of proxy server) (address of desired web site) (user name or identifier) (date and time of search) (reference to the search results sent to the enquirer, as an identifier) (other information)

In a preferred embodiment the server may at times suppress the full length of this URL so it appears different when it goes through the proxy server for example. It may for example just show the address of the desired web site, files, etc.

In a preferred embodiment people may advertise in the search engine pages, as is well known in the art. This includes all other internet advertising, as well as all other kinds of advertising. The businesses may be web based, or any other kind.

Preferably the people and companies advertising may direct their sales through outlets that are monitored by the search system administrators.

For example there could be many companies advertising on the search engine, and in the other avenues described herein. Sales that are made can be directed to checkouts that can be set up in many ways including for example centralised companies and web sites that handle the transaction and payments including by credit cards, smaller transaction means including those on their own web sites, and other systems for collecting payment.

In a preferred embodiment the search system may monitor these sales from their advertising and collect amounts of this by various systems including for example a percentage of the sales, a sliding scale where their percentage changes, a flat fee per sale, credits for future advertising according to the sales made, and any other kind of merchant arrangement known in the relevant arts.

The administrators of the system preferably need not be associated with a search engine or any particular business model. In a preferred embodiment they could manage other means including for example web sites, directories, internet shopping malls, shops on the internet, discount vouchers, coupons, banners, pop up advertising, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### SHOE INSERT

### ABSTRACT

An insert can be made for shoes. This can be washable and clipped back into place.

### BACKGROUND OF THE INVENTION

The present invention relates to the field of shoe manufacture.

### SUMMARY OF THE INVENTION

Shoes often become smelly, and if they are washed this damages the shoe. It would be desirable to have an insert into the shoe which can be washed and then replaced.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a sleeve which goes in a shoe. The sleeve can be in any shape including for example a shoe itself, a sock, etc. Preferably this sleeve can be removed from the shoe and be washable. The removing of the sleeve can include for example unclipping, unbuttoning, unzipping, opening Velcro, unscrewing, unbolting, unlacing, etc.

Preferably the sleeve has connectors so it can securely affixed inside the shoe including for example with rivets, buttons, zips, etc.

In a preferred embodiment the sleeve can also be described as being like the inside lining of a shoe, except it can be removed. Ideally this arrangement allows the insides to be cleaned and remove odor.

Preferably this can include exterior panels to be affixed outside the sleeve so different looking shoes can easily be assembled.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### 3D SOUND HELMET

### ABSTRACT

Sounds can be played on differing parts of the body and skull. This can be perceived as a more detailed sound experience.

### BACKGROUND OF THE INVENTION

The present invention relates to the field of acoustics.

### SUMMARY OF THE INVENTION

Headphones have a drawback in that sound only reaches the ears directly. However when we listen to sounds they impact on all parts of the body. It would be desirable to mimic more closely the real experience.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves an array of sound speakers that are placed in ways including for example connected, attached, adjoined, etc substantially near and/or on the skull, torso, legs, arms, etc. Sounds played through these speakers can give special audio effects including for example a 3D sound experience for the listener, sounds to assist blind people, sounds to give feedback, etc. These sounds can change as the user moves around, heightening the 3D sound.

In a preferred embodiment sounds can be used as a form of feedback. For example as different sounds fall on different parts of the body they can be felt as vibrations and sounds. By feeling the pattern of these sounds a person could infer information. This could be used with blind people for example to feel data such as converting light into sound so they can know more about their environment.

In a preferred embodiment speakers can be placed in preferred locations including for example the skull, the forehead, the temples, behind and in front of the ears, the back of the head, the neck, etc. This can have many effects including for example simulating the sound waves falling onto the head and body, and how the acoustics then reach the eardrums.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### USER PROFILES

### ABSTRACT

A computer system for storing a person's data is disclosed. For example, when they wish to converse with a speech recognition means their profile can be uploaded to make the program more accurate.

### BACKGROUND OF THE INVENTION

The present invention relates to the field of computers.

### SUMMARY OF THE INVENTION

Speech recognition is often inaccurate. This is sometimes because the programs are not familiar with the user. It would be useful then to have the speech recognition means be able to get more information about users it tries to understand.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves profiles of a user's information stored in a repository, to be on call as necessary. This can include information for example that assists computers to better interact with them, including for example speech recognition, face and body recognition, biometric information, speech habits, accents, preferred slang, typical voice tone, other idiosyncrasies and habits, artificial intelligence programs, etc.

In a preferred embodiment, computers still find it difficult to understand people's speech. The user may go through a process where various speech and other recognition programs try to work out his style of speech and other mannerisms and then store this information as part of his profile. When he wishes to for example speak to a speech recognition means it could access a repository of his speech patterns and habits by a means including for example the internet, by phone, by modem, by email, by accessing a file server, etc, and so work out more easily what he is saying and doing. It may preferably store more feedback about the user so the repository grows with more information for the next computer, program, people, etc who need to access it.

In a preferred embodiment the profile can include stress patterns in the user's voice so the recognition means can tell how the user is feeling. It may be able to detect inebriation, tiredness, being upset, happy, satisfied, talking more quickly or slowly than normal, or in a different tone or pitch. All of these can be entered into the profile so the recognition means can have a preferably extensive database of the user's speech wherever he goes.

Of course this is not meant to be limited to speech but can refer also to any characteristics of a person or group of any kind. Facial features as another preferred embodiment may be collected so the user can be more easily recognized with different fashions, hair styles, eyeglasses, beards, moustaches, etc. The user's writing style may be also profiled so he can write more easily and the recognition means can understand his writing.

In a preferred embodiment facial expressions can also be profiled so that these can be more easily recognized. The profile may be a link to a repository, database, etc. It may be stored in many ways including for example a file, smart card, any kind of data card, media, CD, DVD, flash memory, etc. It may be sent as an attachment to email, messaging, as a file on the user's or another's web page, etc. It may preferably be encrypted so as not to be accessed without permission. The user in a preferred embodiment might log on securely with the recognition means in ways including for example person, online, by phone, network, any communication means, etc and the recognition means reads the file and if desired updates it.

Preferably the recognition means may update the profiles with statistics on errors made, so the user may work on improving that part of his speech, actions, etc. Also the recognition means may indicate other programs may need to be more careful in these areas.

In a preferred embodiment also included in this profile can be avatars, both static and dynamic. These can be images, movies, small programs that respond to certain questions, stimuli, etc. In an embodiment there may be a plurality of movies that can be played according to various inputs, for example certain questions and statements. Additionally there can be artificial intelligence programs that manipulate the avatar to show desirable images. There can additionally be sounds which can be synthesized and which can be recording to be played.

In a preferred embodiment the profile can include actions the user would permit to be done autonomously or semi autonomously. For example the profile can also preferably be an intermediary or translator between the user and the outside world, including but not limited to computers. By this interface the problems involved including for example understanding, classifying anticipating the user, etc can be handled by an accumulation of data.

In a preferred embodiment the profile can also instruct the user. Preferably the user can examine his profile and realize where problems occur, and work on improving his speech and characteristics so the outside recognition means including computers, people, programs, etc can work more effectively. This can include updating information and action with the avatars. There can also be multiple profiles for different situations, such as games, business, social meetings, purchasing, sports, traveling, other countries, and languages, etc.

For example a user may have an avatar profile in gaming that makes preferably semi or completely autonomous actions including sayings, conversations, movements, facial expressions, joining games, etc. The profile also works in reverse to make the world more understandable by accessing other profiles of people computers, programs, groups, etc. In an embodiment the profiles become general intermediaries as required, acting as agents including for example coordinators, protectors, minders, secretaries, etc. Avatars can also be trained to mimic the user's facial expressions, to move facial features including lips to go along with what the user says, etc.

Preferably the user may monitor his and other profiles and make suggestions and commands to them, criticisms about them. For example he may monitor his profile and adjust some parameters and additionally correct inaccuracies the profile makes in real time or later.

Preferably the profile may additionally handle some financial transactions for the user. For example some bills might be paid unless the relevant accounts had less funds in which case they would be delayed. It might be interacted with by speech recognition or any other controllers.

In a preferred embodiment the profile means can be contained in many objects including for example a computing means in a piece of jewelry, a key chain ornament, a pendant, ring, chain, brooch, etc. It might be activated by connecting in ways including for example wires, wireless, infra red, Bluetooth, sound, etc. It can include a means including for example programs, files, circuits, in any computing means including laptops, USB connecting devices, mobile phones, Personal Digital Assistants, smart cards, etc.

The profile can preferably include artificial intelligence abilities. Some of the profiles actions may include for example requiring security, including encryption, Kerberos, Ipsec, passwords, PIN numbers, before it will interact with the user and/or outside agents in selected ways.

In a preferred embodiment the user might have a planning means including a diary, calendar, email organizer, time planner, secretary, etc and the profile might gain access to this and prepare some actions to synchronize with it. For example if a trip is entered into the planning means the profile might book tickets with or without confirmation, make purchases, look up relevant information, etc. The user might receive accounts and mark them to pay upon which this can be organized by the profile.

In a preferred embodiment the profile may have a standardized method of communication that can be targeted by a means including for example advertising, offers, discounts, promotions, etc. For example the user might go into an area where the profile can be interrogated by other devices for information about the user and the profile can input information. In addition the devices might rearrange advertising and other information for the users. This can include screens in mobile phone, Personal Digital Assistants, and other computing means, on the internet, on networks, wireless, etc.

In a preferred embodiment the profile can communicate with other profiles and computing means, arranging options and transactions for the user. It might for example automatically pay tolls and parking station entries.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### SPINNING DISPLAY

### ABSTRACT

A display can be made in ways including by a spinning implement. The image is preferably constructed by being received at one end of a spinning device and traveling up optical conduits to be displayed at the other end.

### BACKGROUND OF THE INVENTION

The present invention relates to the field of optics.

### SUMMARY OF THE INVENTION

Volumetric displays are popular but suffer from being very large. It would be desirable to make a two or three dimensional image that was smaller and more lightweight.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 25 shows an implement.

FIG. 26 shows conduits in the implement.

FIG. 27 shows a third aspect of the invention.

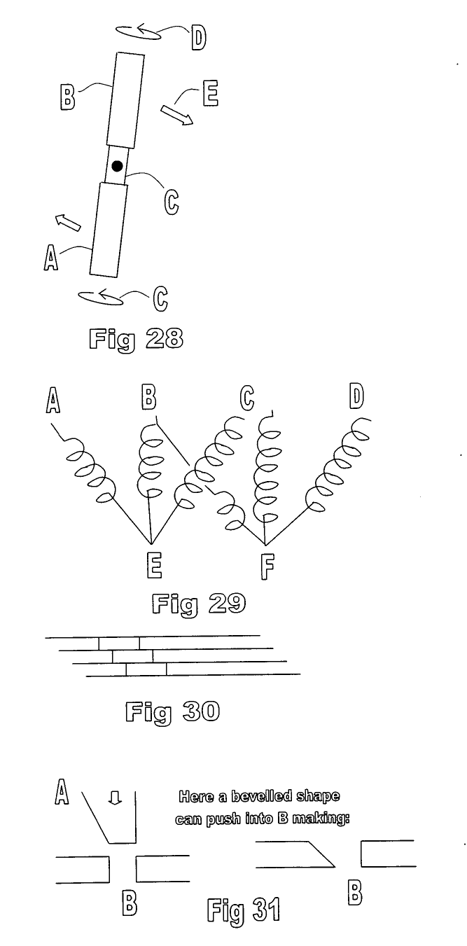

FIG. 28 shows a fourth aspect of the invention.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to create a display from a moving implement. Volumetric displays are well known in the art. They are made form a rotating surface that in some variations has changing images shined on it as it rotates.

In a preferred embodiment an implement rotates preferably around a fixed substantially central axis. The axis need not be in the center, often it can be off center for optical effects including for example making an image larger or smaller.

In a preferred embodiment to create a 2D image the implement has optical conduits in it that substantially correspond to a pixel height of the image. For example if the image was 100 pixels tall it would have preferably 100 conduits between one end and the axis, and a further 100 conduits between the other end and the axis.

For example in FIG. 25 A is preferably the viewing end, B is the end that receives an image, C is the axle, axis, rotating point, etc. D is at least one object to be viewed, and E is a preferred position for a viewer.

In FIG. 26 4 optical conduits are shown, which corresponds to a 4 pixel high image. Preferably there would be more than 4 conduits, this is an example only. A receives part of the image which is displayed at E, B is displayed at F, C is displayed at G, D is displayed at H, etc. The optical conduits may include for example wires, optic fibers, tubes, grooves in layers to direct light and other radiation, light pipes, etc. Preferably there is a means at the viewing ends to receive a sharp image. This can include at least one lens at each entry point, for example A. It might also include a tube that faces in the preferred direction to receive the image and is long and narrow enough to receive smaller part of the image. Tubes in this way can create a sharp image, and in different orientations can receive a 3D image. By the tubes being orientated the same way at the viewing end a 3D image can be transferred.

Preferably the optical conduits, for example A to E are regularly spaced. One section will be described as the viewing end in this example and go from the axis to a first end. The other section is the receiving end and goes from the axis to a second end.

Preferably the axis is mounted on a frame and a means is available to make the implement spin, including for example a motor, a wind up spring, spinning in the wind, cogs, belts, etc. A good example of a suitable speed might be 30 revolutions per second which would correspond to a frame rate in a display of 30 frames per second though of course another number of frames per second might be preferred.

In a preferred embodiment the conduits run along on and/or in the implement and are preferably separated so light or other signals in one does not leak from a first conduit into a second conduit. The conduits have entry and exit points that point in preferred directions. In this example the viewing end or B in FIG. 25 points in one direction and the receiving end A points in a second direction. Any angle is contemplated according to the effects desired and the box and frames employed. For example B might point in a first direction and A might point any angle including for example 30,45,60,90, 180 degrees, etc in another direction. The viewing means or B in FIG. 25 can also point upwards or downwards, as can A to make the viewing angle as desired. In the example of 3D viewing A and B would have entry and exit points, for example A and E in FIG. 26 pointing in many different directions to get the different 3D viewpoints.

In a preferred embodiment the objects to be viewed are positioned so the receiving conduits at B on FIG. 25 point substantially at them. These might include for example slides, photos, a display, a LCD, OLED's, scenery, any kind of viewable scene known in the art. The objects may be in a light for easy viewing including for example sunlight, lamps, flash, etc.

Preferably the user is positioned substantially in front of where the viewing conduits exit at A in FIG. 25. As the implement spins the user should see an image of the objects appear. This is because the light goes up the conduits and the implement spins quickly enough for the eye to make this into an image.

Preferably this can display a moving picture if the objects viewed are moving. It can also be larger and smaller in size if the ratio of the distances between the conduits on the receiving end and viewing end is adjusted. For example if the distance between the conduits on the receiving end is twice the distance between those on the viewing end the image will be twice as large. This might enable adjusting the position of the axle.

In a preferred embodiment the axis need not be in the center, as this can make it easier to have the distance between the conduits larger on either the viewing end or the receiving end, and thus change the ratio between the sizes of the images viewed and the images received.

In a preferred embodiment this can be used as a display including for example on a computing means, on a mobile phone, laptop, Personal Digital Assistant, etc. It can also be made as a novelty item including for example toys, games. A large enough implement could be used as an outdoor display.

Preferably the magnification of the viewed image could be quite large, such as a display for a plurality of viewers. In this example the image inputted would have to be brighter to compensate for the magnification of it.

Preferably the rotating implement could be open or enclosed in a frame including for example a wire mesh, glass or other transparent materials, be removed enough from users so they could not touch it while moving, etc.

In a preferred embodiment the array may have two ends for example A and B in FIG. 25, it can also have as many as desired. For example it could have 3,4,5, implements any number of these on the axis so the overall array would not need to spin as quickly to see the image. This may be desirable for example when the implement is larger, as it may create a whirring as it turns quickly. For example in FIG. 27 there are 4 implements, though there could be many more. As the device spins the image is four times clearer for the same speed as one implement spinning. Also the spaces between the implements can be sealed so the device appears as a full circle, an arc, etc.

In a preferred embodiment the implements can be placed on at least one axle in front of each other. Then the viewer sees each implement in a slightly different position.

In a preferred embodiment a 3D version can be constructed. For example the number of implements on at least one axle can be increased as before and the entry and exit points of the conduits, for example A,B,C,D, in FIG. 26 as entry points might point upwards, downwards, at different angles to the side. E,F,G,H can point in the opposite direction so the image is reproduced in proportion. This allows the viewer to lobk from different directions and still have some of the conduits pointing at him. The conduits can also be mixed in orientation on any single end though it is preferable the same array shape is on both ends so the image received is the same in proportions as that viewed, though this can be changed in any way according to the effect desired.

In a preferred embodiment in understanding this aspect of the invention the user might look at the array without spinning to examine the orientation of the conduits. He would observe that some on each of the ends would be pointing in preferred directions. Preferably in all these embodiments and examples the conduits may have at their ends and anywhere along them devices including for example lenses, prisms, filter, any kind of circuitry, CCD's, film, LCD pixels, OLED's, etc. For example along the conduits there could be a means to record the images so CCD's and the equivalents could be placed in them. Also to display and image a light emitting means could be placed in them including for example LCD's OLED's, etc though these would have to respond rapidly to give a good image quality.

Preferably in an embodiment the entry and exit points of the conduits would include a focusing means so the light received and viewed is a narrow arc that would not be seen substantially from the side. This is to make the 3D image appear sharper. This could include for example tubes sticking out from the conduits, lenses directing the beams, etc.

In a preferred embodiment it would be desirable for the orientations of the conduits to be substantially irregular, periodic, non uniform, etc to avoid patches in the image where there are fewer details. This can also be a periodic pattern if desired. The orientations of the entry and exit points would preferably point left and right, up and down, any angle if the implement is examined for example in a vertical position.

Preferably the implement need not be cylindrical or any particular shape. It could be for example a complete wheel shape with the conduits entry and exit points pointing as desired for a 2D or 3D image. It can also be any part of a full circle in shape, any angle of arc with a single or multiple implements. It can also have a plurality of these arrays on this or other axles in line with each other or any other angle. This may be desirable as the viewer would see perhaps a sharper image with multiple implements like this.

In a preferred embodiment the implements can themselves rotate around their central axis, this is easier for example if they are cylindrical in shape. The conduits with their entry and exit points would preferably all rotate around their core, while the whole array rotated around the axis. SO there are at least two kinds of rotation preferably driven by means including gears, cogs, levers, motors, belts, etc.

For example in FIG. 28 A is the receiving end, and B is the viewing end. A is rotating, twirling, etc as shown by C. B is rotating as shown by D. E shows the device is rotating clockwise around the axle C.

As the array spins it takes the 3D image and displays it for the viewer. While more complicated this system has the advantage of the conduits moving through more arcs and creating potentially a sharper image.

In a preferred embodiment the receiving end can receive the image as disclosed and then transfer it to a remote viewing means by a connection means including for example optic fibers, tubes, Perfect Mirror conduits, liquids in conduits with a good internal reflection of signals, CCD's and equivalent in the receiving means and emitters in the viewing means, etc.

In a preferred embodiment an implement with 100 conduits to make an image 100 pixels tall would use 100 light pipes and equivalents. Preferably there could be a fewer number of conduits which sequentially handle a predetermined number of receiving conduits in a sequence. Some details of this were disclosed in my PCT WO03025344. For example if there are 100 conduits of optical or other data to be transferred to a remote viewing means there could be used say 20 connecting conduits. At the receiving end of preferably each these 20 conduits would be a means to sequentially receive a signal from 5 of the receiving conduits one after another.

In a preferred embodiment this can be for example a spinning mirror means with the 5 conduits directed at it. As the mirror spins at the correct speed one after another of the receiving conduits is directed into the predetermined connector conduit. While this is happening the other 4 receiving conduits can have their light and other signals discarded until it is their turn.

At the other end of the connecting means depending on the number of conduits there will be a means to put all the signals back in the right order. Since in the example of the rotating means some of the signal has been discarded the overall signal will be darker, and it may be necessary in the case of the rotating viewing conduits to spin the array faster to compensate. It may be preferable to have in this example the full number of conduits, here as 100.

In a preferred embodiment the connecting conduits can be as long as desired, however light can be absorbed in them if they are too long. Perfect Mirror coated tubes would enable a long connection and the number of individual tubes or fibers is not difficult to use even in the case of an image say the standard 600 or 768 pixels often used in computers.

In a preferred embodiment the connecting conduits can be arrayed in many ways. For example one end of the conduits receive the images from each viewing conduit on one end and send it to a receiving conduit on its other end. In the example of FIG. 26 A might receive light from an object and send it to E. E has its light received by an optical conduit which transfers it to at least one other rotating implement. The light from the conduit enters a tube such as A in FIG. 26 and exits at E where it might be seen by a user.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### SPRING ARRAYS

### ABSTRACT

Springs can be arrayed to make a surface softer in preferred directions. This can be useful for devices including mattresses and chairs.

### BACKGROUND OF THE INVENTION

The present invention relates to the field of cushioning.

### SUMMARY OF THE INVENTION

Mattresses and chair are often uncomfortable after using them for extended periods. If a mattress is too soft the user tends to sink into a hole. It would be desirable to make cushioning more adjustable.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 29 shows an arrangement of springs.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves an array of resilient devices to create a preferred overall resilience in predetermined directions.

In FIG. 29 in a bed for example BC could represent an upper part of the bed, and EF the lower part. The user would recline on a layer of material above BC and under EF would be the base of the mattress.

This has severe limitations in that the springs have only two variations, to be harder or softer. In the invention the example above shows how additional springs can be connected to alter the springiness and comfort.

If someone reclined on the bed there would be softness according to the springs BE and CF. As they reclined there would be a tendency for other forces to come into play. For example BC would tend to spread apart.

Here AE and CE can retard this tendency as can BF and DF. Additionally there can be a tension in the spring means with no weight on it. For example if all springs are under load then adding another weight to the array would cause weaker springs to move more than stronger springs.

In a preferred embodiment of this concept for example only, imagine BE and CF as relatively weaker springs and the others as stronger. Someone lying on the bed would sink directly down and feel the bed as soft but the transverse springs would give other support and tend to stop them sinking into a “hole” in the bed. So the other springs would tend to allow some softness but change the gradient at which the bed became harder as a person sunk into the mattress, or whatever other device is being cushioned.

In a preferred embodiment the springs BE and CF could be removed and the bed would have another kind of softness. In addition there could be springs of varying resilience between for example AB AF, AC, AD, and so on. If desired there could be additional springs between and set of points in the cushioning means.

In a preferred embodiment there could be more springiness in predetermined directions. For example a person lying lengthwise on the bed might feel a different springiness than lying at another angle. Springs then might be arrayed to be stronger to stop a person sinking in one way such as across the bed while lengthwise there is less chance of this.

In a preferred embodiment some springs can be adjusted to preferred positions for the user. This can be done with remote controls and solenoids, relays, electromagnets on the mattress. Preferably this could be done in a factory environment so the user could work out the softness he wanted. Otherwise special beds could be made up or variations being preconfigured. Assembling these could involve moving the mount points for springs and using different springs.

Of course these examples are not intended to limit the scope or any aspects of the invention. For example the spring arrays could be used in chairs, for example on the backs so stronger springs hold the user up more so he doesn't sink as much back into the cushion. In the seat of a chair the springs could be arrayed to spread less and in other preferred ways so they are not as fatiguing to sit on. Instead of springs any resilient deice or material can be used.

Preferably they could be used with shock absorbing means like shock absorbers in a vehicle to finely tune how the vehicle reacts to various forces.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### OPTICAL CONDUITS

### ABSTRACT

Layers are altered to create conduits and then sealed together. Edges can also be made smoother to improve the flow and reflections through the conduits.

### BACKGROUND OF THE INVENTION

The present invention relates to the field of optics and hydraulics.

### SUMMARY OF THE INVENTION

Optical conduits are hard to make in a three dimensional shape. It would be desirable to have a more efficient way to manufacture them.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 30 shows holes in layers.

FIG. 31 shows including changing the wall angle of the holes.

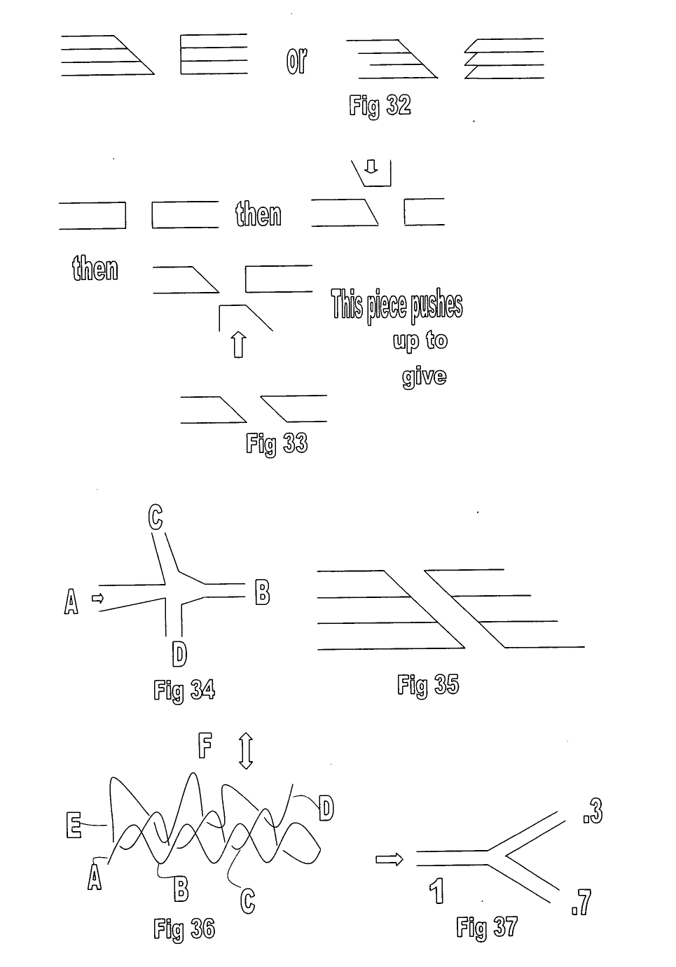

FIG. 32 shows layer configurations.

FIG. 33 shows other aspects of layers.

FIG. 34 shows different shapes of conduits.

FIG. 35 shows angles of conduits in layers.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means of creating conduits in a material. Preferably these are used to transfer many things including for example wires, light, electromagnetic radiation, fluids, electricity, and all other forces and objects known in the relevant arts.

Disclosed in my PCT WO03025344 was a means to create conduits including with layers. Uses include light conduits for 2D and 3D displays, fluid conduits, to fill with a conductive or insulating material, etc.

FIG. 30 shows layers with holes or other objects near each other. The three sections shown as rectangles could be cut out of the layers, so when they are put together as shown a conduit is formed. This conduit can point at different angles according to how the layers are placed.

In FIG. 31 a material can be inserted into the holes in the layers to alter the shape in many ways, an example is shown. For example a layer has cavities including for example holes, lines, conduits, curves, circles, rings, arcs, L shapes, zigzags, etc. These can be made in ways including for example stamping, cutting, melting, fusing, lasers, lithography, etc.

Once the layer is made preferably a means is introduced into the cavities to change the angles of their side. For example A is inserted into B and gives the left side of B a different angle. The layer can also be turned over and a similar implement applied to do the right side of B. The angles of the sides can be changed so conduits at an angle can have smoother sides, as shown in FIG. 32.

This can be done at various angles to create the desired shape for the conduits. This can also be done in an efficient manner. For example sheets are processed with various holes and grooves, and then preferred part of these sheets can be stamped or otherwise stamped with the correct angles. In FIG. 33 stamping for example can be done from above and below. While the stamping here alters a side of a cavity in a flat plane this could be in any shape. For example it may be preferable to stamp it in ways including for example a U shape, cycloidal, parabolic, multi facets, circular, arcs, etc. A rounded shape for example can assist in reflectivity of light.

Then the sheets can be assembled in many ways including for example fused together, glued together, held in a brace, held together in a brace or frame, etc. The cavities are preferably coated a shiny material to make light go through the conduits, this could include for example Perfect Mirror material. FIG. 34 shows a shape for a device including for example switches, optical conduits, light pipes, fluids, valves, wires, etc. FIG. 35 shows a conduit with a smooth angle on all sides.

Preferably they could also be made of a shiny material so the edges and conduits will be reflective, or they could be plated with a shinier surface. In a preferred embodiment they could have a conductive surface, various amounts of friction, resistance, etc.

In a preferred embodiment the layers could be very small and assembled in this way to make circuits, motherboards, any kind of circuitry. Preferably the holes could be made and filled with a substance including for example resistors, transistors, integrated circuits, wires, optic fiber, conductive material, optical and other filters, valves, other liquids, biological materials, tubes, etc.

Preferably other parts can be made with layers and then inserted into holes. These other layers may be at different angles, there is no reason for them all to be parallel or any particular angle to each other.

In a preferred embodiment layers can be altered by many means including for example lasers, cutters, stampers, impressers, drills, sonic tools, air tools, jets of fluids, lithography, acids, masks, etc.

The materials used can include for example metals, plastics, optic fiber faceplate material with the fibers at any angles, substantially transparent and tinted materials, those with differing reflectivity, etc.

In a preferred embodiment liquids can be used in the conduits to direct beams including light, other electromagnetic radiation. For example some liquids are better for internal reflection so if the layers or their coating is made of preferred materials the light will internally reflect better. This means that there is less loss of light, etc in the cavities, grooves, conduits, etc.

Preferably the grooves would be shaped so that the light could internally reflect, and in preferred places there might be a reflector such as Perfect Mirror material.

In a preferred embodiment there can be additional grooves around the main grooves to reduce light and other radiation leakage from them. Around the grooves there can be a raised lip on one side and another groove on the other layer. Placing the layers together would make an optical and other kinds of conduit and around this the lip and additional groove would join in a way substantially similar to dovetailing to seal leakages.

In a preferred embodiment imperfections in the conduits can be adjusted by placing a device over selected parts. For example if the conduits are being used as a display there may be small imperfections so some pixels appear darker than others. One way to fix this for example would be to place filters over some of the exit points of the conduits.

In a preferred embodiment the conduits can be in a shape of a screen and a film or array of CCD's are placed at exit points of the conduits behind the display. Light is directed onto the front of the display (or vice versa) and some spots on the film or recorded data by the CCD's, etc could show some conduits are less able to transfer the signal. The exampled film could be developed and placed as a barrier screen on the exampled back of the display. The tubes that let through more light would be aligned with a correspondingly darker spot on the film which would tend to equalize each conduit in its brightness.

### ADAPTIVE OPTICS

### ABSTRACT

Telescopes can use a different system to adaptive optics.

### BACKGROUND OF THE INVENTION

The present invention relates to the field of optics.

### SUMMARY OF THE INVENTION

Telescopes have many difficulties with air turbulence. Adaptive optics which deforms a reflective mirror is used to try to overcome this. It is difficult however to deform the mirror quickly enough.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to control imaging distorted from an effect including air turbulence with an imaging means including for example telescopes, cameras, movie cameras, binoculars, etc. In the example of telescopes this is typically handled by adaptive optics which includes deforming the mirror to focus the images more clearly.

In a preferred embodiment an imaging means including for example a telescope, camera, lens array, etc can also be created with a novel and inventive method of focusing.

In a preferred embodiment reflective and/or refractive shapes including those partially reflective and refractive in a predetermined ratio are used. A parabolic shape for example is created with the purpose of the light not being all reflected to a focal point inside the parabola (as a reflective telescope works) but being substantially refracted through the mirror surface to a receiving means under it.

In a preferred embodiment the inner surface of the parabola is substantially transparent. Preferably there exists on the surface a plurality of refractive sections including for example lenses, tubes, prisms, Fresnel lenses, fly eye lens sheet, holographic imprints, etc. Holographic screens are well known in the art, for example as used with projectors. Usually it is a thin film applied to the surface.

Preferably the holographic material will act as a plurality of lenses closely placed together. Otherwise lenses themselves can be used.

Preferably the lenses, the holographic material, etc will act as a focusing means and so each can focus onto a focal plane. On this focal plane is a means to receive an image from each lens. Herein a lens will refer to including a separate constructed lens, a lens shape in a surface, a holographic material that acts as a lens, etc.

In a preferred embodiment on the focal plane are preferably image receptors. These include for example CCD's, film, etc and other receptors known in the art. Preferably a plurality of the lenses acquires an image that is slightly wider than the parabola would if it acted as a reflective surface directing an image onto a focal plane. The parabola is just an example here, as will be seen other shapes can be used. Because each lens by its nature tends to have a wider angle view the total image information received should have a wider angle than the same parabola would as a reflecting telescope.

In a preferred embodiment the surface of the parabola is much larger than the focal plane used so if under the parabola was densely packed with image receptors including CCD's the potential image resolution can be greater. This can be seen by comparing the size of the focal plane on a reflecting telescope compared to the size of the reflecting mirror.

In a preferred embodiment the CCD's are preferably positioned so a plurality of lenses, preferably covering the parabola is focused onto the CCD's. The lenses may evenly, periodically or irregularly cover the surface. They can be all the same size, vary in size periodically irregularly, with different focal lengths, etc. A more irregular array might receive more image data.

In a preferred embodiment the lenses in this example are receiving as much or more image information as would be normally reflected upwards to a focal plane, but they are directing it downwards. Also because a plurality of these lenses, preferably even all of them is acquiring a wider angle view the lenses can acquire more image information than the parabola.

In a preferred embodiment the images from the CCD's can be used to construct an image the same as would be acquired if the parabola was a reflector. This must be true as all the data that would have been acquired with a reflector must be there. Algorithms would calculate where the data from each CCD would have to be in the overall image.

In a preferred embodiment the image would be of higher resolution because there are more CCD's gathering information. Also if the lenses have a wider angle view the data can be arranged to simulate distorting a mirror with adaptive optics. When there is air turbulence an image can be corrected by distorting the parabolic mirror shape, which is the equivalent of directing light that would normally hit a first point near or on the focal plane to a second point near or on the focal plane. The lenses because they collect a wider angle of view than the parabolic mirror have also collected the image data about both these points.

In a preferred embodiment the data received by the mirror both before and after it is distorted has been received by the exampled CCD's. By selecting the image data from the right CCD's by an algorithm the image created can precisely duplicate the total image seen before distorting the image and after it.

This means that the mirror need not be distorted, that by sorting the image data from the CCD's the same result is obtained. One advantage of the invention is because this sorting of the image data can be done by computer it can be done more accurately than manually distorting the mirror. It need not be done in real time but can be done later. As long as the amount of distortion required is known the maximum information from the image data can be obtained.

Of course the parabolic shape is only an example to illustrate that it can also focus to a focal plane above as a reflecting telescope. This system can be used on any shaped surface because the lenses and which way they point are most important. For example this could be created on a flat surface. This has advantages of being easy to create because the flat shape can be made by gravity.

In a preferred embodiment a layer of image receptors can be laid down, CCD's in these examples. Preferably these examples involve flat layers. Next can be a transparent layer preferably with lenses above it, or on its upper surface.

Preferably at least one layer can be composed of optic fiber faceplate material. This is made from fused optic fibers positioned parallel to each other. Light from the lenses can fall onto the faceplate material and be directed to the CCD's. Faceplate material can also work to some degree without lenses as it tends to direct light down the fibers like a focusing means.

In a preferred embodiment there can also be other layers with lenses above them, the multi layers could tend to act as a multi lensed camera. This can correct for example chromatic aberration, and also act as a wider angle lens. Preferably the system can capture much of the sky from different lenses using the flat surface. Other shapes may also be used, including for example cycloidal, hyperbolic, etc.

Preferably the layers can be created in a molten state and cool to be very flat. Sheets of glass and other materials might also be used, preferably with the lenses like a fly eye sheet, and/or a layer of the holographic imprint on the surface.

Preferably parts of the lens array might point in preferred directions. For example some might point straight up, some at an angle like 10,20,30, . . . degrees. Any angle as preferred is suitable as long as the light to be captured does not reflect off at an angle instead.

In the example of a flat surface the lenses would tend to be tilted and deformed slightly to capture light more from one side, or they might be wider angle to receive light from all side. Lenticular lenses could also be used to for example receive light in a preferred arc such as the Milky Way.

Because the layers are easier to construct and support, and can simulate adaptive optics they can be very large.

It could be possible for example to have even square miles of optics in this way. Adjustment might also be made for flexing and buckling to some degree in changing temperatures but this could also be done by arranging the data correctly. This can be checked for example by picturing clearer objects such as the moon, Mars, etc to ensure the correct algorithms are used.

While the algorithms may appear difficult this is not an inventive aspect. The optics of the lenses is well known and the mathematical means to translate this into correct images while complex is fairly trivial mathematically.

In a preferred embodiment some of the materials might include liquids. For example the CCD's might be under a liquid such as water with a lens sheet or holographic film floating on it. This could also be done as a holographic film reflecting light upwards to a focal plane above like a reflecting telescope with a flat mirror. This could also be done with a solid instead of liquid.

In a preferred embodiment the layers may have a coating such as used on camera lenses to reduce reflection and let more light through the lenses.

Distortion in the shape of some lenses need not be a problem as algorithms can still get image information from them. The importance of an accurate surface is less than a normal reflecting telescope.

In a preferred embodiment the lens array could be in sections with the room for cars, people, etc to travel between them. This can also enable access for repair, cleaning them, etc. Preferably an additional layer can be suspended above the lenses to shield them from dust, and the sides are sealed to keep dirt out. The top might be cleaned in ways including for example flying a helicopter above to blow dust off the surface.

In a preferred embodiment the array can include reflectors such as used in telescopes. Using large numbers of these can enable the equivalent of a larger telescope. For example there could be reflectors like 20 inches in diameter, but perhaps thousands of them. Each preferably receives an image to a receptor means including for example CCD's. This data can be fed into a computing means and an overall image achieved.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### POWER GENERATION

### ABSTRACT

Enclosures can be created including over tidal water. As the tide comes in the air is compressed when the water level rises which can be used to move a turbine.

### BACKGROUND OF THE INVENTION

The present invention relates to the field of renewable energy.

### SUMMARY OF THE INVENTION

Renewable energies are difficult to use with tidal energy. It would be useful to make another system to exploit tidal power.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves an enclosed container placed over tidal water. As the tide comes in, the air inside the enclosure is compressed and runs out a conduit to power for example a turbine creating electricity. As the tide goes out this creates a partial vacuum which causes air to run back into the container which can also generate electricity.

In a preferred embodiment the enclosure can be made of cheap materials, for example canvas on poles. Part can also be constructed over a shoreline, and have translucent panels to be more neutral to the environment. Other suitable materials would be plywood or fiberglass.

In a preferred embodiment large containers of air or containers of foam are anchored underwater in tidal water. As the tide comes in this allows these containers to float higher which causes a cable connected to them to move, and turn a generator. The motion of the containers can also produce power in other ways. For example they might create a partial vacuum in a pipe as they moved upwards which could power a generator.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### ROPE FROM CARBON NANOTUBES

### ABSTRACT

Rope from carbon nanotubes can made in ways including by weaving lengths of tubes together. By weaving the strands back onto themselves tension in one direction can cause them to bind together.

### BACKGROUND OF THE INVENTION

The present invention relates to the field of rope and nanotubes.

### SUMMARY OF THE INVENTION

Nanotubes are difficult to make rope from. They tend to be slippery next to each other and a binder adds to the weight. It is desirable to find a stringer configuration of nanotubes.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 36 shows a configuration of carbon nanotubes.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to create a connecting means including rope, line, twine, thread, etc. One of the main problems in creating rope with nanotubes is in making the strands of tubes long enough.

For example it is desired to make a long connecting means, even to reach into space to make space elevators. Handling such material is very difficult as it may require strands thousands of miles long. Also the strands are relatively slipper and putting them side by side gives little friction between them. Adding a binder does not work well because the binder itself does not stick well to the tubes, and it is not as strong so it decreases the overall strength of the connecting means.

To solve this problem the tubes would need to increase this friction, in effect here to use the tension on the connecting means to increase the friction between the tubes.

The solution includes weaving the tubes into a kind of pattern including weaving it, knitting it, etc. Preferably tubes are initially made into a line. This should be so the tubes overlap each other much like normal rope, cotton etc. They can be woven as with the exampled rope or cotton, but at this step of the invention this is preferably to hold the strands together to be further positioned. Binder can also be used for this though it is preferable if it can be removed later by for example dissolving it, chemical reactions, etc.

In FIG. 36 the tubes weave back in on themselves. A represents a line made substantially of carbon nanotubes. There also may be a plurality of lines woven into the invention. B represents loops in the line so parts of the line can loop back into themselves. C shows the line looping back onto itself. D shows another example of this, as does E. F shows the direction the weave is preferably tightened. This causes the line in the loops to grip tightly against itself.

When a tension is placed on the connecting mean vertically the tubes push on each other and this friction holds it together. Also there can be relatively short strands in this system as each strand can have multiple points where it is woven back on itself, which increases the friction an overall strength. Preferably each tube can be held in this way by a plurality of other tubes. This is much stronger than placing the tubes parallel to each other in a rope, as the tubes tend to slide against each other.

Preferably this can also be used for electrical and optical conduits and all other uses in the relevant art.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### HAND MOVEMENTS AS CONTROLLERS

### ABSTRACT

The finger positions are detected and translated into controller information.

### BACKGROUND OF THE INVENTION

The present invention relates to the field of computing.

### SUMMARY OF THE INVENTION

Mice are limited in the amount of controller information they can impart to a computer. It would be useful to increase these controls. Also holding a mouse can tire the hand. It would be desirable to make controlling a computer more comfortable.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a sensor pad capable of detecting the positions of objects remotely or in contact with it. The pad may include protrusions on its surface to monitor the movement of objects. In an embodiment this can include controlling a computer means by monitoring the movements of objects including parts of the human body.

Preferably this includes using parts of the hand including the fingers and palm to act as controllers. Preferably this can be done without additional controllers on the hand though preferred accessories may be worn to be detected by the computing means in ways including for example radio waves, wireless, infra red, sound waves, lasers, capacitance, light beams, etc.

According to a preferred embodiment the hands can move on a surface, preferably as a kind of pad. This can include a kind of mouse pad in the broadest sense, but preferably it is a larger pad. The pad can also include a surface of an objecting for example parts of a desk, chair, table, computer case, computer monitor, television, stereo, car stereo, dashboard, steering wheel, handles, doors, knobs, phones, faxes, speakers, consumer white goods, garden tools, etc.

The pad is preferably capable of detecting parts of the body including for example the hands as they rest on or are positioned near it. Preferably the invention can do this in ways including for example by the pressure sensed from their weight, radio waves, wireless, infra red, sound waves, lasers, light beams, etc.

In a preferred embodiment the pad would sense preferably parts of the body including where each of the fingers were, and the palm of the hand. Preferably each part of the hand could act as a controller for a predetermined action. For example there are mice that have buttons for nearly every finger including the thumb. This system would sense each finger and execute commands according to what they did.

For example one finger could act as a left hand button mouse click, another as a right hand mouse click, another to delete, another to copy, another to paste, etc. Of course there are many possible commands and many are listed in various menus in operating systems, programs, and mouse menus with multiple buttons. The ones disclosed here are examples only and are not intended to limit the scope of anything here. All these commands could be activated by different positions of the hand. This could relate to data marked on the pad. For example certain positions on the pad might correspond to activate certain controllers. There could be letters and numbers to trace out with the fingers, section to tap which open predetermined menus, other sections could open a browser, Word, file managers, etc.

The pad is preferably flat but it can be any shape. For example some parts might contain shapes including for example bulges, recesses, cavities, rectangles, circles, ovals, squares, pentagons, knobs, sliders, etc which can control aspects of electronic and other devices. The pad can also include known electrical controllers including for example mice, joysticks, trackballs, button, potentiometers, switches, etc.

Preferably controllers can be activated by moving at least one part of the body, for example a finger. Moving two or more fingers such as one on each hand might activate a second controller. Combinations of fingers could correspond to more complicated commands including for example letters, numbers, punctuation marks, phrases, the shift key, caps lock, tab, space bar, insert, delete, etc.

Moving for example one finger closer to another could act as a controller, also tapping the pad surface could act as a controller for each finger as a controller. The amount of pressure could also be a controller for example to make things happen faster.

Preferably the sensor surface can have any shape known in the relevant arts. A flat surface is an example here but parts of at least one pad could be held with the fingers around them and controllers could include squeezing, rubbing, pulsating, swinging, spinning, twisting, etc.

In a preferred embodiment at least one pad can have different textures including for example like foam, liquid in a bag, grease in a bag, corduroy, fur, steel, plastic, loose objects in a bag, etc.

Preferably the invention can be used on any computing means and anything connected to them. These can include for example mobile phones, Personal Digital Assistants, laptops, desktop computers, terminals, etc where the hand can rest on a sensing surface and act as a controller as described.

In a preferred embodiment the hand need not be on the surface of the sensing surfaces, but can also be substantially near them. For example it may use a sensing means including for example sound, infra red, wireless, etc. For example at least one beam could shine onto the exampled hand and a receptor could calculate the shape of the hand from its image. The beam could describe a grid shape and so the shape of the exampled hand can be seen from the distortions in the grid.

Sounds could additionally be reflected from the exampled hand and its position determined, preferably in all these examples from at least one position, two or more to get a 3D perspective.

In a preferred embodiment at least one pad can detect the hand positions for example by capacitance. This mechanism is often seen in elevators. The fingers are placed onto a surface, often a recess, and are detected and a controller activated.

In a preferred embodiment a computing means including for example mobile phones, laptops, notebooks, Personal Digital Assistants, etc can be controlled in these ways by resting the hand on their surfaces. Preferably buttons may not be necessary, perhaps icons and markings on the surface can indicate where to press or place the fingers. Controllers can also be used including for example buttons, knobs, sliders, keys, etc.

In a preferred embodiment small protrusions which stick out substantially from at least one pad and which parts of the hand for example interact with in ways including for example touching, pressing, pushing, tapping, scratching, dialing, doodling, etc. Selected protrusions are pushed in ways including for example down, to the side, etc by the motion of the hand which can be interpreted as a controller for actions. The protrusions could be larger like kinds of joysticks, and/or smaller to feel like a kind of raised fabric, and any other shape and texture known to the relevant arts.

In a preferred embodiment the protrusions would preferably connect to devices including for example switches, variable resistors, transistors, potentiometers, piezo electric devices, optic circuits, circuitry, etc.

In a preferred embodiment light can be sensed being occluded, reflected, etc by the fingers and hand, and this can be interpreted as controller data. For example light including laser can exit at least one pad through locations including for example tubes, portals, apertures, lenses, through holographic optical elements, etc and shine onto a part of the body including the hand and fingers. The reflection from this might sense for example where the finger tips are. This is similar to the principle of a laser mouse but in reverse, the light coming from below instead of above.

In a preferred embodiment radiation including for example sound, light, lasers, radio waves, etc can be emitted from preferred points on the sensor pad, and data received back can indicate the hand and finger positions. A similar principle is used with laser mice except the mouse emits the laser beam and analyzes the reflection to determine its movement. In this example the beams might be emitted out of the surface and sense the moving hand with reflections.

In a preferred embodiment movements can also be sensed touching the body, for example including fingers touching parts of the body to correspond to controllers. For example a pad material can be located in ways including for example placed on the skin, tattooed on, stuck on, worn like a garment, worn like an armband, worn like a piece of jewelry, etc.

In a preferred embodiment the sensory pads can interpret motion from implements including for example pens, pencils, prods, rollers, mice, light pens, etc.

The disclosures anywhere in this U.S. application are not intended to limit their scope of the invention, or any of their parts. For example while the devices disclosed here refer to hands they could apply to any moving object. The surfaces described here use a hand as an example but they might in addition sense the movement of other objects including for example boxes, animals, vehicles, vacuum cleaners, footsteps, pets, freight, luggage, tools, utensils, cutlery, personal effects, etc and any other objects known in the relevant arts.

Such a sensory surface then can monitor the movements of almost anything for many purposes including for example stock control, finding misplaced objects, statistical analysis, checking objects are cleaned properly, directing people or a computing means to the orientation and location of objects, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### A PARTIAL VACUUM IN A RESILIENTLY DEFORMABLE CONTAINER

### ABSTRACT

The invention includes a softer breast implant. These can be combined with conventional models to improve the texture.

### BACKGROUND OF THE INVENTION

The present invention relates to the field of gas pressure.

### SUMMARY OF THE INVENTION

Breast implants are typically unnatural in feel compared to human tissue. This is because fluids inside them are not compressible. It would be desirable to improve this texture to more closely simulate human tissue.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a resilient material including for example sponge, foam, springs, etc in a deformable container with a partial vacuum. Matter relating to this invention was explained in my PCT WO0025429.

In a preferred embodiment varying methods can be combined to improve the feel and operation of a breast implant. For example the implant can contain a central or elsewhere section where a container can be filled with foam and/or liquid including saline, silicon, etc. The outer parts would include a resilient material and a partial vacuum.

Preferably when the gas pressure is reduced the foam will still be softer from the partial vacuum but the movement of the liquid will combine to balance the texture of the implant.

In a preferred embodiment the materials can be reversed. On the outside can be the liquid, silicon, etc and/or foam, and inside it there can be the resilient means with partial vacuum in the deformable container. The feel of the overall container would be softer. The inner bag in this example would be affixed to a given position or float around. Preferably it can be weighted so as to approximate overall the weight of the liquid. Having foam for example in with the liquid, silicon, etc can assist in holding the two kinds of containers in place.

Preferably this can be useful since tissue has a springy texture but also has plenty of fluids in it. Using at least one container of fluid then can help to mimic the texture.

In a preferred embodiment the resilient material described herein with a partial vacuum can be used with other cushioning means including for example footwear. For example dust would commonly get into springy materials in footwear, as well as odors. If the resilient material is enclosed with a reduced gas pressure then this would not be easily contaminated. In addition parts of the shoe can have other methods of shock absorbing including the known ones in the relevant art for example compressed air, tread patterns, etc.

In a preferred embodiment a combination of methods can alter the compressibility of the sock absorbing means. For example on a shoe such as Nike commonly make, air is enclosed in sections of the shoe. Inside, above, below, or to the side these sections there could be a container of the resilient material with a partial vacuum and the combination of these two would substantially alter the overall compressibility of the array.

For example in a tire as the shape is compressed the air pressure goes up in a well known relationship. Reduce the volume of the examples of tires and shoe parts by X% and the air pressure will go up Y% which in turn is associated with a harder ride or feel. If the examples disclosed here are used the overall hardness of the product under a given load can be altered to change in whatever gradient is desired.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### VARIABLE CIRCUITRY

### ABSTRACT

Optical circuits each have a different output. Measuring the output of a plurality of these can reveal the configuration of those in the circuit.

### BACKGROUND OF THE INVENTION

The present invention relates to the field of optics and computing.

### SUMMARY OF THE INVENTION

Optical and electrical circuits can rely on a complicated array of transistors, switches, etc. It would be preferable to have a system that could more simply calculate.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

FIG. 37 shows a kind of circuit.

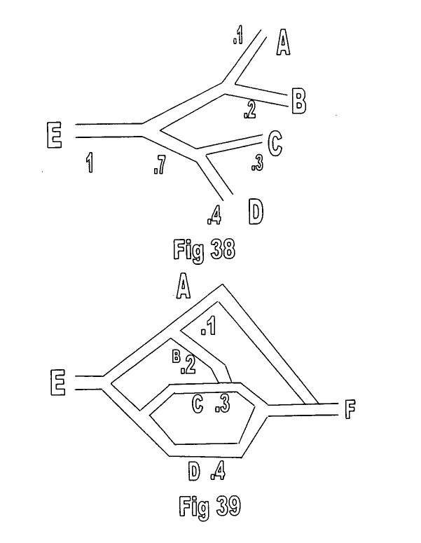

FIG. 38 shows a variation of this circuit.

FIG. 39 shows a more complex version of this circuit.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves optical circuits designed to have a variable output in at least one conduit compared to the others.

Preferably the optic conduits have a means to alter including for example restrict, curtail, meter, etc the amount of light and other radiation which passes through them. For example in FIG. 37 assuming the example of light passes through it with a value of one the values of the beam which get through are 0.7 in one conduit and 0.3 in the other. This could be also applied to electrical circuits by a different resistance in each wire.

In FIG. 38 this is further extended, preferably so the different conduits have a dissimilar amount of the exampled light that gets through. Imagine then there are switches and other devices at the various junctions, and the starting point itself may be a junction from other circuits, in this example as optical conduits though electrical circuits and hybrids are also contemplated.

Preferably by measuring the strength of predetermined junctions the signal received will tell us which switches are open and where, as long as the conduits, wires, etc have sufficiently dissimilar values.

Preferably signals can be read in a substantially different way from standard circuits, where the strength of the signal gives us an answer instead of or in addition to logic circuits.

This can include other optical devices as disclosed in my own PCT applications. For example beams may interfere with each other and be directed into conduits giving a dissimilar output to be read as disclosed herein.

In a preferred embodiment circuits may vary according to changing throughputs and signals. For example if a signal reached a given strength it might activate a filter to reduce its signal, activate an optical transistor to create a third signal, etc. A change in a switch for example might alter the overall voltage, light intensity, etc so by measuring this it can be determined which switch has been activated. For example in FIG. 38 the voltage, light intensity from E at A and B might change according to devices, switches, etc at C and D.

In FIG. 39 the voltage, current, light intensity, etc at F from E would depend on whether the conduits A,B,C, and/or D were open or closed. In each case the signal strength could determine which were open or closed.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### THREE DIMENSIONAL DISPLAY

### ABSTRACT

A display is disclosed that can simulate a three dimensional image. The surface can vary in its magnifying ability which periodically makes the screen appear closer and larger. By making a different image at differing parts of this change a three dimensional image can be displayed.

### BACKGROUND OF THE INVENTION

The present invention relates to the field of autostereoscopy.

### SUMMARY OF THE INVENTION

Three dimensional imagery is hard to display accurately. One reason is that there needs to be a pixel for each viewpoint that decreases the overall image quality. It would be desirable to use the same pixel for different viewpoints.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to give a 3D image. As is known the art, there is a form of holographic pattern which can be activated by electricity, upon which the pattern deflects light like a lens.

In a preferred embodiment of the invention this material is used to make optical effects including 3D. For example a display image is under this material and can be seen through it. When the material is activated as a lens the image under it appears larger. As the material is rapidly switched on and off the image appear to get larger and smaller and this is the optical equivalent of appearing to get closer and further away.

Preferably the display makes a first image when the material is on and a second image when the material is off. This can make a preferred optical effect, including the example of the 3D image. The display might additionally emit other images while the material is turning on. As the material reacts the image is partially magnified and emitting at least one transitional image at this time can fill in more details in the 3D image. When the material is switched off the magnified effect is decaying and intermediary images at this time can also include more details.

In a preferred embodiment the material can be partially activated so there is a partial magnification and intermediary images can be emitted then to add more 3D detail.

In a preferred embodiment a room is shown in 3D. When the material is off, the display shows objects further away. When the material comes on the deflection like a lens is appearing slowly and the display changes to show intermediate distances in the image, and when it is fully activated it shows the foreground. When the display synchronizes like this the appearance is of the 3D room.

Preferably this can be used in many ways including in the example of 3D in mobile phones, Personal Digital Assistants, laptops, larger displays such as using LCD's and OLED's, any kind of display known to the art. Preferably it can also be used in signage, advertising, special effects in windows, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### A BLOWING MEANS

### ABSTRACT

A blowing means is connected onto a device.

### BACKGROUND OF THE INVENTION

The present invention relates to the field of gardening.

### SUMMARY OF THE INVENTION

Lawn blowers are expensive to buy as are lawn edgers. It would be desirable to create a device to do both jobs.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves a means to make an air blower for garden work, lawn mowing, and maintenance, etc. Whipper snippers are a common device in this field. They have a nylon or other cord at one end which spins quickly and is useful to cut weeds, lawn edging, etc. Air blowers are often used to blow lawn clippings off driveways, etc.

It would be desirable to combine these in one device rather than having to pay for two separate one. In a preferred embodiment the end of the lawn edger, whipper snipper and similar device is removed or augmented and at least one fan is attached. Preferably the fan is in a grill to protect the blade.

The motor spins the blade and it blows air like the air blower does, useful for lawn clippings, etc. Preferably it can include wheels below the fan mount so it can be moved more easily to do the work.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

### NOISE REDUCED WIPER BLADES

### ABSTRACT

Wiper blades can be made that have reduce chatter and noise as they wipe over a windscreen.

### BACKGROUND OF THE INVENTION

The present invention relates to the field of auto accessories.

### SUMMARY OF THE INVENTION

Windscreen wipers often become noisy on dry windscreens, and as they age. It would be desirable to make windscreen wipers quieter.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### DESCRIPTION OF DRAWINGS

The features of the invention will be better understood by reference to the accompanying drawings which illustrate presently preferred embodiments of the invention. In the drawings:

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The best mode of the invention involves the blades of windscreen wipers being segmented to have uneven shapes and thicknesses. This is to avoid the blades chattering as they lift on a dry windscreen. For example on a standard wiper blade there can be cuts a predetermined distance apart. When they have multiple blades on the one wiper these cuts can be staggered so they don't line up together and leave a smear of water on the glass.

On purpose of the invention is to avoid “chatter” where the blades jumps across the windscreen and makes an unpleasant sound. By breaking up the blade surfaces into smaller widths, and differing characteristics including for example width, strength material, depth of the cuts, shape, etc it makes it more difficult for the sound to be created from the whole blade. This reduces the overall sound. This can also be used in other devices that scrape an implement over a surface including for example window washers, etc.

Although some preferred embodiments are shown to include certain features, the applicant specifically contemplates that any feature disclosed herein may be used together or in combination with any other feature on any preferred embodiment of the invention. It is also contemplated that any feature may be specifically excluded from any preferred embodiment of an invention.

Although illustrative embodiments have been described herein in detail, it should be noted and will be appreciated by those skilled in the art that numerous variations may be made within the scope of this invention without departing from the principle of this invention and without sacrificing its chief advantages. Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

The description of the invention is merely exemplary in nature and, thus, variations that do not depart from the gist of the invention are intended to be within the scope of the invention. Such variations are not to be regarded as a departure from the spirit and scope of the invention.

1. A data control system in which unauthorized messages are restricted.

2. A message control system according to claim 1 where the messages are emails, the user is limited to a predetermined number of emails in a predetermined time period.

3. A message control system according to claim 2 where the user's email contains an identifier from the system to distinguish it from other email.

4. A message control system according to claim 3 where email without the identifier is separated from email with the identifier.

5. A message control system according to claim 4 where the user logs into a server with a username and password.

6. A message control system according to claim 5 in which people can be allowed entry to the system to use a predetermined number of emails in a time period with acceptable credentials.

7. A message control system according to claim 6 in which user behavior can be guaranteed by a third party, and who will pay a penalty if the user abuses the system.

8. A message control system according to claim 7 in which people may be allowed to message the system in ways highly restricted in content to exclude spam being sent.

9. A message control system according to claim 8 in which administrators may validate people wanting to use the system for a limited number of emails in a time period by:
(a) Conversing with the person over a message system to ensure they are not spammers.
(b) Requiring the person to undergo tests to prove they are not computers.
(c) Requiring the person to reply to a message.

10. A data control system in which hashes are made of authorized identifiers and displayed in a repository.

11. A data control system according to claim 10 in which a user receives or sends data which can be hashed and compared with the hash in the repository.

12. A data control system according to claim 11 in which if the hash created by the sender or receiver matches the hash in the repository the data is accepted.

13. A data control system according to claim 12 in which the data hashed includes emails, sender addresses, files, messages, programs, code, and identifiers.

14. A data control system according to claim 13 in which users may display hashes of their data and identifiers so a receiver of data can make a second hash of the data and compare the second hash with the first displayed hash of the user.

15. A data control system in which a computer connects to a proxy server that takes the computer's DNS request for IP addresses and returns a dummy identifier to them.

16. A data control system according to claim 15 in which a computer contacts the proxy server with the dummy identifier to receive data from that address, and the proxy server, gets the data from the real IP address, and sends the data to the computer stripped of identifiers of where the data is coming from outside the proxy server.

17. A data control system according to claim 16 in which the proxy server has a limited ability to interpret code outside of its function of supplying a dummy IP address and routing data to the computer.
